(19) United States
(12) Patent Application Publication
(10) Pub. No.: US 2011/0174346 A1
(43) Pub. Date: Jul. 21, 2011

(54) DOSING SYSTEM FOR A DISHWASHER

(76) Inventors: Arnd Kessler, Monheim am Rhein (DE); Salvatore Fileccia, Oberhausen (DE); Dieter Eichholz, Iserlohn (DE); Gerold Jans, Waldburg (DE)

(21) Appl. No.: 12/986,275

(22) Filed: Jan. 7, 2011

Related U.S. Application Data
(63) Continuation of application No. PCT/EP2009/005107, filed on Jul. 14, 2009.

(30) Foreign Application Priority Data
Jul. 15, 2008 (DE) 102008033100.7
Jul. 15, 2008 (DE) 102008033102.3
Jul. 15, 2008 (DE) 102008033107.4
Jul. 15, 2008 (DE) 102008033108.2
Jul. 15, 2008 (DE) 102008033109.0
Jul. 15, 2008 (DE) 102008033237.2
Jul. 15, 2008 (DE) 102008033238.0
Jul. 15, 2008 (DE) 102008033239.9

(51) Int. Cl. A47L 15/42; B67D 3/00

(52) U.S. Cl. 134/56 D; 222/52

(57) ABSTRACT

A dispensing system, in particular for a user to position in the interior of a dishwashing machine, comprising at least one cartridge for flowable washing or cleaning agents with a plurality of chambers for spatially separate accommodation of in each case different preparations of a washing or cleaning agent, and a dispenser couplable with the cartridge and comprising an energy source, a control unit, a sensor unit, at least one actuator, which is connected with the energy source and the control unit in such a manner that a control signal from the control unit brings about movement of the actuator, a closing element, which is coupled with the actuator such that movement of the actuator displaces the closing element into a closure or a release position, at least one dispensing chamber which, when cartridge and dispenser are assembled, is connected in communicating manner with at least one of the cartridge chambers, wherein the dispensing chamber comprises an inlet for inflow of washing or cleaning agent from a cartridge chamber and an outlet for outflow of washing or cleaning agent from the dispensing chamber into the surrounding environment, wherein at least the outlet of the dispensing chamber is closable or openable by the closing element.

### CROSS REFERENCE TO RELATED APPLICATIONS

This application is a continuation of PCT/EP2009/005107 filed on Jul. 14, 2009, which claims priority under 35 U.S.C. §119 to DE 10 2008 033108.2, DE 10 2008 033238.0, DE 10 2008 033109.0, DE 10 2008 033102.3, DE 10 2008 033239.9, DE 10 2008 033107.4, DE 10 2008 033100.7, DE 10 2008 033237.2 all filed on Jul. 15, 2008.

### BACKGROUND OF THE INVENTION

1. Field of the Invention

The invention relates to a cartridge, a dispenser for coupling with a cartridge and a dispensing system for the release of a plurality of preparations for use in dishwashing machines.

2. Description of the Prior Art

Automatic dishwashing agents are available to consumers in numerous presentations. In addition to traditional liquid manual dishwashing agents, automatic dishwashing agents have in particular become increasingly significant as domestic dishwashing machines have become more common. These automatic dishwashing agents are typically offered for sale to the consumer in solid form, for example as a powder or as tablets, but increasingly also in liquid form. For some considerable time, attention has focused on convenient dispensing of washing and cleaning agents and on simplifying the operations required to carry out a washing or cleaning method.

Furthermore, one of the main objectives of manufacturers of automatic cleaning agents is to improve the cleaning performance of these agents, increasing attention having been paid in recent times to cleaning performance in low temperature cleaning cycles or in cleaning cycles with reduced water consumption. To this end, new ingredients, for example more highly active surfactants, polymers, enzymes or bleaching agents have been added to the cleaning agents. However, since new ingredients are only available to a limited extent and the quantity of the ingredients used per cleaning cycle cannot be increased at will for environmental and economic reasons, there are natural limits to this approach to solving the problem.

In this connection, devices for multiple dispensing of washing and cleaning agents have recently come to the attention of product developers. In terms of these devices, a distinction may be drawn between dispensing chambers integrated into the dishwashing machine or washing machine, on the one hand, and separate devices independent of the dishwashing machine or washing machine, on the other hand. These devices, which contain a multiple of the quantity of cleaning agent required to carry out a cleaning method, automatically or semi-automatically dispense washing or cleaning agent portions into the interior of the cleaning machine over the course of a plurality of successive cleaning processes. For the consumer, manual dispensing for each cleaning or washing cycle is no longer necessary. Examples of such devices are described in European patent application EP 1 759 624 A2 (Reckitt Benckiser) or in German patent application DE 53 5005 062 479 A1 (BSH Bosch and Siemens Hausgeräte GmbH).

### BRIEF SUMMARY OF THE INVENTION

The object of the invention is to provide an improved dispenser, an improved cartridge, and/or improved dispensing system.

The dispensing system according to the invention consists of the basic components of a cartridge filled with preparation and a dispenser couplable with the cartridge, which is in turn formed of further assemblies, such as for example component carrier, actuator, closing element, sensor, energy source and/or control unit.

It is preferred for the dispensing system according to the invention to be mobile. For the purposes of the present application, mobile means that the dispensing system is not nondetachably connected to a water-conveying device, such as for example a dishwashing machine, washing machine, washer/dryer or the like, but may instead be removed for example from a dishwashing machine by the user or be positioned in a dishwashing machine, i.e. may be handled separately.

According to an alternative development of the invention, it is also conceivable for the dispenser to be connected nondetachably for the user to a water-conveying device such as for example a dishwashing machine, washing machine, washer/dryer or the like and for only the cartridge to be mobile.

In order to ensure operation at elevated temperatures, as may for example occur in individual washing cycles of a dishwashing machine, the dispensing system may be formed from materials which are dimensionally stable up to a temperature of 120° C.

Since, depending on the intended purpose, the preparations to be dispensed may have a pH value of between 2 and 12, any components of the dispensing system which come into contact with the preparations should exhibit appropriate acid and/or alkali resistance. In addition, suitable material selection should ensure that these components are as far as possible chemically inert, for example in relation to nonionic surfactants, enzymes and/or scents.

### BRIEF DESCRIPTION OF THE DRAWINGS

FIG. 1 Autonomous dispenser with two-chamber cartridge in the separated and assembled states

FIG. 2 Autonomous dispenser with two-chamber cartridge arranged in a drawer of a dishwashing machine

FIG. 3 Two-chamber cartridge in the separated state, for an autonomous dispenser and an internal dispenser integral to the machine

FIG. 4 Two-chamber cartridge in the assembled state, with an internal dispenser integral to the machine

FIG. 5 Two-chamber cartridge in the separated state, for an autonomous dispenser and an external dispenser integral to the machine

FIG. 6 Two-chamber cartridge in the assembled state with an external dispenser integral to the machine

FIG. 7 Two-chamber cartridge in the separated and assembled state, for an autonomous dispenser integratable into the machine

FIG. 8 Two-chamber cartridge in the assembled state, for an autonomous dispenser integrated into the machine

FIG. 9 Autonomous dispenser with refillable two-chamber cartridge and refill unit

FIG. 10 Cartridge formed from a trough-shaped and a lid-shaped cartridge element

FIG. 11 Cartridge formed from two trough-shaped cartridge elements

FIG. 12 Cartridge formed from a cellular, bottom-less container and a cartridge bottom

FIG. 13 Cartridge formed from a cellular container open at the top, with a cartridge lid

FIG. 14 Cartridge formed from two chamber elements

FIG. 15 Cartridge with refill pouch

FIG. 16 Cartridge with chamber for releasing volatile substances

FIG. 17 Cartridge with interlockingly connected chambers in plan view

FIG. 18 Cartridge with three chambers in front view

FIG. 19 Cartridge with three chambers in plan view

FIG. 20 Two-part cartridge with a trough-shaped and a plate-like cartridge element in exploded view

FIG. 21 Two-part cartridge with a cellular container and a cartridge bottom in exploded view

FIG. 22 Three-chamber cartridge with dispenser in the separated state in perspective view

FIG. 23 Three-chamber cartridge with ventilation orifices in perspective view

FIG. 24 Perspective inside view into a three-chamber cartridge with front wall removed

FIG. 25 Longitudinal sectional view into a three-chamber cartridge

FIG. 26 Longitudinal sectional view of a three-chamber cartridge coupled to the dispenser

FIG. 27 Schematic diagram of the ventilation channel provided in a separating web of the cartridge

FIG. 28 Cartridge and dispenser in the uncoupled state in cross-sectional view

FIG. 29 Cartridge and dispenser in the swivelably engaged state in cross-sectional view

FIG. 30 Combi dispenser with transmit and receive unit

FIG. 31 Combi dispenser with transmit and receive unit with open dispensing chamber lid

FIG. 32 Combi dispenser with receptacle for external dispenser

FIG. 33 Dispenser and transmitter arranged in domestic appliance

FIG. 34 Dispenser and transmitter arranged in domestic appliance, with domestic appliance loaded

FIG. 35 Dispenser and transmitter emitting two signal types arranged in domestic appliance

FIG. 36 Dispenser with transmitter emitting two signal types and receiver in domestic appliance

FIG. 37 Dispenser with optical transmitter, couplable cartridge and transmitters and/or receivers on domestic appliance

FIG. 38 Solenoid valve

FIG. 39 Solenoid valve

FIG. 40 Dispensing chamber with float

FIG. 41 Dispensing chamber with float

FIG. 42 Dispensing chamber with float

FIG. 43 Dispensing chamber with float

FIG. 44 Dispensing device in plate receptacle of a crockery drawer

FIG. 45 Dispensing device with fixing means on bottom

FIG. 46 Dispensing device with fixing means in outer circumferential surface of dispenser

FIG. 47 Dispensing device with plates projecting from bottom

FIG. 48 Dispensing device with release orifices projecting from bottom

FIG. 49 Dispensing device with V-shaped dispenser bottom contour

FIG. 50 Dispensing device with sawtooth-like fixing means

FIG. 51 Dispensing device with wavy fixing means

FIG. 52 Dispenser and cartridge in exploded view

FIG. 53 Component carrier in front view

FIG. 54 Component carrier in exploded view

FIG. 55 Component carrier in exploded view

### DETAILED DESCRIPTION OF THE INVENTION

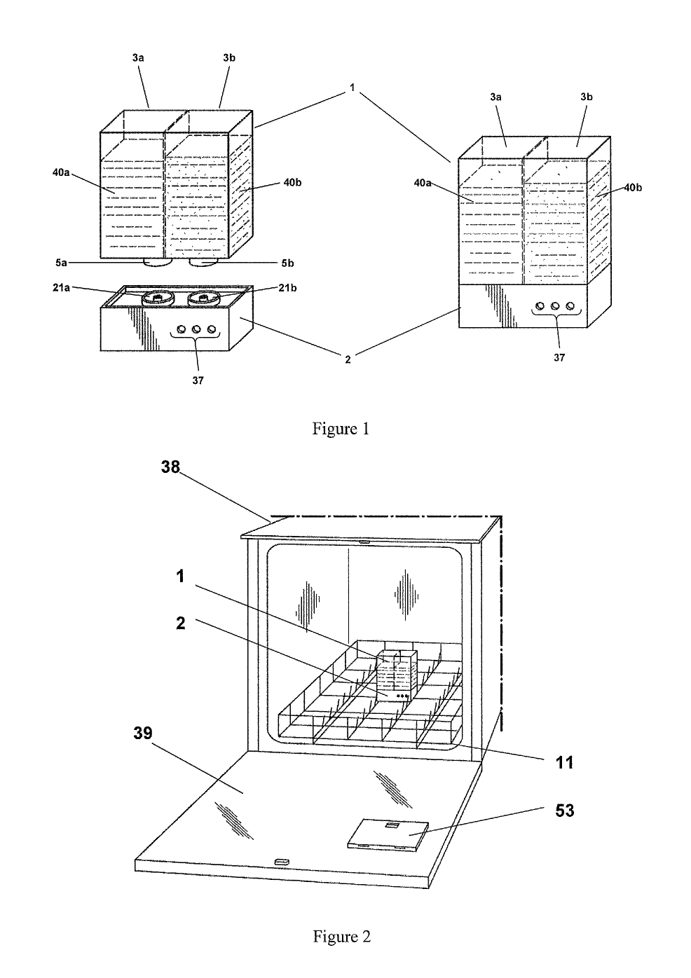

FIG. 1 shows an autonomous dispenser 2 with a two-chamber cartridge 1 in the separated and assembled states.

The dispenser 2 comprises two dispensing chamber inlets 21a, 21b for repeatedly detachable accommodation of the corresponding outlet orifices 5a, 5b of the chambers 3a, 3b of the cartridge 1. Indicator and operating elements 37, which indicate the operating state of the dispenser 2 or have an effect thereon, are located on the front.

The dispensing chamber inlets 21a, 21b additionally comprise means which, when the cartridge 1 is placed on the dispenser 2, bring about opening of the outlet orifices 5a, 5b of the chambers 3a, 3b, such that when dispenser 2 and cartridge 1 are in the coupled state, the interior of the chambers 3a, 3b is connected in communicating manner to the dispensing chamber inlets 21a, 21b.

The cartridge 1 may consist of one or more chambers 3a, 3b. The cartridge 1 may be of single-part construction comprising a plurality of chambers 3a, 3b or be of multi-part construction, wherein the individual chambers 3a, 3b are then assembled to form a cartridge 1, in particular by bonded, interlocking or frictional connection methods.

In particular, fixing may be effected by one or more of the connection types from the group of snap-in connections, press connections, melt connections, adhesive connections, welded connections, brazed connections, screw connections, keyed connections, clamped connections or rebound connections In particular, fixing may also be provided by a heat-shrinkable sleeve, which is drawn in the heated state over at least portions of the cartridge and firmly envelops the cartridge in the cooled state.

The bottom of the cartridge 1 may be inclined in the manner of a funnel towards the release orifice 5a, 5b in order to provide the cartridge 1 with advantageous residual emptying characteristics. Moreover, the internal wall of the cartridge 1 may be constructed by suitable material selection and/or surface finish such that the product adheres only slightly to the internal wall of the cartridge. The residual emptying characteristics of the cartridge 1 may also be further optimized by this measure.

The chambers 3a, 3b of a cartridge 1 may be of identical or different capacities. In a configuration with two chambers 3a, 3b, the ratio of the chamber volumes is preferably 5:1; in a configuration with three chambers preferably 4:1:1, these configurations in particular being suitable for use in dishwashing machines.

One possible connection method may also consist in plugging the chambers 3a, 3b into one of the corresponding dispensing chamber inlets 21a, 21b of the dispenser 2 and thereby fixing them relative to one another.

The connection between the chambers 3a, 3b may in particular be detachable, so as to allow separate replacement of chambers.

The chambers 3a, 3b each contain a preparation 40a, 40b. The preparation 40a, 40b may be of the same or different composition.

Advantageously, the chambers 3a, 3b are made of a transparent material, such that the filling level of the preparations 40a, 40b is visible to the user from outside. It may however also be advantageous to make at least one of the chambers from an opaque material, in particular when the preparation located in this chamber contains light-sensitive ingredients.

The outlet orifices 5a, 5b are designed such that they form an interlocking and/or frictional, in particular liquid-tight, connection with the corresponding dispensing chamber inlets 21a, 21b.

It is particularly advantageous for each of the outlet orifices 5a, 5b to be configured such that it fits onto only one of the dispensing chamber inlets 21a, 21b, so preventing a chamber from being inadvertently plugged onto an incorrect dispensing chamber inlet. This may be achieved for example by outlet orifices 5a, 5b and/or dispensing chamber inlets 21a, 21b which differ in size or basic shape.

The cartridge conventionally has a capacity of <5000 ml, in particular <1000 ml, preferably <500 ml, particularly preferably <250 ml, very particularly preferably <50 ml.

In the assembled state, the dispensing unit 2 and the cartridge 1 may be adapted in particular to the geometries of the devices on or in which they are used, so as to ensure the smallest possible loss in useful volume. To use the dispensing unit 2 and the cartridge 1 in dishwashing machines it is particularly advantageous to shape the dispensing unit 2 and the cartridge 1 in imitation of dishes to be cleaned in dishwashing machines. The dispensing unit 2 and the cartridge 1 may, for example, be plate-shaped, approximately assuming the dimensions of a plate. In this way, the dispensing unit may be positioned in space-saving manner in the lower basket.

The outlet orifices 5a, 5b of the cartridge 1 are preferably arranged in a line or row, so making a slender, plate-shaped configuration of the dispenser possible.

FIG. 2 shows an autonomous dispenser with a two-chamber cartridge 1 in the crockery drawer 11 when the door 39 of a dishwashing machine 38 is open. It will be noted that the dispenser 2 may be positioned together with the cartridge 1 in principle at any desired point within the crockery drawer 11, wherein it is advantageous for a plate- or cup-shaped dispensing system 1, 2 to be provided in a corresponding plate or cup receptacle in the crockery drawer 11. In the dishwashing machine door 39 there is located a dispensing chamber 53, into which a dishwashing machine cleaning preparation may be introduced, for example in the form of a tablet. If the dispensing system 1, 2 is in the operational state inside the dishwasher 38, the addition of cleaning preparation for each washing cycle via the dispensing chamber 53 is not necessary, since cleaning agent release is provided for a plurality of washing cycles via the dispensing system 1, 2, this being explained below in greater detail. An advantage of this embodiment of the invention is that, when the autonomous dispensing system 1, 2 is arranged in the lower crockery drawer 11, preparations 40a, 40b are released from the cartridge 1 directly via the outlet orifices arranged on the dispenser into the washing liquor, such that quick dissolution and uniform distribution of the washing preparations in the washing program is ensured.

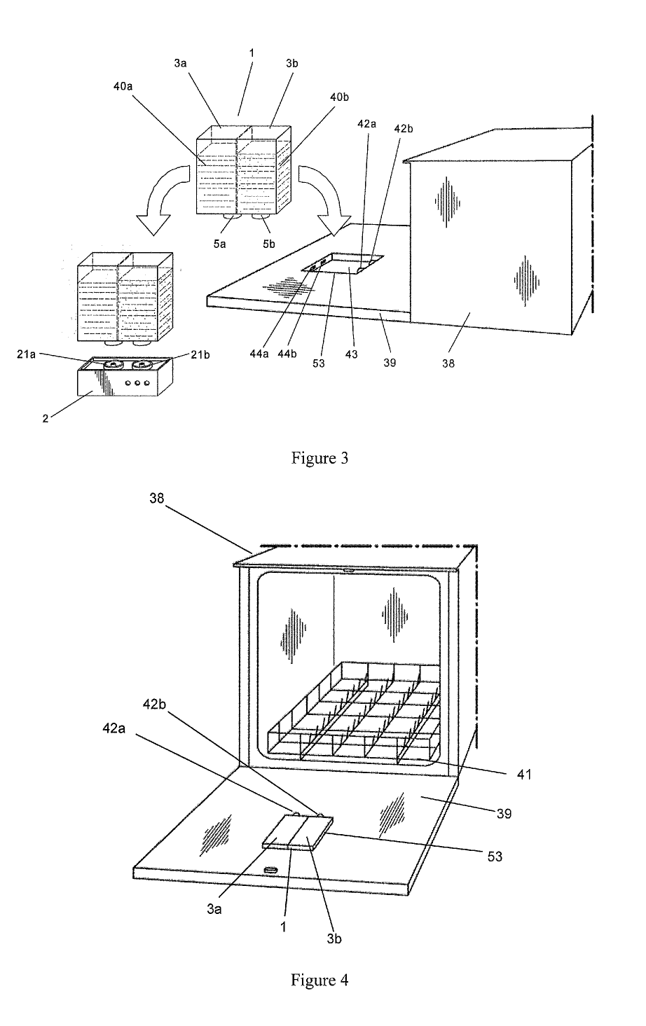

FIG. 3 shows a two-chamber cartridge 1 in the separated state, for an autonomous dispenser 2 and an internal dispenser integral to the machine. Here the cartridge 1 is designed in such a way that it is couplable both to the autonomous dispenser 2 and to the dispenser integral to the machine (not shown, may be located for example in the dishwashing machine door 39), which is indicated by the arrows shown in FIG. 3.

On the side of the dishwashing machine door 39 directed towards the interior of the dishwashing machine 38, a recess 43 is formed, into which the cartridge 1 may be inserted, wherein by such insertion the outlet orifices 5a, 5b of the cartridge 1 are connected in communicating manner with the adapter pieces 42a, 42b. The adapter pieces 42a, 42b are in turn coupled to the dispenser integral to the machine.

To fix the cartridge 1 in the recess 43, retaining elements 44a, 44b may be provided on the recess 43, which ensure frictional and/or interlocking fixing of the cartridge in the recess 43. It goes without saying that it is also conceivable for corresponding retaining elements to be provided on the cartridge 1. The retaining elements 44a, 44b may preferably be selected from the group of snap-fit connections, latching connections, snap-fit/latching connections, clamped connections or plug-connections.

When the dishwashing machine 38 is in operation, preparation 40a, 40b from the cartridge 1 is introduced by the dispenser integral to the machine through the adapter elements 42a, 42b to the corresponding washing cycle.

FIG. 4 shows the cartridge 1 known from FIG. 3 installed in the door 39 of a dishwashing machine 38. It will be noted that, by integrating the dispensing unit 2 and the cartridge 1 into the door 39 of the dishwashing machine, no space for items to be washed is lost in the crockery drawer 11, which constitutes a significant advantage of this embodiment.

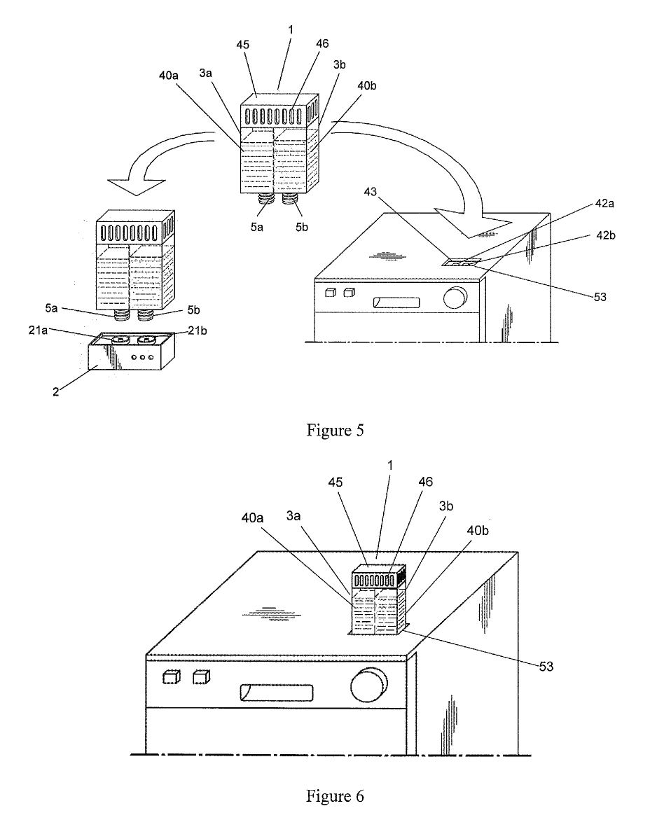

Another embodiment of the invention is shown in FIG. 5. FIG. 5 shows the cartridge 1 known from FIG. 3 with a chamber 45 arranged on the top of the cartridge 1, which chamber comprises a plurality of orifices 46 in its outer circumferential surface. Preferably, the chamber 45 is filled with an air freshening preparation, which is released through the orifices 46 into the surrounding environment. The air freshening preparation may comprise in particular at least one scent and/or one odor-controlling substance.

Unlike with the arrangement known from FIG. 3 and FIG. 4 of the cartridge 1 in the interior of a dishwashing machine 38, it is also possible to provide a recess 43 with adapter elements 42a, 42b for coupling to the cartridge 1 on an external surface of a dishwashing machine 38. This is shown by way of example in FIG. 5 and FIG. 6. This development may be advantageous in particular for highly temperature-sensitive preparations 40a, 40b, since they are not exposed directly to the temperature fluctuations conventionally arising during the washing program.

It goes without saying that the cartridge 1 illustrated in FIG. 5 and FIG. 6 may also be arranged with a chamber 45 containing an air freshening substance in a correspondingly constructed receptacle in the interior of a dishwashing machine 38.

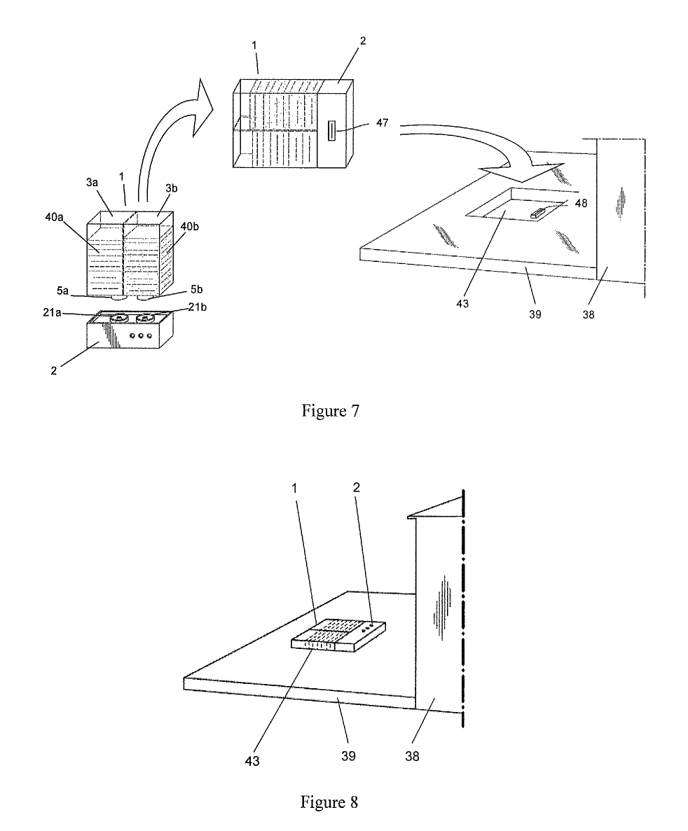

A further development of the invention is shown in FIG. 7 and FIG. 8. The dispenser 2 may here be coupled to the cartridge 1, this being indicated accordingly in the drawing by the first, left-hand arrow. Then, cartridge 1 and dispenser 2 are coupled as an assembly via the interface 47, 48 to the dishwasher, as shown by the right-hand arrow. The dispenser 2 comprises an interface 47, via which data and/or energy are transmitted to and/or from the dispenser 2. In the door 39 of the dishwasher 38 a recess 43 is provided for accommodating the dispenser 2. In the recess 43 a second interface 48 is provided, which transmits data and/or energy to and/or from the dispenser 2.

Preferably, data and/or energy are exchanged wirelessly between the first interface 47 on the dispenser 2 and the second interface 48 on the dishwasher 38. It is particularly preferable for energy to be transmitted from the interface 48 of the dishwasher 38 wirelessly via the interface 47 to the dispenser 2. This may, for example, proceed inductively and/or capacitively.

It is furthermore advantageous for the interface for data transmission also to be of wireless configuration. This may be achieved using the methods known in the prior art for wireless data transmission, such as for example by means of radio transmission or IR transmission. It is particularly preferable for data and signal transmission to take place wirelessly by means of optical transmission technologies using the visible range.

Alternatively, the interfaces 47, 48 may also take the form of integral plug-in connections. Advantageously, the plug-in connections are configured in such a way that they are protected from the ingress of water or moisture.

FIG. 8 shows the dispensing system 1, 2 coupled to the dishwashing machine 38 in the recess 43 in the dishwashing machine door 39.

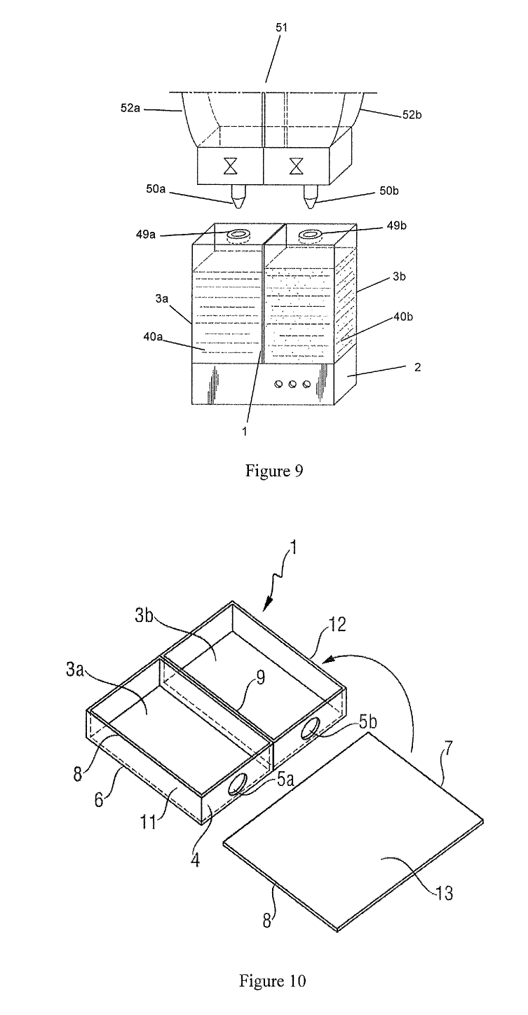

FIG. 9 shows a cartridge 1, the chambers 3a, 3b of which may be filled by way of the orifices 49a, 49b in the top for example by means of a refill cartridge 51. The orifices 49a, 49b in the cartridge 1 may for example take the form of silicone valves, which open when pierced by the adapter 50a, 50b and close again upon removal of the adapter 50a, 50b, such that preparation is prevented from flowing unintentionally out of the cartridge.

The adapters 50a, 50b are designed such that they may pierce the orifices 49a, 49b in the cartridge 1. Advantageously, the orifices 49a, 49b in the cartridge 1 and the adapter 50a, 50b are configured with regard to position and size in such a way that the adapter can only engage in the orifices 49a, 49b in a predefined position. In this way, incorrect filling of the cartridge chambers 3a, 3b may in particular be prevented, and it is ensured that in each case the same or a compatible preparation passes from a chamber 52a, 52b of the refill cartridge 51 into the corresponding chamber 3a, 3b of the cartridge 1.

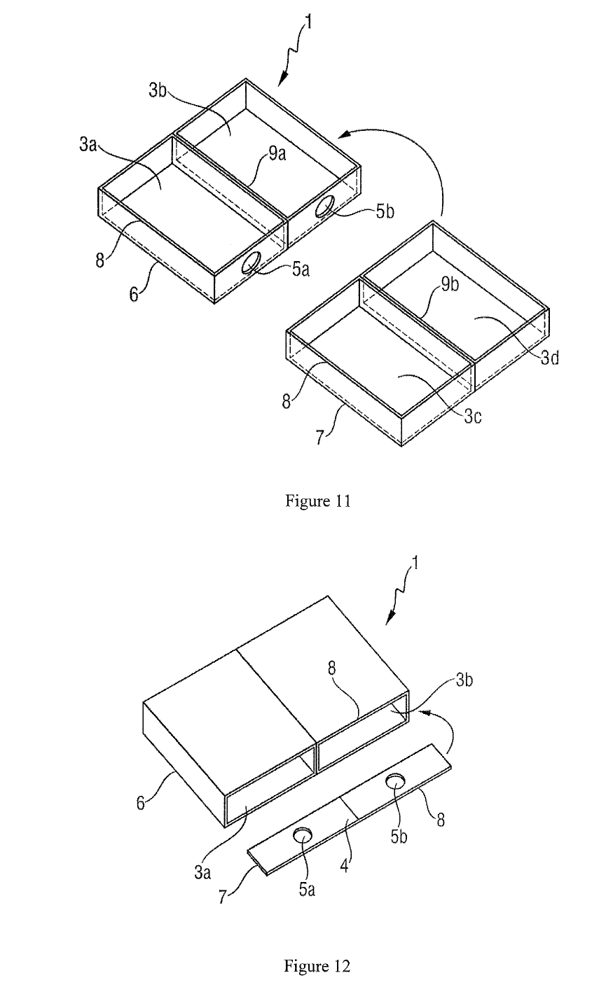

Further exemplary embodiments of the cartridge known from the above figures are shown in FIG. 10 to FIG. 16.

In a first embodiment, which is reproduced in FIG. 10, the cartridge 1 consists of a first trough-shaped element 6 and a second plate- or lid-like element 7, the two elements 6, 7 being shown unassembled in FIG. 10. The second, plate- or lid-like element 7 is dimensioned such that, when the cartridge 1 is in the assembled state, it completely covers the first trough-shaped element 6 along the connecting edge 8.

The first, trough-shaped element 6 is formed by the cartridge top 10, the cartridge side faces 11 and 12 and the cartridge bottom 4. The two chambers 3a, 3b of the cartridge 1 are defined by the separating web 9. An outlet orifice 5a, 5b is in each case provided in the cartridge bottom 4 for each of the chambers 3a, 3b. The cartridge 1 is formed by bonding together the first, trough-shaped element 6 and the second, plate- or lid-like element 7, the connecting edge 8 not intersecting the outlet orifices 5a, 5b of the cartridge 1 in the assembled state.

A further possible embodiment of the cartridge is shown in FIG. 11, in which two cartridge elements 6, 7 are likewise shown in the as yet unassembled state. The two cartridge elements 6, 7 are in this case of mirror-symmetrical construction, such that in the assembled state the connecting edges 8 of the two elements 6, 7 rest fully on one another. The outlet orifices 5a and 5b are here formed merely in the bottom 4 of the first cartridge element 6, such that the connecting edges 8 of the elements 6, 7 extend on the cartridge bottom 4 at a distance from the outlet orifices 5a, 5b and the connecting edge 8 thus does not intersect the outlet orifices 5a, 5b. In this way, more reliable sealing of the outlet orifices 5a, 5b may be ensured, since material deformations in the region of the outlet orifices 5a, 5b resulting from thermal stresses are more uniform and uneven deformation does not arise as a result of an abutting or connecting edge 8, which may lead subsequently to undesired sealing problems, in particular on insertion of the cartridge and/or during the temperature fluctuations within a washing program.

FIG. 12 shows a modification of the cartridge known from FIG. 10 and FIG. 11. In this embodiment the first cartridge element 6 takes the form of a single-part, cellular, bottom-less plastics container. The cartridge 1 is formed by fitting the bottom 4 to the container 6 along the connecting edge 8, which is indicated in the figure by the arrow. The bottom 4 comprises a first orifice 5a and a second orifice 5b, which, when the cartridge 1 is in the assembled state, allow preparation to flow out of the respective chambers 3a, 3b. Here too the connecting edge 8 extends at a distance from the outlet orifices 5a, 5b when the cartridge 1 is in the assembled state.

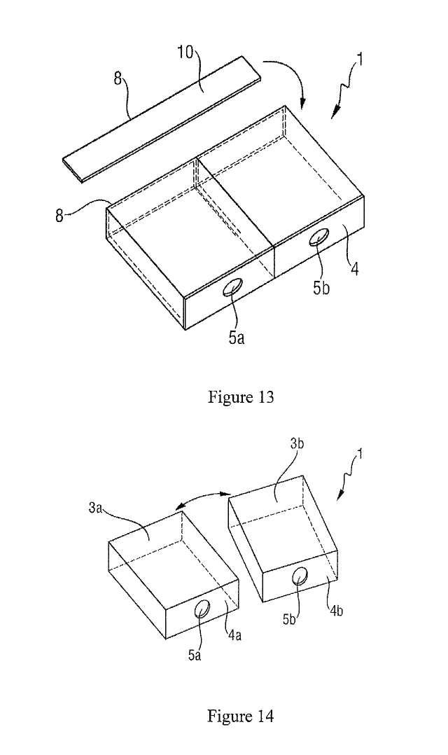

Alternatively, it is also conceivable for a cartridge element 6 to take the form of a cellular container open at the top, with the chambers 3a, 3b and the second element forming a cartridge lid 10, which is connected in liquid-tight manner to the cellular container open at the top along the connecting edge 8, wherein again the connecting edge 8 extends at a distance from the outlet orifices 5a, 5b when the cartridge 1 is in the assembled state, as is clear from FIG. 13.

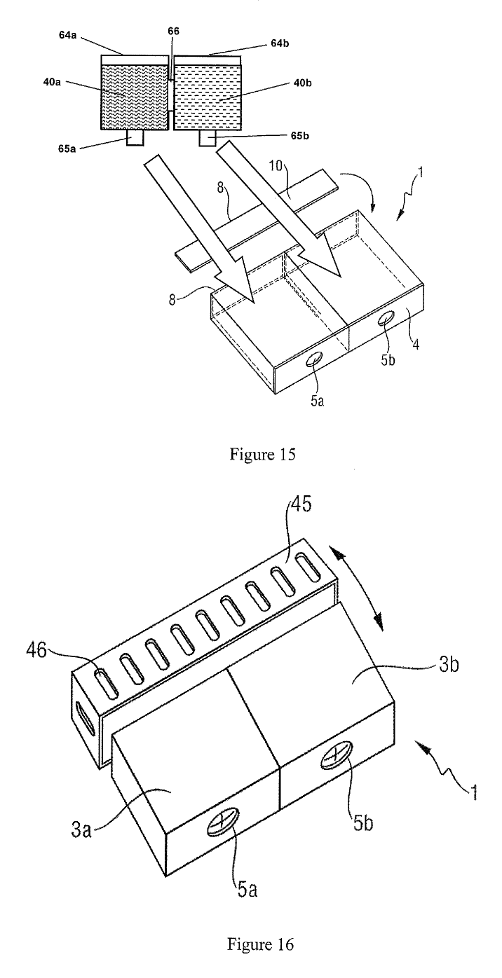

FIG. 14 shows that the cartridge 1 may also be formed of two separately formed chambers 3a, 3b. In particular, the chambers 3a, 3b may here be formed by blow-molding. In this variant embodiment the two chambers 3a, 3b are connected detachably or nondetachably together interlockingly and/or frictionally and/or by material bonding, so forming the cartridge 1.

FIG. 15 shows the cartridge 1 known from FIG. 13 in the form of a receiving container for a pouch 64 filled with preparation 40, such that insertion of the pouches into the cartridge chambers, which is indicated by the arrows in the Figure, forms a “bag-in-bottle” container. The orifices 65a, 65b of the pouch 64a, 64b are designed such that they may be inserted into the orifices 5a, 5b in the cartridge 1. Preferably the orifices 65a, 65b take the form of dimensionally stable plastics cylinders. It is on the one hand conceivable for in each case one pouch 64a, 64b to be positioned in a corresponding chamber of the cartridge 1, but it is also possible to construct a multi-chamber pouch connected by way of a web 66, which multi-chamber pouch is inserted as a whole into the cartridge. After insertion of the pouch 64 into the cartridge 1, the latter is detachably closed by the cartridge top 10. It is particularly advantageous, to prevent undesired loss of the cartridge top 10, to fix the latter swivelably to the cartridge 1, for example by means of a material bridge.

FIG. 16 shows a further development of the cartridges known from FIG. 10 to FIG. 14, in which a further chamber 45 for accommodating a preparation is arranged on the cartridge and is configured in such a way as to effect release of volatile substances from the preparation into the surrounding environment of the chamber 45. Volatile scents or air freshening substances for example may be situated in the chamber 45 and released through the orifices 46 in the chamber 45 into the surrounding environment.

It will additionally be noted that the orifices 5a, 5b are closed by silicone valves which comprise an x-shaped slit. This prevents preparation 40 from escaping from the uncoupled cartridge 1 when the cartridge 1 is detached from the dispenser 2.

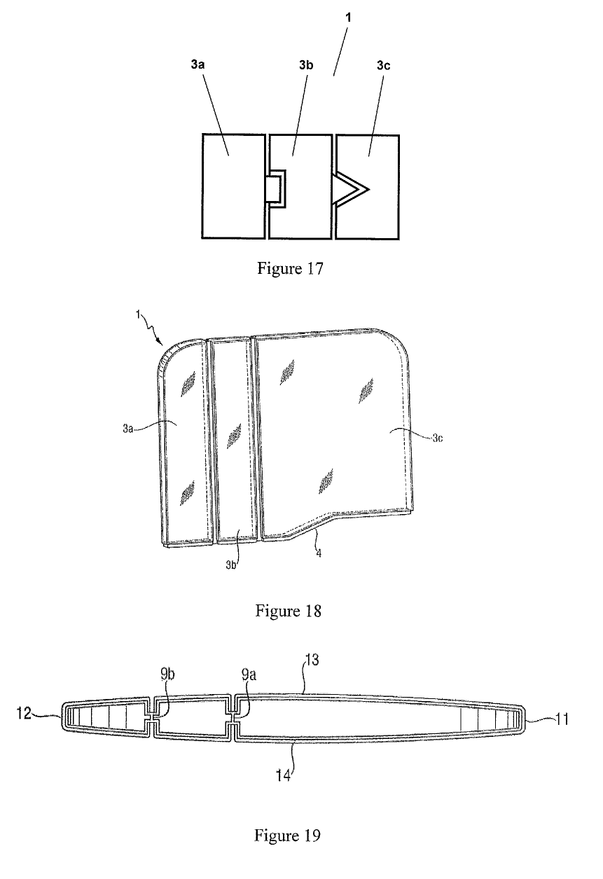

FIG. 17 shows a cartridge 1 with individually replaceable chambers 3a, 3b, 3c, in plan view. The chambers 3a, 3b, 3c are here configured in such a way, by matching contours of their outer circumferential surfaces, that they can be assembled to form a cartridge 1 only in a predetermined, defined arrangement. This makes it possible, in particular, to provide individually replaceable chambers without the risk of an undesired arrangement of chambers and the preparations corresponding thereto.

FIG. 18 shows a further possible embodiment of the cartridge 1 with three chambers 3a, 3b, 3c. The first chamber 3a and the second chamber 3b have approximately the same capacity. The third chamber 3c has a capacity which is for instance 5 times that of chamber 3a or 3b. The cartridge bottom 4 comprises a ramp-shaped step in the region of the third chamber 3c. This asymmetric configuration of the cartridge 1 makes it possible to ensure that the cartridge 1 is couplable to the dispenser 2 in a position intended therefor and insertion in an incorrect position is prevented by a corresponding configuration of the dispenser 2 or the bracket 54.

The plan view of the cartridge shown in FIG. 19 shows the separating webs 9a and 9b, which separate the chambers of the cartridge 1 from one another. The cartridge known from FIG. 18 and FIG. 19 may be formed in various ways.

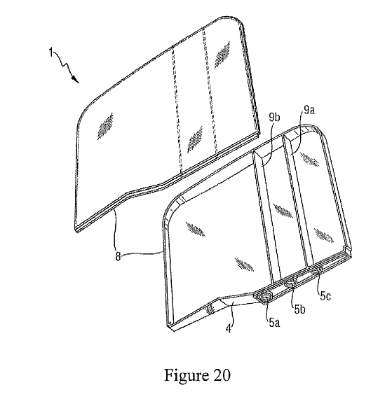

In a first variant, which may be inferred from FIG. 20, the cartridge 1 is formed of a first trough-like cartridge element 7 and a second, lid- or plate-like cartridge element 6. The separating webs 9a and 9b are provided in the trough-like cartridge element 7 and form the three chambers of the cartridge 1. On the bottom 4 of the trough-shaped cartridge element 7 the outlet orifices 5a, 5b, 5c are arranged in each case under the chambers of the cartridge 1.

As is additionally clear from FIG. 20, the bottom 4 of the cartridge in the region of the third chamber 3c comprises a ramp-like step, which forms a slope on the chamber bottom in the direction of the third outlet orifice 5c. In this way, it is ensured that preparation located in this chamber 3c is always conveyed in the direction of the outlet orifice 5c and thus good residual emptying characteristics of the chamber 3c are achieved.

When the cartridge 1 is assembled, the trough-shaped cartridge element 7 and the lid-like cartridge element 6 are bonded together along the common connecting edge 8. This may be achieved for example by welding or adhesive bonding. It goes without saying that, when the cartridge 1 is assembled, the webs 9a, 9b are also bonded to the cartridge element 6.

The connecting edge 8 does not here run through the outlet orifices 5a-c, so avoiding leakage problems in the region of the orifices 5a-c, in particular in the state coupled to the dispenser.

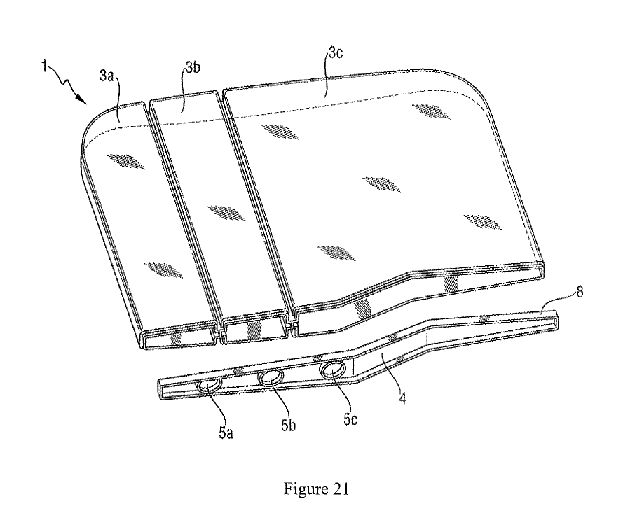

A further variant for embodying the cartridge is shown in FIG. 21. The first cartridge element 6 is here of cellular construction and comprises an open bottom. The separately formed bottom 4 may be inserted as a second cartridge element 7 into the orifice at the bottom of the cellular cartridge element 6 and bonded thereto along the common connecting edge 8. An advantage of this variant is that the cellular element 6 may be produced inexpensively by a plastics blow molding method.

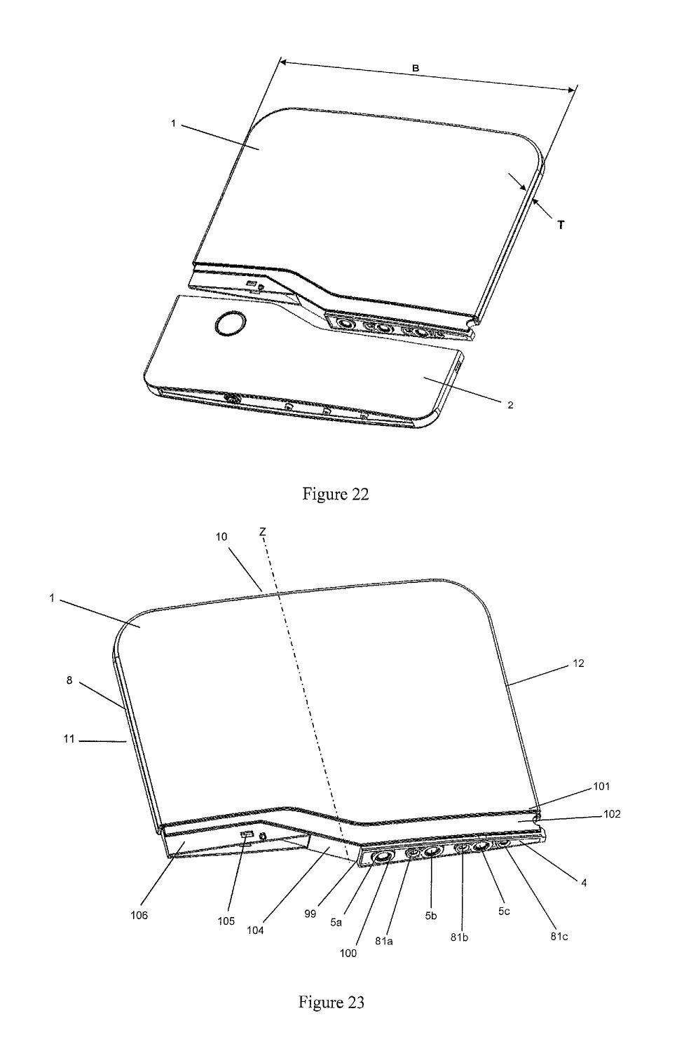

FIG. 22 shows a further embodiment of the cartridge 1 and of the dispenser 2 in the uncoupled state. The cartridge 1 of FIG. 21 is explained in greater detail with reference to FIG. 22.

FIG. 22 shows the cartridge 1 known from FIG. 21 in a perspective view. Outlet orifices 5 and ventilation orifices 81 are arranged alternately on the cartridge bottom 4. An outlet orifice 5 and a ventilation orifice 81 are provided in each case for each of the chambers in the cartridge 1. The width (B) is substantially greater than the depth (T) of the cartridge 1. The ratio of the depth (T) to the width (B) of the cartridge 1 amounts to approximately 1:20.

The region of the cartridge bottom 4 in which the outlet and ventilation orifices are arranged is enclosed by a peripheral collar 99 (see also FIG. 23). This collar 99 on the one hand effects structural reinforcement of the cartridge 1 in the bottom region, which prevents deformation in the bottom region 4 in particular upon insertion of the cartridge 1, when corresponding pressure forces act on the bottom region 4 for coupling the cartridge 1 to the dispenser 2, so enabling controlled and secure insertion of the cartridge 1 into the dispenser 2.

In addition, the collar 99 offers protection against undesired mechanical action on the closures of the outlet and ventilation orifices. As is clear from FIG. 22 and FIG. 23, the outlet and ventilation orifices 5, 81 are set back relative to the collar 99, such that the orifices 5, 81 are protected for example from direct exposure to objects which are larger than the orifices.

As is additionally apparent from FIG. 23, the outlet and ventilation orifices 5, 81 in each case comprise a collar 100. This collar 100 bordering the outlet and ventilation orifices 5, 81 serves in structural reinforcement of the outlet and ventilation orifices 5, 81 in the bottom region 4 of the cartridge 1. Furthermore, the collar 100 may serve in the attachment of closing means for the outlet and ventilation orifices 5, 81, for example for closing stoppers or closing lids.

The collar 100 of one of the outlet and ventilation orifices 5, 81 is set back relative to the collar 99, such that the collar 100 does not project beyond the edge of the collar 99.

It is clear from FIG. 23 that the cartridge 1 is of asymmetric construction with regard to its Z-Z axis. This asymmetry ensures that the cartridge 1 is couplable with the dispenser 2, in particular with the inlet orifices 21 of the dispenser 2, only in a defined way. In this way the principle of a mechanical lock and key is achieved between cartridge 1 and dispenser 2, which prevents incorrect operation during coupling of the cartridge 1 to the dispenser 2.

The asymmetry of the cartridge 1 is also achieved inter alia in that the bottom 4 comprises two planes, the first plane being formed by the collar 99 enclosing the outlet and ventilation orifices 5, 81 and the second plane being a bottom portion which is stepped towards the cartridge top 10 by way of a ramp 104, as is clearly visible for example in FIG. 22 and FIG. 23.

Starting from the ramp 104, a further collar 105 comprising an orifice 106 extends from the bottom portion of the second plane. With a corresponding engagement element on the dispenser 2, the orifice 106 forms a detachable latching connection for securing the cartridge 1 in the coupled state with the dispenser 2.

FIG. 23 additionally shows a peripheral edge 101 in the lower, bottom region of the cartridge 1. From this edge 101 a peripheral wall portion 102 of the cartridge 1 extends in the direction of the bottom, this wall portion being set back towards the interior of the cartridge 1, such that a shoulder extending towards the interior of the cartridge is provided between the edge 101 and the wall portion 102.

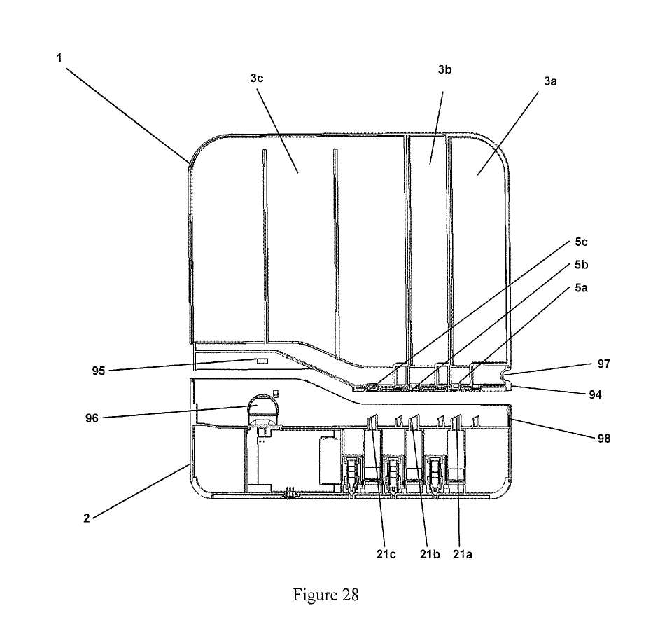

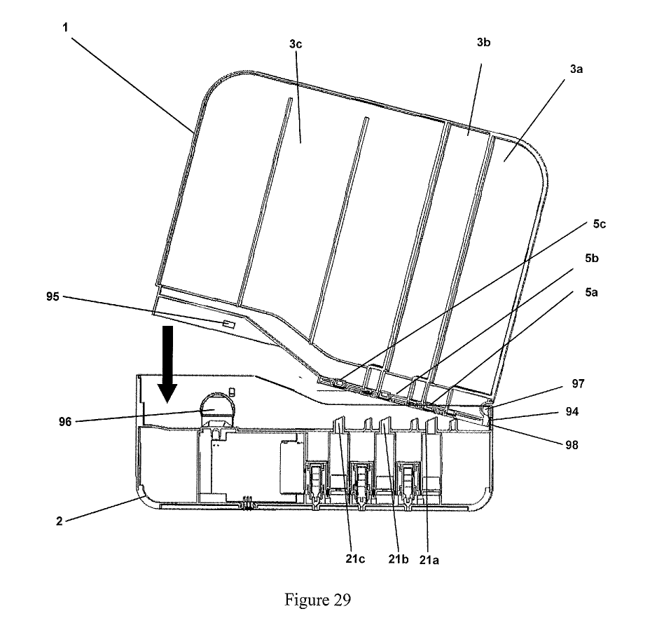

The dispenser 2 is configured in such a way that the peripheral wall portion 102 may be introduced into the collar 103 of the dispenser 2 (see also FIGS. 28-29), wherein, when cartridge 1 and dispenser 2 are coupled together, the edge 101 of the cartridge rests on the collar 103 of the dispenser, such that the space surrounded by the collar 103 of the dispenser 2 is protected at least from splash water ingress. The collar 103 of the dispenser 2 and the edge 101 of the cartridge may in particular also be configured such that, when cartridge 1 and dispenser 2 are coupled together, ingress of water into the dispenser space surrounded by the collar 103 is prevented by the edge 101 resting substantially tightly on the collar 103.

Furthermore, the inwardly offset wall portion 102 of the cartridge acts in conjunction with the collar 103 on the dispenser to form a guide for the cartridge 1 on insertion into the dispenser 2.

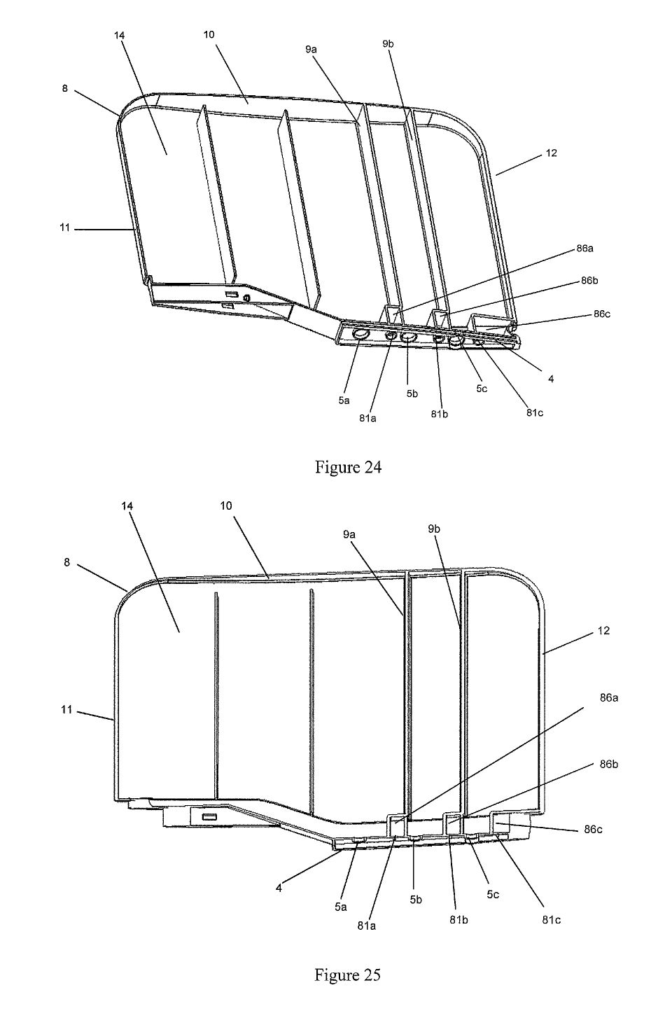

The cartridge 1 is formed from two elements, which are welded together interlockingly at the peripheral connecting edge 8. FIG. 24 shows the cartridge 1 known from FIG. 23 with a lid-like element removed along the connecting edge 8, such that FIG. 24 provides a view into the interior of the cartridge 1.

It is apparent that the cartridge 1 is subdivided into three chambers by the two separating webs 9a, 9b, wherein each of the chambers comprises an outlet orifice 5 at the bottom in the direction of gravity.

At the bottom end of the separating webs 9 there are arranged ventilation chambers 86, which border the ventilation orifices 81 on the cartridge interior. The ventilation chambers 86 serve on the one hand in structural reinforcement of the cartridge bottom 4 in the region of the ventilation orifices 81, such that deformation during coupling of the cartridge 1 with the dispenser 2 is prevented, and on the other hand in connecting the ventilation orifices 81 and the ventilation channels 82. As is apparent in particular from FIGS. 24-26, the ventilation chambers 86 are cuboid. The ventilation chambers 86 are connected in communicating manner to the ventilation channel 82 (not shown in FIGS. 24-26).

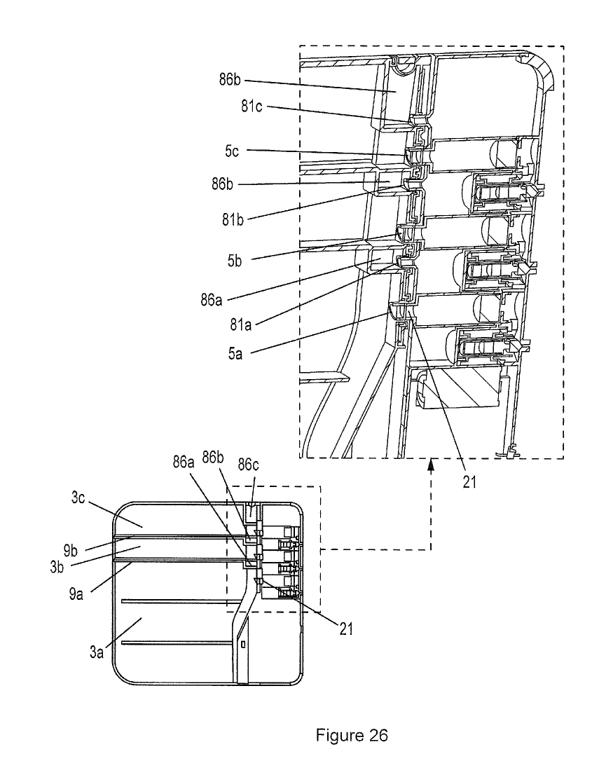

FIG. 26 shows the cartridge 1 and the dispenser in the coupled state in a cross-sectional view. It is clear that the pin-like inlets 21 project into the interior of the cartridge chambers 3 or of the ventilation chambers 86 when dispenser 2 and cartridge 1 are in the coupled state, wherein in particular the pin-like inlets 21 of the dispenser 2 form a liquid-tight connection with the outlet orifices 5 of the cartridge, such that preparation from the chambers 3 can only enter the dispenser 2 through the interior of the pin-like inlets 21. As is also clearly visible from FIG. 26, the outlet orifices 5a-c and the ventilation orifices 81a-c lie on a line, wherein a corresponding ventilation orifice 81a-c is assigned to each outlet orifice 5a-c.

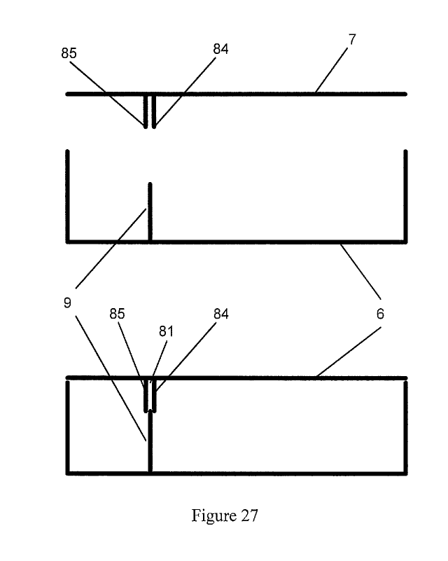

FIG. 27 shows schematically how a ventilation channel is formed by connecting two cartridge elements 6, 7. In the upper part of FIG. 27 the two cartridge elements 6, 7 are shown separated from one another. The cartridge element 7 is of plate-like construction, wherein two mutually spaced webs 84, 85 extend perpendicularly from the cartridge element 7. The webs 84, 85 are configured in such a way that they can encompass a web 9 foamed on the cartridge element 6, as is apparent from the bottom part of FIG. 27. The fit is selected in this case such that the inner sides of the webs 84, 85 rest gently against the web 9. The two webs 84, 85 and the web 9 form the ventilation channel 81 when the cartridge elements 6, 7 are in the assembled state. It is particularly advantageous for the ends of the webs 84, 85 to be bonded to the web 9, in particular by welding. Hot plate and/or laser welding have proven particularly advantageous for this purpose.

In FIG. 28 the dispenser 2 and the cartridge 1 are shown uncoupled. This figure shows the indentation 97 in the cartridge 1 below the external chamber 3a. The indentation 97 is of approximately semicircular construction and comprises a shoulder 94 at its end near the bottom. The indentation 97 and the shoulder 94 are configured such that the shoulder 94 may be introduced into a recess 98 in the dispenser 2 by a swiveling movement of the cartridge 1 during coupling of the cartridge 1 with the dispenser 2. This is shown by way of example in FIG. 29. As a result of detachable connection between the recess 98 in the dispenser and the shoulder 94 on the cartridge, the cartridge 1 is swivelably fixed during coupling of the cartridge 1 to the dispenser 2 by the indicated swiveling movement (arrow). It is apparent that during coupling by the swiveling movement around the connection of the recess 98 and shoulder 94, sequential opening or coupling of the outlet orifices 5a, 5b, 5c and ventilation orifices 81 takes place. First of all, on initial coupling of cartridge 1 and dispenser 2 by swiveling, a ventilation orifice 81a-c is thus opened, before the associated outlet orifice 5a-c is pierced. After completion of the swiveling movement, the snap-in elements 95 and 96 on the cartridge 1 and the dispenser 2 secure the cartridge 1 in the coupled position. The snap-in elements 95, 96 are configured such that the latched connection may be undone by the user, for example cartridge 1 and dispenser 2 may be redetached from one another by pressing together the clip-like snap-in element 96 and by effecting a swiveling movement around the connection between recess 98 and shoulder 94.

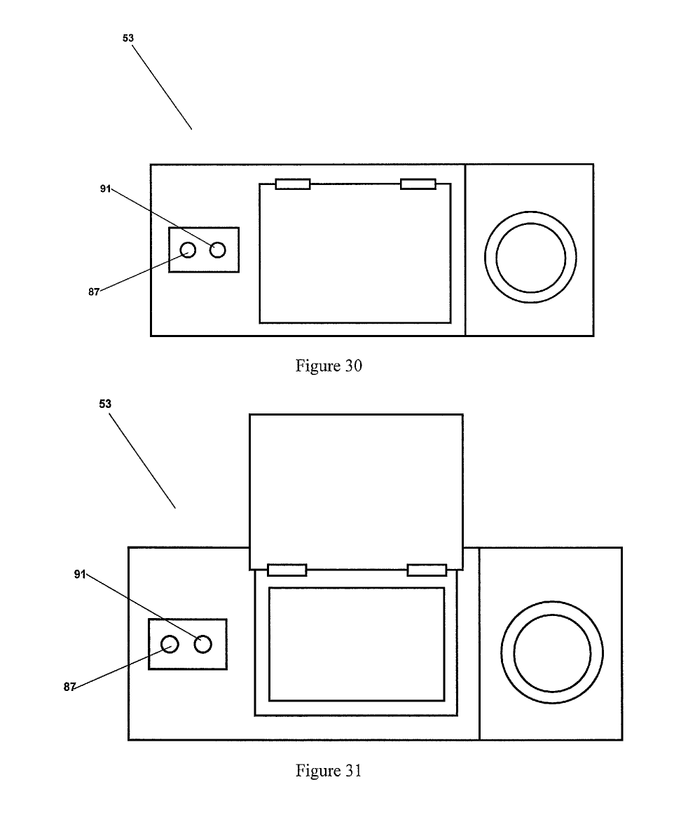

FIG. 30 shows a dispensing chamber 53 into which a transmit unit 87 and a receive unit 91 have been integrated. Such a dispensing chamber 53 is also known as a combi dispenser. The dispensing chamber 53 comprises a receptacle, closable by a coupled-on closing lid, for a dishwashing agent. FIG. 31 shows the closing lid in its open position. In addition, the dispensing chamber 53 may also comprise a receptacle for a rinse aid, which is indicated by the circular closure to the right of the closing lid in FIGS. 30 and 31.

The transmit unit 87 comprises a luminous means, which is arranged in the transmit unit 87 in such a way that the luminous means radiates into the interior of the dishwashing machine. The luminous means may in particular be an LED or a laser diode. The LED is arranged such that it projects out of the plane of the transmit unit 87, such that the LED produces the largest possible angle of radiation.

The transmit unit 87 may be configured in such a way that the LED is provided both for emitting signals inside the dishwasher 38, in particular when the dishwashing machine door 39 is closed, and for optical display of an operating state, for example the filling level of the salt or rinse aid storage container of a dishwashing machine, in particular when the dishwashing machine door 39 is open.

The receive unit 91 preferably consists of a photodiode, which is suitable for detecting light signals from the interior of the dishwashing machine. Like the transmit unit 87, the photodiode of the receive unit 91 may also project out of the plane of the receive unit in order as far as possible to optimize irradiation characteristics onto the photodiode.

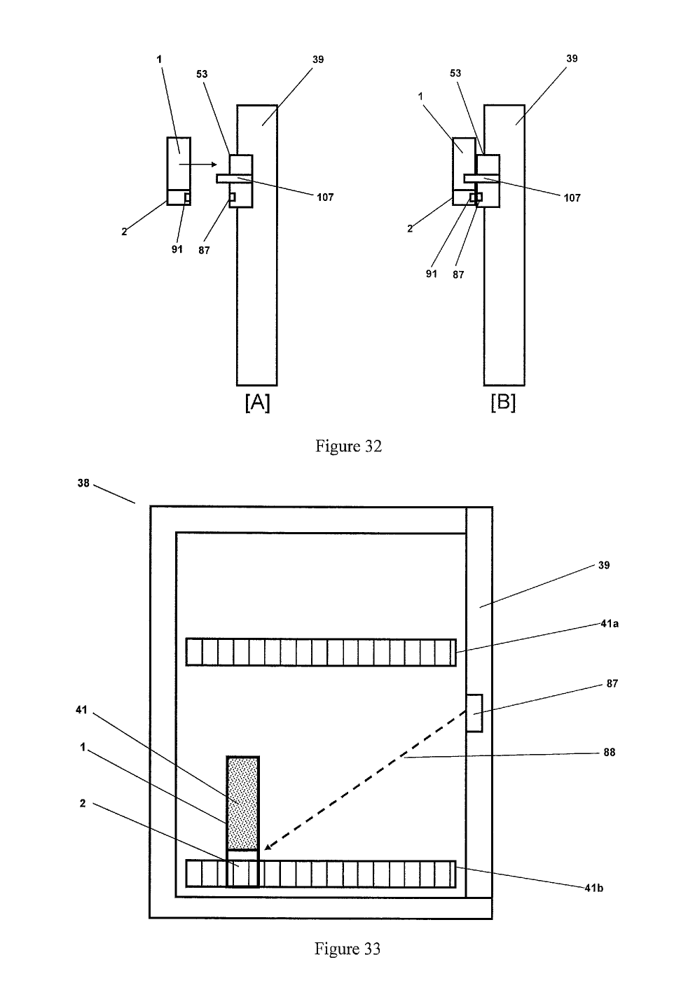

It is also possible for the dispensing chamber 53 to comprise a receptacle 107, by means of which a mobile dispensing system consisting of dispenser 2 and cartridge 1 may be coupled detachably or fixedly with the dispensing chamber 53. This is shown schematically in FIG. 32.

In this variant embodiment, the dispensing chamber 53 is integrated fixedly into a dishwashing machine door 39. The dispenser 2 comprises a receive unit 91, which is suitable for receiving signals from the transmit unit 87 of the dispensing chamber 53. As is clear from FIG. 32 (B), when dispensing system and dispensing chamber 53 are in the coupled state, the receive unit 91 on the dispenser and the transmit unit 87 on the dispensing chamber lie directly opposite one another, so achieving the smallest possible distance between transmit unit 87 and receive unit 91.

The receptacle 107 may form for example an interlocking and/or frictional detachable or fixed connection, for example a snap-fit/latching connection, with the dispensing system.

How the transmit unit 87 interacts with a dispenser 2 arranged inside a dishwashing machine 38, in particular in a crockery drawer, is explained below with reference to FIGS. 33-36.

FIG. 33 will be examined first of all. A dishwashing machine 38 is shown in a schematic cross-sectional view. Inside the dishwashing machine 38, arranged one above the other, are two crockery drawers 41a, 41b for accommodating items to be washed such as for example plates, cups etc. The dishwashing machine 38 has a swivelable door 39, which is shown closed in FIG. 33. Integrated into the dishwashing machine door 39 is a transmit unit 87, which is coupled to the controller of the dishwashing machine 38. Preferably, the transmit unit 87 is integrated into a combi dispenser 53 according to FIGS. 30-31.

The transmit unit 87 comprises an LED, which emits an optical signal 88, which bears control information, into the interior of the dishwashing machine 38. This signal and the direction thereof are indicated by the arrow in FIG. 33. The broken line of the arrow indicates that the optical signals 88 emitted by the transmit unit 87 are photoflashes or light pulses.

The dispenser 2 with a cartridge 1 is positioned in the lower crockery drawer 41b. It goes without saying that it is possible to arrange the dispenser 2 with the cartridge 1 at any desired, suitable location in the lower or upper crockery drawer 41, wherein plate receptacles provided in or on the crockery drawer 41 are preferable for arrangement of the dispenser 2.

The dispenser 2 has a receive unit 91, which is not shown in FIG. 33. The optical signals 88 emitted by the transmit unit 87 are received by the receive unit 91 of the dispenser 2 and evaluated or converted by the control unit of the dispenser 2.

At the start in particular of a washing program, an optical signal 88 may be emitted by the transmit unit 87, which signal, after reception by the dispenser 2, has the effect that control of the dispenser 2, in particular control of dispensing times and quantities, is transferred to the controller of the dishwashing machine 38. This is particularly advantageous when the controller of the dispenser 2 has its own dispensing programs for operation autonomously of the dishwashing machine 38, but these programs are not to be executed upon detection of a corresponding signal 88 from a transmit unit 87 which is present.

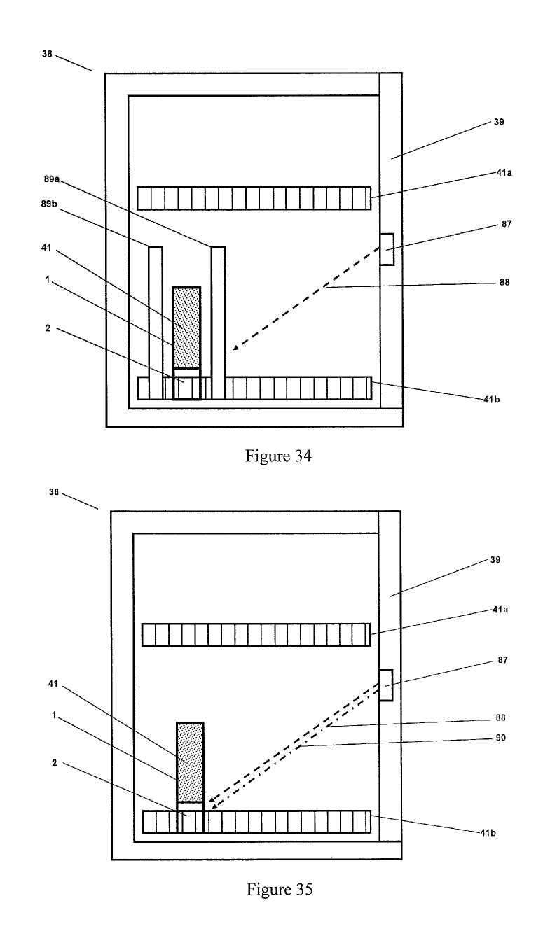

FIG. 34 shows a situation in which the dispenser 2 cannot receive any signals from the transmit unit 87, since for example the dispenser 2 in the crockery drawer 41b is surrounded by items to be washed (objects) 89a, 89b in such a way as to prevent reception of signals 88 from and to the transmit unit 87. This may also be the case for example if items to be washed fall over during the course of a dishwashing program.

In this case where the signals 88 are not received at the dispenser 2 or are interrupted, a dispensing program from the control unit of the dispenser 2 is activated, such that the dispenser 2 dispenses at least one preparation 40 during a washing program autonomously of the controller of the dishwashing machine 38. This prevents a situation in which signal interruption results in no preparation 40 being released into the interior of a dishwashing machine 38 during a washing program, resulting in poor cleaning performance. This applies to situations both at the start of a washing program and during a washing program.

To identify signal interruption between the dispenser 2 and the transmit unit 87, an additional monitoring signal 90 may be provided, which is emitted at predefined, fixed time intervals by the transmit unit 87, while the control signal 88 is emitted at fixed time intervals or merely on direct transmission of a control signal. This is outlined by way of example in FIG. 35. Since the transmit unit 87 is conventionally operated via the mains connection of the dishwashing machine 38, emission of a periodic monitoring signal 90 does not place an unacceptable load on the energy source of the dispenser 2, since the monitoring signals 90 have merely to be received and evaluated during a washing program.

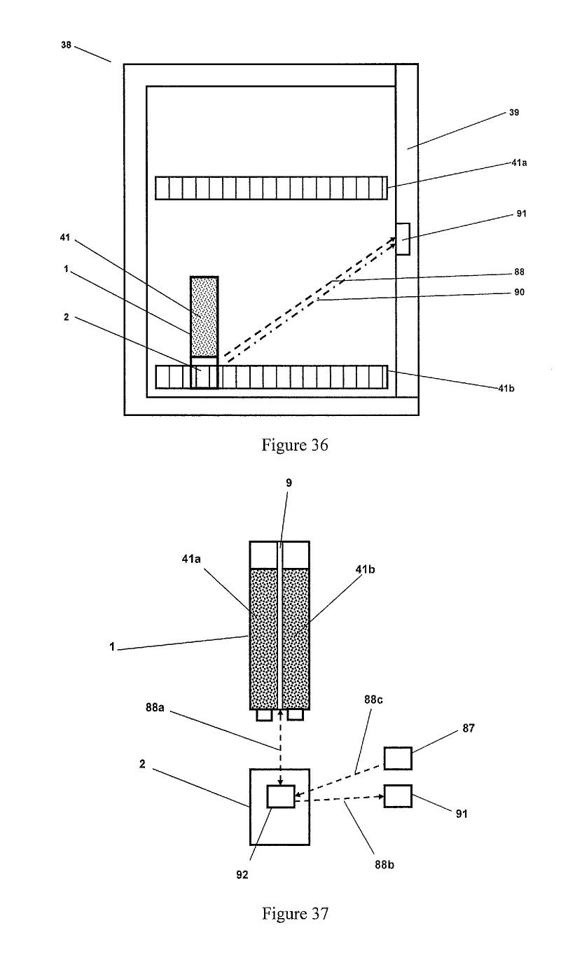

As shown in FIG. 36, it goes without saying that it is also conceivable, if the energy source of the dispenser 2 is adequately dimensioned, for both the monitoring signals 90 and the control signal 88 to be transmitted by the dispenser 2 to a corresponding receive unit 91 in the dishwashing machine 38.

It is in principle also possible for the transmit and receive modes of control and monitoring signals 88, 90 according to FIG. 35 and FIG. 36 to be superimposed on or parallel to one another. This means that a monitoring signal 90 is emitted by the transmit unit 87 and received by the dispensing unit 2 and a control signal 88 is transmitted by the dispensing unit to a receive unit 91.

Another embodiment of the invention is shown in FIG. 37. FIG. 37 shows the dispenser 2, which has an optical transmit and receive unit 111. By means of the optical transmit and receive unit 111, control signals 88b may be transmitted to a receive unit 91 on the dishwashing machine and control signals 88c may be received from a transmit unit 87 on the dishwashing machine. The receive unit 91 on the dishwashing machine and transmit unit 87 on the dishwashing machine are preferably arranged in a combi dispenser, as shown in FIGS. 30-31. In addition, optical signals 88a from the optical transmit and receive unit 111 may be incoupled into the cartridge 1, in particular into the web 9 taking the form of a light guide, and/or outcoupled from the cartridge 1 and received by the optical transmit and receive unit 111.

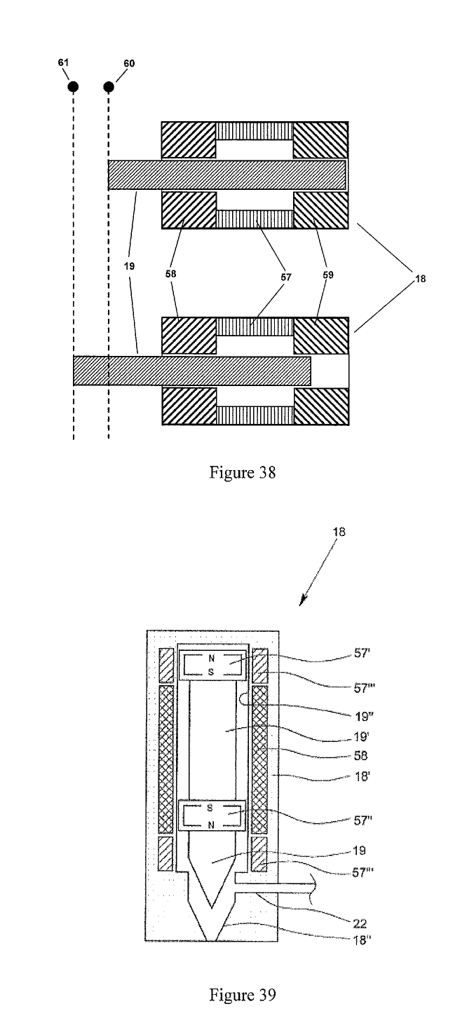

FIG. 38 and FIG. 39 show an actuator/closing element combination for a dispenser 2 of an above-described dispensing system for flowable washing or cleaning agents.

An actuator 18 and a closing element 19 are shown. Provision is made for the closing element 19 to take the form of an open-close valve element, for the actuator 18 to be configured in such a way that, driven by a suitable pulse, it adopts as desired one of two end positions and without further drive stably maintains the end position it has reached, and for the combination thus to form a pulse-controlled, bistable open-close valve.

It is clear from both drawings that, according to a correspondingly preferred embodiment, the actuator 18 takes the form of a bistable solenoid with a space 19″ accommodating an armature 19′ and an outer accommodation space 18′ surrounding said space 19″.

In particular, FIG. 39 shows a particularly convenient embodiment in which the armature 19′ of the bistable solenoid forms the closing element 19 or is coupled thereto. The closing element 19 is here shown as a valve cone at the lower end of the armature 19′. The valve cone of the closing element 19 is associated with a conical valve seat 18″ at the bottom on the actuator 18. FIG. 39 shows, on the right, the outlet 22 of the dispensing chamber 20, which is not shown here, seated laterally next to the actuator 18.

According to particularly preferred teaching of the invention, provision is made for the space 19″ in the actuator 18 accommodating the armature 19′ to be separated in a liquid-tight manner and preferably also gas-tight manner from the outer accommodation space 18′ of the actuator 18. This ensures that the essential, sensitive components of the actuator 18 are located in the dry region, i.e. they cannot come into contact with the flowable washing or cleaning agent because of this sealing of the spaces.

For the armature 19′ itself, measures should likewise be taken to prevent it, or in any case its metallic components, from coming into contact with the flowable washing or cleaning agent. According to the invention, provision is made to this end, in particular, for at least the outer surface of the armature 19′ to consist of a material not susceptible to attack by the washing or cleaning agent to be dispensed, in particular of a plastics material.

FIG. 38 is a schematic representation of a cross-sectional view through an actuator 18 configured as a bistable solenoid. It shows a first coil 58 and a second coil 59 with a permanent magnet 57 arranged between the coils 58, 59. The closing element 19 is accommodated as a plunger core in the circular coils 58, 59 and the circular permanent magnet 57. A retention force is generated by magnetic return between the magnetic field of the permanent magnet 57 and the magnetizable closing element 19, whereby the closing element 19 may be fixed in a position which is defined in each case by the retention points 60, 61.

The closing element 19 may be moved to the retention points 60 and 61 by pulsed energization of the coils 58, 59, by superimposing on the magnetic field of the permanent magnet 57 an electrically generated magnetic field in each case of one of the coils 58, 59 with appropriate polarization. If the coil 58 is energized, for example, interruption of the magnetic return between the permanent magnet 57 and the closing element 19 is brought about, such that the closing element 19 is subsequently moved into the magnetic field of the coil 58 from retention point 60 to retention point 61, which is obvious from the bottom part of FIG. 38. If corresponding pulsed energization of the coils 59 is brought about, the closing element 19 moves back from retention point 61 in the starting position, retention point 60.

The further preferred exemplary embodiment illustrated in FIG. 39 has a somewhat different design, in which permanent magnets 57′, 57″ are arranged in the armature 19′ at the axial ends thereof with opposing polarities in the axial direction, and in which yoke rings 57′″ of a ferromagnetic material, in particular of iron, are arranged in the outer accommodation space 18′ at both axial ends, with a coil winding 58 arranged between said yoke rings. The permanent magnets 57′, 57″ are arranged with opposing polarities in the axial direction. In the exemplary embodiment illustrated, in each case the north pole is positioned axially externally, and the south pole internally. The arrangement may also be precisely the opposite. If the armature 19′ has reached one of its end positions, for example the passage position shown in FIG. 31a, this position of the actuator 18 is in itself stable, without the coil winding 58 being energized. To protect the battery, the coil winding 58 is only energized when a changeover process is to take place. This increases the service life of the energy source 15 very considerably.

The armature 19′, made overall of plastics, in which the permanent magnets 57′, 57″ are embedded, is permanently resistant to the conventional washing and cleaning agents.

The coil winding 58 and the yoke rings 57′″ are located in the outer accommodation space 18′ and are therefore arranged in the dry region.

If the coil winding 58 is energized with the correct current flow direction, changeover of the actuator 18 occurs, namely pulsed displacement of the armature 19′ into its other end position (retention point 60 top, retention point 61 bottom in FIG. 39).

Unlike that shown in FIG. 39, it is also possible to arrange the permanent magnets 57 externally together with the coil winding 58 and then to position the yoke rings 57′″ or other yoke components on the armature 19′, embedded in the plastics material. It is essential for the magnetic circuit to be closed in each case.

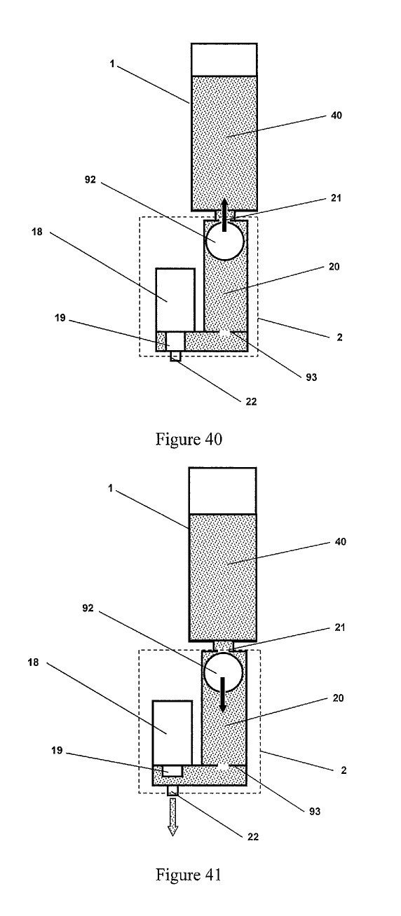

The mode of operation of the dispensing chamber 20 is explained in greater detail below with reference to FIGS. 40-43. FIG. 40 shows the dispenser 2 coupled to the cartridge 40. The preparation 40 may flow out of the cartridge 1 into the dispensing chamber 20 via the dispensing chamber inlet 21. The dispensing chamber 20 is of L-shaped cross-section, wherein the actuator 18 in the form of a bistable solenoid valve is positioned above the short leg of the L-shaped dispensing chamber 20. The closing element 19 closes the dispensing chamber outlet 22 when the dispenser 2 is in the closure position. The L-shaped dispensing chamber 20 is subdivided by the diaphragm 93 into two portions, wherein, as is readily apparent from FIGS. 40-43, the lower portion is substantially horizontal and the upper portion is substantially vertical. Inside the upper, vertical portion of the dispensing chamber 20, i.e. above the diaphragm 93 in the direction of gravity, the float 92 is arranged, whose density is lower than the density of the preparation 40 with which the dispensing chamber 20 is filled, whereby the float 92 exhibits buoyancy contrary to the direction of gravity, which is indicated by the arrow in FIG. 40.

The float 92 does not take the form of a closing member, but rather acts as a deliberate throttle which, on opening of the closing element 19, minimizes slippage between the dispensing chamber inlet 21 and dispensing chamber outlet 22 and so determines dispensing accuracy. The float is configured in such a way that it does not rest sealingly on or against the dispensing chamber inlet 21 and diaphragm 93 in its end positions, but rather also allows flow around and/or through the float 92 in the end positions.

The float 92 and the dispensing chamber 20 are configured such that preparation 40 may flow around and/or through the float 92 in the dispensing chamber 20.

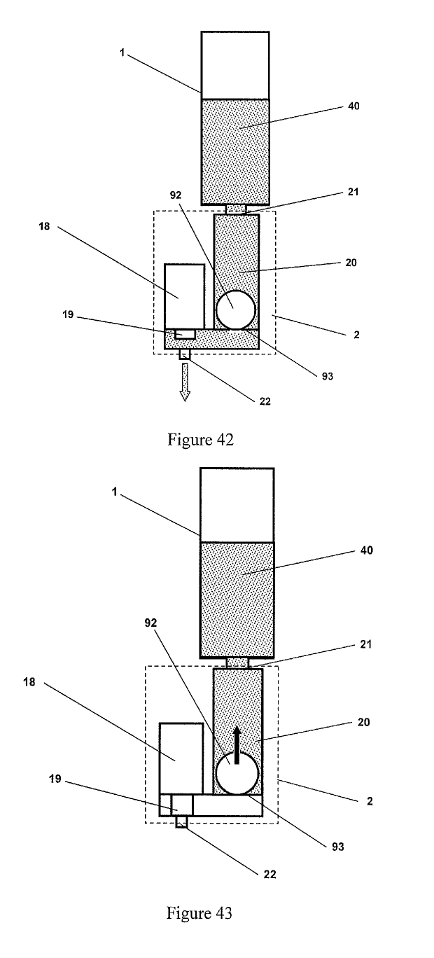

If the closing element 19 is then brought by the actuator 18 into a release position (FIG. 41), such that the dispensing chamber outlet 22 is opened and preparation 40 is released into the surrounding environment, which is indicated by the arrow, the float 92 moves with the preparation 40 flowing out of the dispensing chamber 20 in the flow direction of the preparation 40 towards the diaphragm 93, until the float 92 finally rests on the diaphragm 93, which is shown in FIG. 42.

If, as shown in FIG. 43, the closing element 19 is moved by the actuator 18 back into its closure position and the stream of preparation towards the dispensing chamber outlet 22 comes to a standstill, the float 92 moves, due to its buoyancy in the preparation 40, contrary to the direction of gravity in the dispensing chamber 20 towards the dispensing chamber inlet 21 until the starting position shown in FIG. 40 is reached once again.

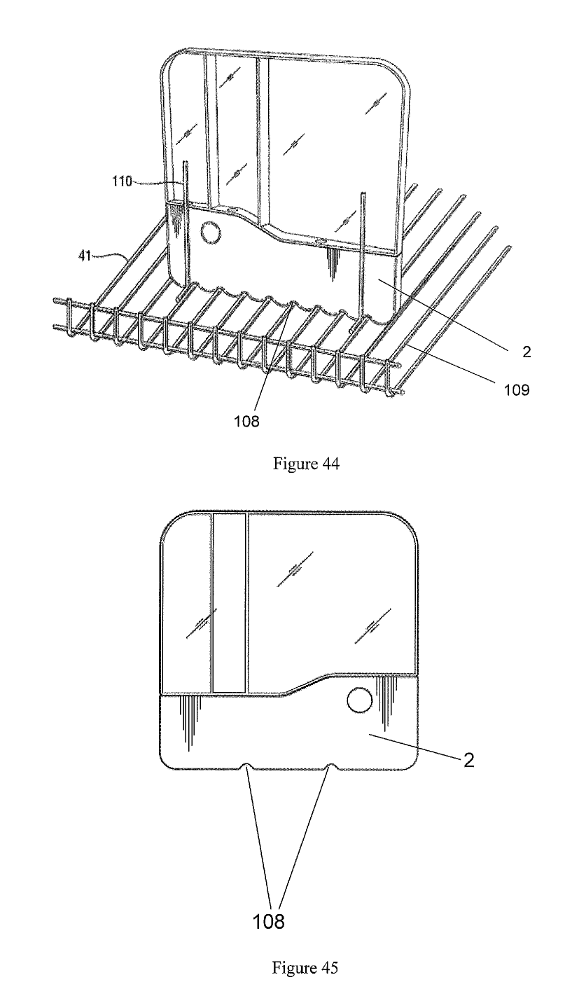

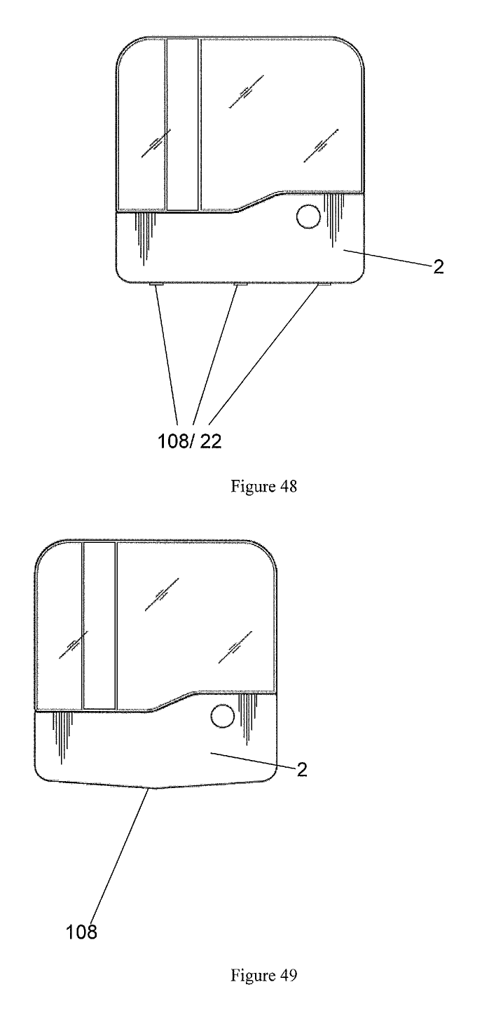

In FIGS. 44 to 51 various possibilities for fixing or securing the dispensing system according to the invention in a crockery drawer 41 of a dishwasher 38 are explained in greater detail.

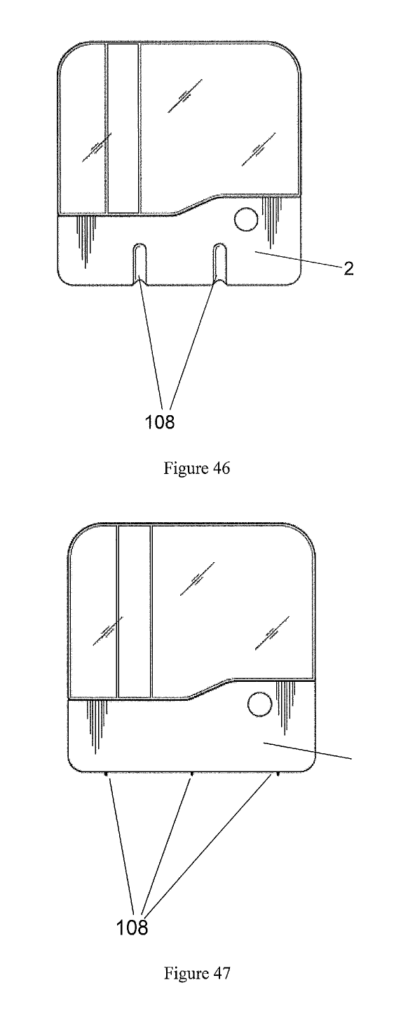

FIG. 44 shows the dispenser 2 coupled with a cartridge 1 in the plate receptacle 110 of a crockery drawer 41. The crockery drawer 41, which is of conventionally grid-like construction, comprises struts 109 in which the fixing means 108 of the dispenser 2 engage. This prevents lateral slippage of the dispenser 2, for example when the crockery drawer 41 is pulled out of or pushed into the dishwasher 38. FIG. 45 shows a possible embodiment of the dispenser 2, in which the fixing means 108 take the form of arched recesses in the base of the dispenser 2. It is also conceivable for the fixing means 108 to engage in the struts of the plate receptacle 110 or at least partially to enclose them, so as to prevent lateral slippage. This is shown in FIG. 46, in which the fixing means 108 take the form of channel-like recesses in the front and/or rear wall of the dispenser 2.

Furthermore it is possible for the fixing means 108 to take the form of webs projecting out of the bottom plane of the dispenser 2, as shown in FIG. 47. It is also conceivable for the dispensing chamber outlets 22 of the dispenser to be allowed to project out of the bottom plane of the dispenser 2, so as to form the fixing means 108.

The bottom contour of the dispenser 2 may also be V-shaped as shown in FIG. 49, such that the tip of the V-shaped dispenser 2 may engage between two adjoining crockery drawer struts 109, so forming the fixing means 108 against lateral slippage.

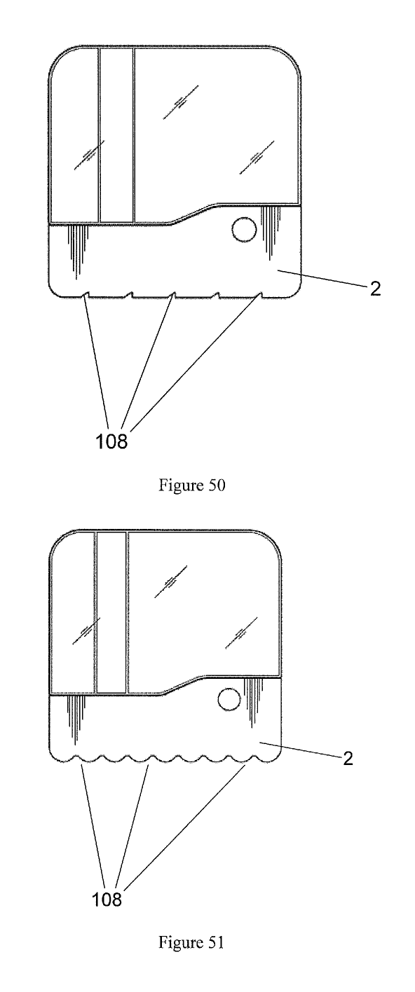

A further embodiment of a fixing means is shown in FIG. 50. The bottom contour of the dispenser 2 comprises sawtooth-like recesses, in which the struts 109 of a crockery drawer 41 may engage and so form a fixing means 108 against lateral slippage of the dispenser 2 in the crockery drawer 41.

It is also conceivable to make the bottom contour of the dispenser 2 wavy, so forming fixing elements 108, as shown in FIG. 51.

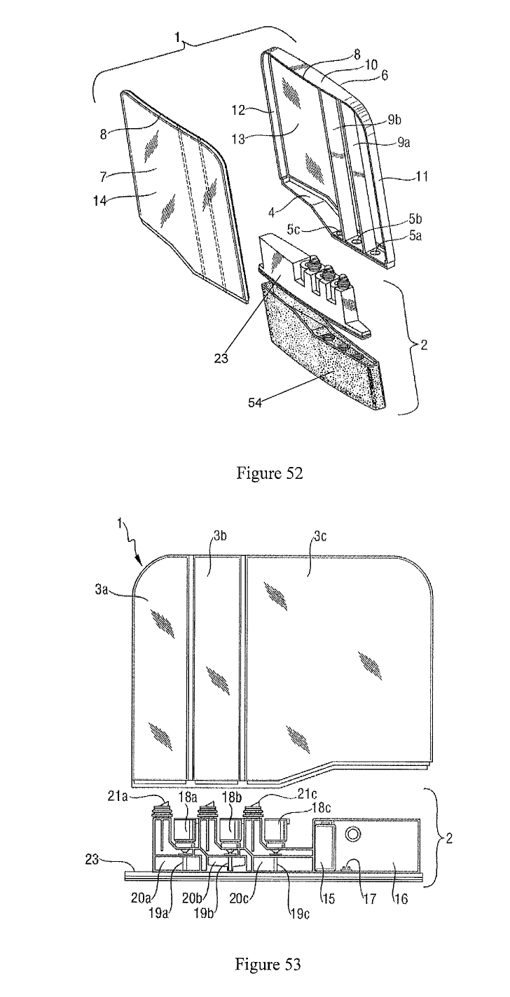

FIG. 52 is an exploded representation of the essential components of the dispensing system consisting of cartridge 1 and dispenser 2.

As may be inferred from FIG. 52, the cartridge 1 is composed of two cartridge elements 6, 7, which are already known from FIG. 20. The dispenser 2 consists substantially of a component carrier 23 and a bracket 54, in which the component carrier 23 may be inserted. In the assembled state, the bracket 54 encloses the component carrier 23 preferably in such a way that water is prevented from penetrating the component carrier 23.

FIG. 53 shows a side view of an embodiment of the component carrier 23 of the dispenser 2, which is explained in greater detail below.

The dispensing chamber 20, the actuator 18 and the closing element 19 are arranged on the component carrier 23, together with the energy source 15, the control unit 16 and the sensor unit 17. The dispensing chamber 20, the predispensing chamber 26, the dispensing chamber inlet 21 and the receptacle 29 are formed in a single part with the component carrier 23.

As may also be inferred from FIG. 53, the energy source 15, the control unit 16 and the sensor unit 17 are combined in an assembly by arranging them on a corresponding board.

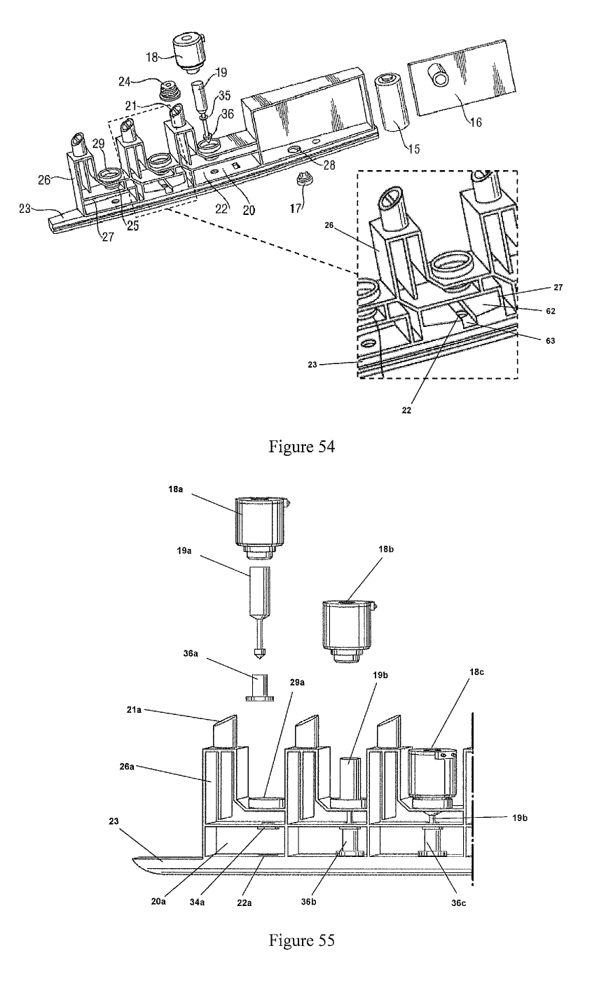

As shown in FIG. 54, the predispensing chamber 26 and the actuator 18 are arranged substantially next to one another on the component carrier 23. The predispensing chamber 26 has an L-shaped basic shape with a shoulder in the lower region, into which is set the receptacle 29 for the actuator 18. The outlet chamber 27 is arranged beneath the predispensing chamber 26 and the actuator 18. The predispensing chamber 26 and the outlet chamber 27 together form the dispensing chamber 20.

The predispensing chamber 26 and the outlet chamber 27 are connected together by the orifice 34. The receptacle 29, the orifice 34 and the dispensing chamber outlet 22 lie in a row perpendicular to the longitudinal axis of the component carrier 23, such that the rod-shaped closing element 19 may be guided through the orifices 22, 29, 34.

As is apparent in particular from FIG. 55, the rear walls of the predispensing chamber 26 and the outlet chamber 27 are formed integrally with the component carrier 23. The front wall may then for example be bonded to the dispensing chamber 20 for example by a covering element or a film/foil (not shown).

The configuration of the dispensing chamber 20 is explained in greater detail with reference to the detailed view of FIG. 54. This figure shows the outlet chamber 27, which has a bottom 62. The bottom 62 is inclined in the manner of a funnel towards the dispensing chamber outlet 22 arranged centrally in the outlet chamber 27. The dispensing chamber outlet 22 is located in a channel 63, which extends at right angles to the longitudinal axis of the component carrier 23 in the outlet chamber 27. The funnel-shaped bottom 62 and the channel 63 and the outlet orifice 22 arranged therein ensure dispensing and virtually complete residual emptying of preparation out of the dispensing chamber 20 if the dispenser is in a position other than horizontal. Furthermore, as a result of the correspondingly funnel-shaped bottom the preparation flows more quickly out of the dispensing chamber, in particular in the case of relatively high viscosity preparations, such that the dispensing period, in which preparation is released, may be kept short.

In FIG. 54 only the middle dispensing chamber 20 is provided with a funnel-shaped bottom of the above-described type. It goes without saying that, in contrast to this representation, further or all of the dispensing chambers may be so shaped. This also applies to the predispensing chambers 26 and outlet chambers 27, if these are provided.

The arrangement of the actuator 18, of the closing element 19 and of the seal 36 on the component carrier 23 is explained in greater detail with reference to the exploded representation in FIG. 55. The figure shows a component carrier 23 with three dispensing chambers 20 arranged next to one another. In the dispensing chamber on the far right the actuator 18c, the closing element 19c and the seal 36c are shown in the assembled state on the component carrier 23. In the case of the middle dispensing chamber the seal 36b and the closing element 19b are shown in the assembled state in the dispensing chamber, while the actuator 18b has been detached from the closing element 19b. Above the left-hand dispensing chamber 20a the seal 36a, the closing element 19a and also the actuator 18a are shown in an exploded representation.

The dispensing chamber 20, the predispensing chamber 26, the dispensing chamber inlet 21 and the receptacle 29 for the actuator 18 are of integral construction with the component carrier 23. The predispensing chamber 26 is arranged in an L-shape above the dispensing chamber 20, wherein the receptacle for the actuator 18 is arranged on the leg of the predispensing chamber extending parallel to the bottom of the component carrier 23. The dispensing chamber 20 and the predispensing chamber 26 are connected together by the orifice 34. The receptacle 29, the orifice 34 and the dispensing chamber outlet 22 lie on an axis, which extends perpendicularly to the longitudinal axis of the component carrier 23.

The seal 36 has a substantially hollow-cylindrical configuration, with a top closed by a plate-like end piece. The resilient seal 36 may be arranged in the dispensing chamber 20 in such a way that the plate-like end piece presses on the inside against the dispensing chamber outlet 22 and with the side of the seal 36 remote from the plate-like end piece against the orifice 34. The first end of the cylindrical closing element 19 is constructed in such a way that it engages in the hollow-cylindrical seal 36 and may be fixed there by interlocking, friction and/or bonding. The closing element 19 is dimensioned such that it may be passed through the orifice 34 and the orifice of the receptacle 29, but abuts against the dispensing chamber outlet 22, such that the closing element 19 cannot slip downwards out of the component carrier 23.

The closing element 19 projects with one end out of the receptacle 29. This end is inserted into the actuator 18 constructed as a bistable electromagnet and functions as an armature.

### Cartridge

For the purposes of the present application, a cartridge is understood to be a packaging means which is suitable for enclosing or holding together at least one flowable, pourable or sprinklable preparation and is couplable to a dispenser for release of at least one preparation.

In the simplest conceivable embodiment, the cartridge comprises a single, preferably dimensionally stable, chamber for storing a preparation. In particular, a cartridge may also comprise a plurality of chambers which may be filled with different compositions.

It is advantageous for the cartridge to comprise at least one outlet orifice which is arranged such that gravity-actuated release of preparation from the cartridge may be brought about in the service position of the dispenser. In this way, no further conveying means are required for release of preparation from the cartridge, whereby the structure of the dispenser may be kept simple and manufacturing costs low. Moreover, it is possible to dispense with the use of conveying means, such as for example pumps, whereby the service life of a battery or storage battery of the dispenser may be increased.

In a preferred development of the invention, at least one second chamber is provided for accommodating at least one second flowable or sprinklable preparation, the second chamber comprising at least one outlet orifice which is arranged such that gravity-actuated product release from the second chamber may be brought about in the service position of the dispenser. The arrangement of a second chamber is particularly advantageous when preparations are stored in the mutually separate chambers of the cartridge which are not conventionally stable in storage together, such as for example bleaching agents and enzymes.

It is also conceivable for more than two, in particular three to four chambers to be provided in or on a cartridge. In particular, one of the chambers may be designed to release volatile preparations such as for instance a scent into the surrounding environment.

In a further development of the invention the cartridge is of single-part construction. In this way, the cartridges may be produced inexpensively in a single production step, in particular by suitable blow molding methods. The chambers of a cartridge may in this case be separated from one another for example by webs or material bridges, which are formed during or after blow molding.

The cartridge may also be of multi-part construction, being made of components which are produced by injection molding and then assembled.

In addition it is conceivable for the cartridge to be of multi-part construction such that at least one chamber, preferably all the chambers, may be individually removed from or inserted into the dispenser. This makes it possible to replace an already empty chamber, if particularly heavy use is made of a preparation from one chamber, while the others, which may still be full of preparation, remain in the dispenser. In this way, the individual chambers or their preparations may be replenished in a targeted manner appropriate to the circumstances. It is additionally conceivable to construct the individual chambers in such a way that the chambers may only be coupled together or with the dispenser in a specific position or place, so preventing a user from connecting a chamber with the dispenser in a position not intended for said chamber. To this end, the chamber walls may in particular be formed in such a way that they may be connected together interlockingly. It is particularly advantageous, in the case of a cartridge formed of at least three chambers, to form the cartridges such that the chambers may only be connected together interlockingly in a given defined position relative to one another.

The chambers of a cartridge may be fixed to one another by suitable connection methods, such that a container unit is produced. The chambers may be detachably or nondetachably fixed to one another by a suitable interlocking, frictional or bonded connection. In particular, fixing may be effected by one or more of the connection types from the group of snap-in connections, hook-and-loop connections, press connections, melt connections, adhesive connections, welded connections, brazed connections, screw connections, keyed connections, clamped connections or rebound connections In particular, fixing may also be provided by a heat-shrinkable sleeve, which is drawn in the heated state over all or parts of the cartridge and firmly envelops the chambers or the cartridge in the cooled state.

The bottom of the chambers may be inclined in the manner of a funnel towards the release orifice in order to provide advantageous residual emptying characteristics. Moreover, the internal wall of a chamber may be constructed by suitable material selection and/or surface finish such that the preparation adheres only slightly to the internal chamber wall. The residual emptying characteristics of a chamber may also be further optimized by this measure.

In particular, the cartridge may also be of asymmetric construction. It is particularly preferred to make the asymmetry of the cartridge such that the cartridge is only couplable with the dispenser in a predefined position, so preventing incorrect operation by the user which would otherwise be possible.

A dispensing chamber may be constructed in or on a chamber upstream of a chamber's outlet orifice in the gravity-actuated direction of flow of the preparation. The dispensing chamber determines the quantity of preparation which, on release of preparation from the chamber, is to be released into the surrounding environment. This is particularly advantageous if the closing element of the dispenser, which effects release of the preparation from a chamber into the surrounding environment, may only be put in a release state and a closed state without the quantity released being measured or monitored. The dispensing chamber then ensures that a predefined quantity of preparation is released without direct feedback of the outflowing quantity of preparation currently being released.

The dispensing chambers may be of single-part or multi-part construction. It is furthermore possible to make the dispensing chambers firmly connected to or detachable from the cartridge. In the case of a dispensing chamber detachably connected to the cartridge, it is straightforwardly possible to connect dispensing chambers having different dispensing volumes with a cartridge or to interchange the latter, whereby it is straightforwardly possible to adapt the dispensing volumes to the particular preparation stored in a chamber and it is thus straightforwardly possible to make up the cartridge for different preparations and for dispensing them.

According to another advantageous further development of the invention, one or more chambers in each case comprise(s), in addition to an outlet orifice preferably located at the bottom, a second chamber orifice which is closable in liquid-tight manner and preferably located at the top. This chamber orifice makes it possible, for example, to replenish the preparation stored in the chamber.

The cartridge chambers may be ventilated, in particular in the top zone, by providing ventilation means to ensure pressure equalization between the interior of the cartridge chambers and the surrounding environment as the filling level declines. These ventilation means may, for example, take the form of a valve, in particular a silicone valve, microorifices in the wall of a chamber or cartridge, or the like.

If, according to a further development, the cartridge chambers are not directly ventilated, but instead via the dispenser, or no ventilation is provided, for example when using flexible containers, such as for example pouches, this has the advantage that at elevated temperatures a pressure is developed over the course of a washing cycle of a dishwasher due to heating of the chamber contents, which pressure presses the preparations to be dispensed in the direction of the outlet orifices, such that in this way good residual emptying characteristics of the cartridge may be achieved. Furthermore, in such air-free packaging, there is no risk of substances of the preparation being oxidized, which makes pouch packaging or also bag-in-bottle packaging particularly convenient for oxidation-sensitive preparations.

The volume ratio of the structural volume of the dispenser and the capacity of the cartridge preferably amounts to <1, particularly preferably <0.1, particularly preferably <0.05. In this way it is ensured that, in the case of a predetermined overall structural volume of dispenser and cartridge, the predominant proportion of the structural volume is occupied by the cartridge and the preparation contained therein.

The cartridge may be of any desired three-dimensional shape. It may for example be cubic, spherical or plate-like in form.

The cartridge and the dispenser may in particular be constructed with regard to their three-dimensional shape such that they bring about the slightest possible loss of useful volume in particular in a dishwashing machine.

When using the dispenser in dishwashing machines, it is particularly advantageous to shape the device on the basis of the dishes to be cleaned in dishwashing machines. It may, for example, be plate-shaped, approximately assuming the dimensions of a plate. In this way, the dispenser may be positioned in space-saving manner for example in the lower basket of the dishwasher. Furthermore, the correct positioning of the dispensing unit is immediately obvious to the user thanks to the plate-like shape.

In the coupled state, the dispenser and cartridge preferably have a ratio of height:width:depth of between 5:5:1 and 50:50:1, particularly preferably of around 10:10:1. Due to the “slender” construction of the dispenser and the cartridge it is in particular possible to position the device in the lower basket of a dishwashing machine in the receptacles provided for plates. This has the advantage that the preparations released from the dispenser pass directly into the washing liquor and cannot adhere to other items being washed.

Conventional commercial domestic dishwashing machines are usually designed such that larger items to be washed, such as for instance pans or large plates, are arranged in the lower basket of the dishwashing machine. In order to prevent the user from positioning the dispensing system consisting of the dispenser and the cartridge coupled with the dispenser less than ideally in the upper basket, in an advantageous development of the invention the dispensing system is dimensioned such that the dispensing system may only be positioned in the receptacles provided for this purpose in the lower basket. To this end, the width and height of the dispensing system may in particular be selected between 150 mm and 300 mm, particularly preferably between 175 mm and 250 mm.

It is, however, also conceivable to construct the dispensing unit in a cup or pot shape with a substantially circular or square base area.

The outlet orifices of a cartridge are preferably arranged in a line, so making a slender, plate-shaped configuration of the dispenser possible.

In the case of a cup or pot shaped construction of the cartridge or a cup or pot shaped grouping thereof, it may however also be advantageous to arrange the release orifices of the cartridge for example in an arc shape.

In order to provide direct visual checking of filling level, it is advantageous to form the cartridge at least in portions of a transparent material.

In order to protect heat-sensitive components of a preparation present in a cartridge from exposure to heat, it is advantageous to produce the cartridge from a material with low thermal conductivity.

Another option for reducing the influence of heat on a preparation in a cartridge chamber is to insulate the chamber by suitable measures, for example by using thermal insulation materials such as for instance Styropor which suitably enclose the chamber or the cartridge entirely or in part.

It is also possible to provide the cartridge or individual chambers completely or in portions with a radiation-reflective coating which is in particular suitable for reflecting thermal radiation.

In the presence of a plurality of chambers, another measure for protecting heat-sensitive substances in a cartridge is the manner in which they are arranged relative to one another.

It is, for example, conceivable for the chamber which contains a heat-sensitive product to be partially or completely enclosed by at least one further chamber filled with a product, the latter product and latter chamber in this configuration acting as thermal insulation for the enclosed chamber. This means that a first chamber which contains a heat-sensitive product is partially or completely enclosed by at least one further chamber filled with a product, such that the heat-sensitive product in the first chamber undergoes a slower rise in temperature when the surrounding environment gets hotter than do the products in the surrounding chambers.

In order to bring about a further improvement in thermal insulation, where more than two chambers are used, the chambers may be arranged one around the other in the manner of a Russian doll, so as to form a multi-layer insulating layer.

In particular, it is advantageous for at least one preparation which is stored in an enclosing chamber to have a thermal conductivity of between 0.01 and 5 W/m*K, preferably of between 0.02 and 2 W/m*k, particularly preferably of between 0.024 and 1 W/m*K.

The cartridge is in particular of dimensionally stable construction. It is, however, also conceivable to configure the cartridge as a flexible packaging means, such as for instance as a tube. It is furthermore also possible to use flexible containers such as pouches, in particular if they are used in a substantially dimensionally stable receiving container in accordance with the “bag-in-bottle” principle. By using flexible packaging means, it is no longer necessary, unlike in the case of the above-described dimensionally stable cartridge configurations, to provide a ventilation system for pressure equalization.

In a preferred embodiment of the invention, the cartridge comprises an RFID label which at least contains information about the contents of the cartridge and is readable by a sensor unit which may in particular be provided in the dispenser or dishwashing machine.

This information may, for example, be used in order to select a dispensing program stored in the control unit of the dispenser. In this way it may be ensured that the ideal dispensing program is always used for a specific preparation. It may also be provided that, in the absence of an RFID label or in the case of an RFID label with an incorrect or defective ID, the dispensing device does not dispense but instead an optical or acoustic signal is produced which notifies the user of the error.

In order to prevent misuse of the cartridge, the cartridges may also comprise structural elements which interact with corresponding elements of the dispenser like a key in a lock, such that for example only cartridges of a particular type are couplable to the dispenser. This development furthermore makes it possible for information about the cartridge coupled to the dispenser to be transmitted to the control unit of the dispenser, whereby the dispensing device may be controlled in a manner adapted to the contents of the corresponding container.

The cartridge is in particular constructed to accommodate flowable washing or cleaning agents. Such a cartridge particularly preferably comprises a plurality of chambers for spatially separately accommodating in each case different preparations of a washing or cleaning agent. By way of non-exhaustive example, some possible combinations for filling the chambers with different preparations are listed below:

| | Chamber 1 | Chamber 2 | Chamber 3 | Chamber 4 |
|---|---|---|---|---|
| A | Alkaline | Enzymatic | — | — |
| | cleaning | cleaning | | |
| | preparation | preparation | | |
| B | Alkaline | Enzymatic | Rinse aid | — |
| | cleaning | cleaning | | |
| | preparation | preparation | | |
| C | Alkaline | Enzymatic | Rinse aid | Scent |
| | cleaning | cleaning | | |
| | preparation | preparation | | |
| D | Alkaline | Enzymatic | Rinse aid | Disinfectant preparation |
| | cleaning | cleaning | | |
| | preparation | preparation | | |
| E | Alkaline | Enzymatic | Rinse aid | Pretreatment preparation |
| | cleaning | cleaning | | |
| | preparation | preparation | | |

It is particularly preferred for all preparations to be flowable, since this ensures rapid dissolution of the preparations in the washing liquor of the dishwasher, as a result of which these preparations have a rapid to immediate cleaning or rinsing action, in particular also on the walls of the washing compartment and/or of a light guide of the cartridge and/or of the dispenser.

The cartridge conventionally has a total capacity of <5000 ml, in particular <1000 ml, preferably <500 ml, particularly preferably <250 ml, very particularly preferably <50 ml.

The chambers of a cartridge may be of identical or different capacities. In a configuration with two chambers, the ratio of the chamber volumes is preferably 5:1; in a configuration with three chambers preferably 4:1:1, these configurations in particular being suitable for use in dishwashing machines.

As mentioned above, the cartridge preferably has three chambers. When such a cartridge is used in a dishwashing machine, it is particularly preferred for one chamber to contain an alkaline cleaning preparation, another chamber a enzymatic preparation and a third chamber a rinse aid, the volume ratio of the chambers amounting to approximately 4:1:1.

The chamber containing the alkaline cleaning preparation preferably has the greatest capacity of the chambers present. The chambers which store an enzymatic preparation or a rinse aid preferably have approximately identical capacities.

In a two and/or three chamber configuration of the cartridge, it is in particular possible to store in particular a scent, disinfectant and/or pretreatment preparation in a further chamber arranged detachably on the cartridge or on the dispenser.

The cartridge comprises a cartridge bottom, which in the service position is directed downwards in the direction of gravity and in which, preferably for each chamber, there is provided at least one outlet orifice arranged at the bottom in the direction of gravity. The outlet orifices arranged at the bottom are in particular constructed such that at least one, preferably all of the outlet orifices may be connected in communicating manner with the inlet orifices of the dispenser, such that preparation can flow out of the cartridge via the outlet orifices into the dispenser, preferably under the action of gravity.

It is also conceivable for one or more chambers to comprise an outlet orifice which is not arranged at the bottom in the direction of gravity. This is in particular advantageous when for example a scent is to be released into the surrounding environment of the cartridge.

The cartridge is preferably formed of at least two elements which are bonded together, the connecting edge of the elements at the cartridge bottom extending away from the outlet orifices such that the connecting edge does not intersect with the outlet orifices. This is in particular advantageous because in this way leakage problems in the area of the outlet orifices are avoided on coupling with the dispenser, which problems in particular occur on exposure to the major cyclic fluctuations in temperature which conventionally occur in a dishwasher,

The bonded connection may be produced, for example, by adhesive bonding, welding, brazing, pressing or vulcanization.

It is particularly preferred to connect the cartridge elements together by means of hot plate welding. In hot plate welding, a hot metal plate which contains the outline of the boundary surfaces to be connected is used to heat the boundary surface and briefly convert them into a plastic state, such that once the hot plate has been removed and the parts assembled, said plastic zones in melt form resolidify and create a solid connection.

In addition to the hot plate welding method known from the prior art, individually injection molded parts may for example also be joined together by means of laser welding. In laser welding, one of the two materials which are to be melted at the boundary surface must bear an absorbent in order to absorb the energy of the laser beam and convert it into heat, which then melts the corresponding zone of the material. This is typically achieved with coloring pigments which interact thermally with laser beam introduced into the material. These boundary surfaces to be joined may also be covered if the material located thereabove in the direction of incidence of the laser beam is transparent to the laser beam and exhibits no absorbance.

It is furthermore possible to connect individual cartridge elements by means of ultrasound welding methods or IR welding via electrodes.

It is advantageous for the connecting edge to extend along the top, bottom and side faces of the cartridge. In this way, two cartridge elements may in particular be produced by injection molding, with either both elements being trough-shaped or one element being trough-shaped and the second element lid-like.

In order to form a two- or multi-chamber cartridge, at least one of the two cartridge elements may comprise at least one separating web which, in the assembled state of the elements, in each case separates two adjacent chambers of the cartridge from one another.

As an alternative to forming the cartridge from two shell-shaped cartridge elements, it is also conceivable for one cartridge element to be a cellular container with at least one chamber and the second element to be the cartridge bottom or top which is connected in liquid-tight manner along the connecting edge with the cellular container.

It is, of course, also conceivable to combine the above-mentioned cartridge configurations in any desired suitable manner. For example, a two-chamber cartridge may be formed from a trough-like and a lid-like cartridge element and a third single-part or multi-part chamber may be arranged on the top or circumferential surface of the cartridge formed in this manner

In particular, such a further chamber for accommodating a preparation may be arranged on the cartridge and configured such that volatile substances such as for example scents are released from the preparation into the surrounding environment of the chamber.

According to one development which is to be preferred, the outlet orifices of the cartridge are closed by closing means at least when the cartridge is in the filled, unopened state. The closing means may be constructed such that they permit one-off opening of the outlet orifice by destruction of the closing means. Such closing means are for example sealing films/foils or closing caps.

According to one embodiment of the invention which is to be preferred, the outlet orifices are in each case provided with a closure which, when in the state coupled with a dispenser, permits outflow of preparation from the respective chambers and, when in the uncoupled state of the cartridge, substantially prevents outflow of preparation. Such a closure in particular takes the form of a silicone slit valve.

It is furthermore preferred for the ventilation orifices of the cartridge to be closed with a closing element before it is first coupled with the dispenser. The closing element may in particular be a stopper or cap which is opened, for example pierced, by the coupling process when it is first coupled with the dispenser.

Before the cartridge is first coupled with the dispenser, it is very particularly preferred for all outlet orifices of the cartridge to be closed with a silicone slit valve and all ventilation orifices with a cap.

The cartridge elements forming the cartridge are preferably formed of a plastics material and may be shaped in a common injection molding process, it possibly being advantageous to form a connecting web acting as a hinge between the two elements, such that, after forming, the two elements are folded over to lie one on the other and are bonded along the connecting edge.

In a further development of the invention, an energy source, in particular a battery or storage battery, is arranged on or in the cartridge, preferably on or in the bottom of the cartridge. Means for coupling the energy source electrically with the dispenser may furthermore be provided on the cartridge.

In a further, preferred development of the invention the cartridge for coupling with a dispenser positionable in the interior of a domestic appliance for releasing at least one washing and/or cleaning agent preparation comprises at least one chamber for storing at least one flowable or pourable washing and/or cleaning agent preparation, wherein, in the state coupled with the dispenser, the cartridge is protected from ingress of washing water into the chamber(s) and the cartridge comprises at least one release orifice at the bottom in the direction of gravity for the, in particular gravity-actuated, release of preparation from at least one chamber and at least one ventilation orifice at the bottom in the direction of gravity for the ventilation of at least one chamber, wherein the ventilation orifice is separate from the release orifice and the ventilation orifice is connected in communicating manner with at least one cartridge chamber.

It is particularly preferred for the cartridge to comprise at least two chambers, very particularly preferably at least three chambers. It is here advantageous for in each case a ventilation orifice and a release orifice to be provided for each chamber.

It is furthermore preferred for the ventilation orifice at the bottom to be connected in communicating manner with a ventilation channel, the end of which remote from the ventilation orifice opens, in the release position of the cartridge coupled with the dispenser, above the maximum filling level of the cartridge.

In this connection, it is advantageous for the ventilation channel entirely or in part to be formed in or on the walls and/or webs of the cartridge. In particular, the ventilation channel may be formed integrally in or on the walls and/or webs of the cartridge.

To this end, the ventilation channel may advantageously be shaped by joining together at least two elements which form the cartridge. For example, a ventilation channel may be formed by joining a separating web of the cartridge formed in the shell-shaped element with two webs bordering the separating web and arranged on the cartridge element.

It is here advantageous for the ventilation channel to be formed by bonded joining, in particular by welding, of a separating web of the cartridge formed in the shell-shaped element with two webs bordering the separating web and arranged on the cartridge element.

Alternatively, the ventilation channel may also take the form, for example, of a dip tube.

In order to ensure cartridge ventilation also in an inclined position, for example when the dispenser is placed in the plate receptacle, it is advantageous for the cartridge filling level (F) in the unopened, filled state of the cartridge not to reach the ventilation channel mouth (83) in an inclined position of up to 45°.

It is moreover advantageous in this connection to arrange the ventilation channel mouth approximately centrally on or in the chamber wall of the cartridge top.

In order to ensure functionality for example also after the cartridge has been in a horizontal position, it is advantageous to configure the viscosity of a flowable preparation and the ventilation channel in such a manner that the preparation is not drawn into the ventilation channel by capillary forces when the preparation reaches the ventilation channel mouth.

Coupling of the cartridge with the dispenser should advantageously be configured such that a pin is arranged on the dispenser, which pin is connected in communicating manner with the inlet orifice of the dispenser and interacts with the couplable cartridge or cartridge chamber in such a manner that, on coupling of the ventilation orifice of cartridge or cartridge chamber with the dispenser, the pin displaces a volume Δv in the ventilation channel, whereby a pressure Δp is produced in the ventilation channel which is suitable for conveying the flowable preparation located in the ventilation channel into the chamber which is connected to the ventilation channel and stores the preparation.

It is preferred for the ventilation orifice of a chamber to be connected in communicating manner with the pin on the dispenser before the closed outlet orifice of the corresponding chamber is opened, for example by a communicating connection with the inlet orifice of the dispenser.

According to a further, advantageous embodiment of the invention, a ventilation chamber is arranged between the ventilation orifice and the ventilation channel.

The cartridge may be configured such that it may be arranged detachably or fixedly in or on the dispenser and/or a dishwashing or washing machine and/or washer/dryer.

In a further, advantageous embodiment of the invention the dispenser for releasing at least one flowable washing and/or cleaning agent preparation into the interior of a domestic appliance comprises a cartridge couplable with the dispenser wherein the cartridge stores at least one flowable washing and/or cleaning agent preparation and the cartridge comprises at least one outlet orifice at the bottom in the direction of gravity, which outlet orifice in the state coupled with the dispenser is connected in communicating manner to an inlet orifice of the dispenser, wherein the dispenser and the cartridge comprise means which interact in such a manner that detachable latching may be established between the dispenser and cartridge, wherein, in the latched state, the dispenser and the cartridge are swivelable relative to one another about a swivel point (SP), and that the outlet orifice of the cartridge and the inlet orifice of the dispensing bracket are configured such that, once latching has been established between the cartridge and dispenser by swiveling the cartridge into the coupled state between the dispensing bracket and cartridge, they are connected in communicating manner.

In particular, it is preferred for the outlet orifices of the chambers and the inlet orifices of the dispenser to be arranged and configured in such a manner that they are connected to one another sequentially by swiveling the dispenser and cartridge in the latched state into the coupled state.

According to a further advantageous embodiment, means may be provided on the dispenser and/or cartridge which, in the coupled state of dispenser and cartridge, bring about detachable fixing of the cartridge to the dispenser.

It is also advantageous to provide means on the dispenser and/or cartridge which, in the latched state of cartridge and dispenser, guide the cartridge during swiveling of the cartridge and dispenser into the coupled state. This may be achieved, for example, by a collar extending around the bottom of the cartridge, which collar is slightly set back relative to a corresponding collar on the dispenser, such that the collar on the cartridge is guided within the collar on the dispenser.

In particular, it is advantageous for the outlet orifices of the chambers to be arranged one behind the other in the swiveling direction. It is very particularly preferred for the outlet orifices of the chambers to be arranged in a line (L) in the swiveling direction.

It is furthermore advantageous for the outlet orifices of the chambers to be approximately identically spaced apart.

In a further, advantageous development of the invention the greatest distance of a chamber outlet orifice from the swivel point (SP) of the cartridge is approximately 0.5 times the cartridge width (B).

In particular, at least two of the cartridge chambers may have different volumes.

Advantageously, the cartridge chamber with the greatest volume is furthest from the swivel point (SP) of the cartridge 1.

In a further development of the invention, the ventilation orifice of a chamber is in each case located upstream of a chamber outlet orifice in the swiveling direction during coupling of the cartridge with the dispenser.

The ratio of cartridge depth (T) to cartridge width (B) is preferably approximately 1:20. The ratio cartridge height (H) to cartridge width (B) preferably amounts to approximately 1:1.2.

It is likewise preferred for the ventilation orifice of a chamber in each case to be located upstream of a chamber outlet orifice in the swiveling direction during coupling of the cartridge with the dispenser. In this way it is ensured that the ventilation orifice of the cartridge is opened first before the outlet orifice of the cartridge is opened during coupling of the cartridge with the dispenser.

### Light Guide, Cartridge

In a preferred embodiment of the invention, the cartridge for coupling with a dispenser for releasing at least one washing and/or cleaning agent preparation from the cartridge into the interior of a domestic appliance comprises a light guide arranged in or on the cartridge, into which light guide a light signal may be incoupled from outside the cartridge. It is particularly preferred to incouple a light signal which is emitted from the dispenser into the cartridge.

The light guide may in particular be formed entirely or in part in or on the walls and/or webs of the cartridge.

It is furthermore advantageous to provide the light guide integrally in or on the walls and/or webs of the cartridge.

The light guide preferably consists of a transparent plastics material. It is, however, also possible to make the entire cartridge from a transparent material.

It is preferred for the light guide to be suitable to conduct light in the visible range (380-780 nm). It is particularly preferable for the light guide to be suitable to conduct light in the near infrared range (780 nm-3000 nm). In particular, it is preferred for the light guide to be suitable to conduct light in the mid infrared range (3.0 μm-50 μm).

The light guide in particular consists of a transparent plastics material with an elevated refractive index.

Advantageously, the light guide is entirely or partially enclosed at least in portions by a material with a lower optical refractive index. In particular, the material of the lower optical refractive index may be a preparation stored in a cartridge chamber.

A ratio of the refractive indices of the preparation and light guide of 1:1.10-1:5, preferably of 1:1.15-1:1.35, particularly preferably of 1:1.15-1:1.20 has proved particularly advantageous, the refractive index in each case being determined at a wavelength of 589 nm. The refractive index of the light guide may for example be determined to DIN EN ISO 489. The refractive index of the preparation may be determined by means of a Abbe refractometer to DIN 53491.

It is in particular advantageous for the preparation which entirely or partially encloses the light guide to have a transmittance of 45%-95%, particularly preferably of 60%-90%, very particularly preferably of 75%-85%. The light guide preferably has a transmittance of >75%, very particularly preferably of >85%. Transmittance may be determined to DIN 5036.

It is furthermore preferred for the wavelength of the light which is transmitted through the light guide approximately to correspond to the wavelength of at least one preparation which encloses the light guide at least in portions, which is not absorbed from the visible spectrum by the preparation. It is here particularly preferred for the wavelength of the light which is transmitted through the light guide and the wavelength which is not absorbed by the preparation to be between 600-800 nm.

The light signal incouplable into the light guide in particular bears information, in particular for example with regard to the operating state of the dispenser and/or the filling level of the cartridge.

In a further development of the invention which is to be preferred, the light guide is constructed such that the light signal incouplable into the light guide is also outcouplable again from the light guide.

It may here be advantageous for the light guide to be constructed such that the light signal is outcouplable at a point on the cartridge which is different from the point at which the light signal may be incoupled into the cartridge.

Incoupling and outcoupling of the light signal may in particular be carried out at a prismatically constructed edge of the cartridge.

It is particularly preferred to form incoupling or outcoupling points for the light signal in the corresponding injection mold by highly polished or hard chromium plated tool surfaces such that the reflectivity of the incoupling or outcoupling point is low and the desired signal incoupling is possible.

The distance from the light source, in particular an LED, arranged in the dispenser to the light incoupling point into the cartridge in the coupled state of the cartridge and dispenser should be kept as small as possible.

It is also advantageous for the light signal and the light guide to be configured such that a light signal visible to a user may be generated on and/or in the cartridge.

According to a further development, the light guide may be severed at at least one point in the cartridge in such a manner that the preparation can fill the discontinuity. In this way, it is straightforwardly possible to provide a filling level and/or inclination sensor, the light signal passing through the discontinuity in the absence of preparation differing from the light signal passing through the discontinuity entirely or partially filled with preparation.

### Dispenser

The control unit necessary for operation and at least one actuator are integrated into the dispenser. A sensor unit and/or an energy source is preferably likewise arranged on or in the dispenser.

The dispenser preferably consists of a housing protected from water splashing, which prevents penetration of water splashes, as may for example occur during use in a dishwashing machine, into the interior of the dispenser, in which dispenser are arranged at least the control unit, sensor unit and/or actuator.

It is particularly advantageous to encapsulate in particular the energy source, the control unit and the sensor unit in such a manner that the dispenser is substantially water-tight, i.e. the dispenser is functional even when completely immersed in liquid. Examples of encapsulation materials which may be used are multi-component epoxide and acrylate encapsulation compounds such as methacrylate esters, urethane meth- and cyanoacrylates or two-component materials comprising polyurethanes, silicones, epoxy resins.

An alternative or supplement to encapsulation is enclosing the components in an appropriately designed, moisture-tight housing. Such a development is further explained in greater detail below.

It is furthermore advantageous to arrange the components or assemblies on and/or in a component carrier in the dispenser; this too is further explained elsewhere.

It is furthermore advantageous for the material from which the dispenser is shaped to prevent or at least reduce biofilm growth. This may be achieved by using appropriate surface textures of the material or additives, such as for example biocides, known from the prior art. It is also conceivable to provide some areas of the dispenser at risk of microbial growth, in particular those areas in which washing water can accumulate, with a finish which prevents or at least reduces biofilm growth. Films/foils with an appropriate action may for example be used for this purpose.

It is particularly preferred for the dispenser to comprise at least one first interface which interacts with a corresponding interface provided in or on a domestic appliance, in particular a water-conveying domestic appliance, preferably a dishwashing or washing machine, such that electrical energy and/or signals is/are transmitted from the domestic appliance to the dispenser and/or from the dispenser to the domestic appliance.

In one development of the invention, the interfaces take the form of plug-in connectors. In a further development, the interfaces may be constructed such that electrical energy and/or electrical and/or optical signals are transmitted wirelessly.

It is here particularly preferred for the interfaces provided for transmitting electrical energy to be inductive transmitters and receivers of electromagnetic waves. The interface of a water-conveying appliance, such as for instance a dishwashing machine, may accordingly in particular be configured as an AC-operated transmitter coil with an iron core and the dispenser interface may be configured as a receiver coil with an iron core.

In an alternative embodiment, the transmission of electrical energy may also be provided by means of an interface which comprises, on the domestic appliance side, an electrically operated light source and, on the dispenser side, a light sensor, for example a photodiode or a solar cell. The light emitted by the light source is converted into electricity in the light sensor, which is then in turn stored, for example, by a storage battery on the dispenser side.

In an advantageous further development of the invention, an interface is provided on the dispenser and the water-conveying appliance, such as for instance a dishwashing machine, for transferring (i.e. transmitting and receiving) electromagnetic and/or optical signals, which in particular represent operating state, measurement and/or control information of the dispenser and/or of the water-conveying equipment such as a dishwashing machine.

It is, of course, possible only to provide an interface for transmitting signals or an interface for transmitting electrical energy or in each case to provide an interface for transmitting signals and an interface for transmitting electrical energy or to provide an interface with is suitable for transmitting both electrical energy and signals.

Such an interface may in particular be constructed such that electrical energy and/or electromagnetic and/or optical signals is/are transmitted wirelessly.

It is particularly preferred for the interface to be configured for emitting and/or receiving optical signals. It is very particularly preferred for the interface to be configured to emit or receive light in the visible range. Since conventionally when a dishwashing machine is in operation it is dark inside the washing compartment, signals may be emitted and/or detected by the dispenser in the visible optical range, for example in the form of signal pulses or photoflashes. It has proved particularly advantageous to use wavelengths of between 600-800 nm in the visible spectrum.

Alternatively or in addition, it is advantageous for the interface to be configured to emit or receive infrared signals. It is particularly advantageous for the interface to be configured to emit or receive infrared signals in the near infrared range (780 nm-3000 nm).

In particular, the interface comprises at least one LED. Particularly preferably, the interface comprises at least two LEDs. It is also possible according to a further preferred development of the invention to provide at least two LEDs, which emit light at different wavelengths. This makes it possible, for example, to define different signal bands on which information may respectively be transmitted or received.

In addition, it is advantageous, in a further development of the invention, for at least one LED to be an RGB LED, the wavelength of which is adjustable. Thus, for example, different signal bands which emit signals on different wavelengths may be defined with one LED. It is thus for example also conceivable for light to be emitted on a different wavelength during the drying process, during which high atmospheric humidity (fog) prevails in the washing compartment, than for example during a washing stage.

The interface of the dispenser may be configured in such a way that the LED is provided both for emitting signals inside the dishwasher, in particular when the dishwashing machine door is closed, and for optical display of an operating state, in particular when the dishwashing machine door is open.

It is particularly preferable for an optical signal to be configured as a signal pulse with a pulse duration of between 1 ms and 10 seconds, preferably between 5 ms and 100 ms.

In addition, it is advantageous for the interface of the dispenser to be configured in such a way that it emits an optical signal with the dishwashing machine closed and unloaded which brings about an average illuminance E of between 0.01 and 100 lux, preferably between 0.1 and 50 lux, measured at the walls bounding the washing compartment. This illuminance is then sufficient to bring about multiple reflections with or at the other washing compartment walls and thus to reduce or prevent possible signal shadows in the washing compartment, in particular when the dishwashing machine is loaded.

The signal emitted and/or received by the interface in particular bears information, in particular being a control signal or a signal which represents an operating state of the dispenser and/or of the dishwasher.

In an advantageous further development of the invention, the dispenser for releasing at least one washing and/or cleaning agent preparation from a cartridge into the interior of a domestic appliance comprises a light source, by means of which a light signal may be incoupled into a light guide of the cartridge. The light source may in particular be an LED. This for example makes it possible to incouple light signals, for example representing the operating state of the dispenser, from the dispenser into the cartridge, such that said signals are visually perceptible on the cartridge by a user. This is in particular advantageous because, in the service position in the plate receptacle of a crockery drawer in a dishwasher, the dispenser may be visually concealed between other items to be washed. By incoupling the light from dispenser into the cartridge, the corresponding light signals may for example also be guided into the top zone of the cartridge, such that, even if the dispenser is positioned in the plate receptacle between other items to be washed, the light signals are visually perceptible by the user since, if the crockery drawer is properly loaded, the top zones of the items to be washed and of the cartridge conventionally remain uncovered.

It is furthermore possible for the light signal incoupled into and passing through the light guide of the cartridge to be detectable by a sensor located on the dispenser. This is explained in greater detail in the following section.

In a further, advantageous development, the dispenser for releasing at least one washing and/or cleaning agent preparation into the interior of a domestic appliance comprises at least one optical transmit unit, the optical transmit unit being configured such that signals from the transmit unit may be incoupled into a cartridge couplable with the dispenser and signals from the transmit unit may be emitted into the surrounding environment of the dispenser. In this way, it is possible by means of an optical transmit unit to achieve not only signal transmission between the dispenser and for example a domestic appliance such as a dishwashing machine but also signal input into a cartridge.

In particular, the optical transmit unit may be an LED which preferably emits light in the visible and/or IR range. It is also conceivable to use another suitable optical transmit unit, such as for example a laser diode. It is particularly to be preferred to use optical transmit units, which emit light in the wavelength range between 600-800 nm.

In an advantageous further development of the invention the dispenser may comprise at least one optical receive unit. This for example makes it possible for the dispenser to receive signals from an optical transmit unit arranged in the domestic appliance. This may be achieved by any suitable optical receive unit, such as for example photocells, photomultipliers, semiconductor detectors, photodiodes, photoresistors, solar cells, phototransistors, CCD and/or CMOS image sensors. It is particularly preferred for the optical receive unit to be suitable for receiving light in the wavelength range from 600-800 nm.

In particular, the optical receive unit on the dispenser may also be constructed such that the signals from the transmit unit incouplable into a cartridge coupled with the dispenser are outcouplable from the cartridge and are detectable by the optical receive unit of the dispenser.

The signals emitted by the transmit unit into the surrounding environment of the dispenser may preferably represent information with regard to operating states or control commands.

### Dispensing Chamber

The dispenser for releasing at least one flowable washing and/or cleaning agent preparation into the interior of a domestic appliance may in particular comprise a dispensing chamber which, with the cartridge couplable with the dispenser, is connected in communicating manner with a dispensing chamber inlet located in the dispenser, such that, in the service position of the dispenser, preparation flows in gravity-actuated manner from the cartridge into the dispensing chamber wherein a dispensing chamber outlet is arranged downstream in the direction of gravity from the dispensing chamber inlet, which dispensing chamber outlet is closable by a valve, wherein a float is arranged in the dispensing chamber, the density of which is lower than the density of the preparation, wherein the float is constructed such that preparation may flow around and/or through the float and the float and the dispensing chamber inlet are configured such that the dispensing chamber inlet is closable by the float.

Depending on the configuration of the density of the preparation and the density of the float and the resultant buoyancy, the float may close the dispensing chamber inlet in sealing or nonsealing manner. In the case of a nonsealing closure, while the float does indeed rest against the dispensing chamber inlet, it does not seal the latter with regard to inflow of preparation from the cartridge, such that an exchange of preparation between the cartridge and the dispensing chamber is possible. In this development of the invention, the float acts as a deliberate throttle which, on opening of the valve, minimizes slippage between the dispensing chamber inlet and dispensing chamber outlet and so contributes to determining dispensing accuracy.

Alternatively, the float and the dispensing chamber may be constructed as a self-closing valve, on the one hand, to ensure the lowest possible energy consumption in a dispenser autonomous with regard to energy; on the other hand a defined quantity of preparation which approximately corresponds to the capacity of the dispensing chamber is released.

It is particularly advantageous to select the density of the washing and/or cleaning agent preparation and the density of the float such that the float exhibits a rate of ascent in the washing and/or cleaning agent preparation of 1.5 mm/sec to 25 mm/sec, preferably of 2 mm/sec to 20 mm/sec, particularly preferably of 2.5 mm/sec to 17.5 mm/sec. This ensures sufficiently rapid closure of the dispensing chamber inlet by the ascending float and thus a sufficiently short interval between two instances of dispensing preparation.

The rate of ascent of the float may advantageously also be stored in the valve-actuating control unit of the dispenser. In this way, it is also possible to control the valve in such a manner that a volume of preparation is released which is greater than the volume of the dispensing chamber. In this case, the valve is then reopened before the float reaches its upper closure position against the dispensing chamber inlet and closes the dispensing chamber inlet.

In order to ensure accurate dispensing from the dispensing chamber into the surrounding environment of the dispenser, it has proved advantageous for the float and the dispensing chamber to be configured such that, in the release position of the valve assigned to the dispensing chamber outlet, the rate of ascent of the float in the washing and/or cleaning agent preparation is lower than the rate of flow of the preparation surrounding the float out of the dispensing chamber.

It is preferred to make the float substantially spherical. Alternatively, the float may also be substantially cylindrical.

It is preferable for the dispensing chamber to be substantially cylindrical. It is furthermore advantageous for the diameter of the dispensing chamber to be slightly larger than the diameter of the cylindrical or spherical float, such that slippage with regard to the preparation arises between the dispensing chamber and the float.

According to a development which is to be preferred, the float is formed from a foamed, polymeric material, in particular from foamed PP.

In a further, preferred embodiment, the dispensing chamber is made L-shaped.

Furthermore, a diaphragm may be arranged in the dispensing chamber between the dispensing chamber inlet and dispensing chamber outlet, wherein the diaphragm orifice is constructed such that it may be closed by the float in sealing or nonsealing manner, wherein the float is preferably arranged between the diaphragm and the dispensing chamber inlet.

### Component Carrier

The dispenser comprises a component carrier on which are arranged at least the actuator and the closing element and the energy source and/or the control unit and/or the sensor unit and/or the dispensing chamber.

The component carrier comprises receptacles for the stated components and/or the components are shaped in a single part with the component carrier.

The receptacles for the components in the component carrier may be provided for a frictional, interlocking and/or bonded connection between a corresponding component and the corresponding receptacle.

For the purposes of simple demounting of the components from the component carrier, it is furthermore conceivable for the dispensing chamber, the actuator, the closing element, the energy source, the control unit and/or the sensor unit in each case to be detachably arranged on the component carrier.

It is also advantageous for the energy source, the control unit and the sensor unit to be arranged as a combined assembly on or in the component carrier.

In an advantageous further development of the invention, the energy source, the control unit and the sensor unit are combined as an assembly. This may for example be achieved by arranging the energy source, the control unit and the sensor unit on a common electrical printed circuit board.

According to a further preferred development of the invention, the component carrier is of a trough-like design and manufactured as an injection molding. It is particularly preferable for the dispensing chamber to be of single-part construction with the component carrier.

The component carrier ensures maximally straightforward automatic population of the dispenser with the necessary components. The component carrier may in this way be preassembled preferably automatically in its entirety and assembled to form a dispenser.

According to one embodiment of the invention, once populated, the trough-like component carrier may be closed in liquid-tight manner with a, for example, lid-like closing element. The closing element may for example take the form of a film/foil which is bonded in liquid-tight manner with the component carrier and, with the trough-like component carrier, forms one or more liquid-tight chambers.

The closing element may also be a bracket, into which the component carrier may be introduced, wherein, when in the assembled state, the bracket and the component carrier form the dispenser. When in the assembled state, the component carrier and the bracket interact such that a liquid-tight connection is formed between the component carrier and the bracket, such that no washing water can get into the interior of the dispenser or of the component carrier.

In the service position of the dispenser, it is furthermore preferred for the receptacle for the actuator on the component carrier to be arranged above the dispensing chamber in the direction of gravity, whereby a compact structure of the dispenser may be achieved. The compact design may be further optimized by arranging the dispensing chamber inlet on the component carrier above the receptacle of the actuator in the service position of the dispenser. It is also to be preferred for the components on the component carrier to be arranged substantially in a row relative to one another, in particular along the longitudinal axis of the component carrier.

In a further development of the invention, the receptacle for the actuator comprises an orifice which is in line with the dispensing chamber outlet, such that a closing element may be moved to and fro by the actuator through the orifice and the dispensing chamber outlet.

It is particularly preferred for the component carrier to be formed of a transparent material.

The component carrier advantageously comprises at least one light guide, through which light from the surrounding environment of the dispenser may be guided into and/or out of the interior(s) of the dispenser or of the component carrier to an optical transmit and/or receive unit, wherein the light guide is in particular shaped in a single-part with the transparent component carrier.

It is accordingly furthermore preferred for at least one orifice to be provided in the dispenser, through which the light from the surrounding environment of the dispenser may be incoupled and/or outcoupled into and/or out of the light guide.

### Actuator

For the purposes of the present application, an actuator is a device which converts an input variable into an output variable of a different kind and with which an object is moved or movement thereof is brought about, the actuator being coupled with at least one closing element such that release of preparation from at least one cartridge chamber may indirectly or directly be effected.

The actuator may be driven by means of drives selected from the group of gravity drives, ion drives, electric drives, motor drives, hydraulic drives, pneumatic drives, gear drives, worm gear drives, ball-screw drives, linear drives, roller-screw drives, toothed worm drives, piezoelectric drives, chain drives, and/or reaction drives.

In particular, the actuator may be constructed from an electric motor which is coupled with a gear train which converts the rotational motion of the motor into a linear motion of a carriage coupled to the gear train. This is in particular advantageous in a slender, plate-shaped configuration of the dispensing unit.

At least one magnet element may be arranged on the actuator, which magnet element, together with a magnet element of identical polarity on a dispenser, effects product release from the container as soon as the two magnet elements are positioned relative to one another such that magnetic repulsion is brought about by the magnetic elements of identical polarity and a contactless release mechanism is created.

In a particularly preferred embodiment of the invention, the actuator is a bistable solenoid which, together with a closing element taking the form of a plunger core engaging in the bistable solenoid, forms a pulse-controlled bistable valve. Bistable solenoids are electromechanical magnets with a linear direction of motion, the plunger core coming to an unenergized rest in each end position.

Bistable solenoid or valves are known from the prior art. In order to change between valve positions (open/closed), a bistable valve requires a pulse and then remains in this position until a counter-pulse is transmitted to the valve. Such a valve is accordingly also known as a pulse-controlled valve. One substantial advantage of such pulse-controlled valves is that they do not consume any energy in order to remain at the valve end positions, the closure position and the release position, but instead merely require an energy pulse to change valve position and the valve end positions should thus be considered stable. A bistable valve remains in whatever switching position for which it most recently received a control signal.

The closing element (plunger core) is driven to one end position for each pulse of electricity. If the power is switched off, the closing element retains its position. The closing element (plunger core) is driven to the other end position for each pulse of electricity. If the power is switched off, the closing element retains its position.

Bistable characteristics of solenoids may be achieved in various ways. On the one hand, it is known to divide the coil. The coil is divided more or less centrally, so creating a gap. A permanent magnet is inserted into this gap. The plunger core itself has material removed from it by lathe from both front and rear such that, in each end position, it has a planar face relative to the magnet frame. The magnetic field of the permanent magnet flows through this face. The plunger core sticks here. Alternatively, it is also possible to use two separate coils. The principle is similar to the bistable solenoid with a divided coil. The difference is that there actually are two different electrical coils. These are separately driven depending on the direction in which the plunger core is to be moved.

It is thus in particular to be preferred for the closing element to be coupled with the actuator in such a manner that the closing element may be displaced by the actuator into a closure position and into a passage position (release position), the closing element being configured as an open-close valve element, that the actuator is configured such that, driven by a suitable pulse, it adopts as desired one of two end positions and without further drive stably maintains the end position it has reached, and that the combination thus forms a pulse-controlled, bistable open-close valve.

In particular, the actuator may to this end be constructed as a bistable solenoid with a space accommodating an armature and an outer accommodation space surrounding said first space. The armature of the bistable solenoid may be configured such that it forms or is coupled with the closing element.

In order to bring about separation between a wet and a dry space in the dispenser, the actuator space accommodating the armature may be separated from the outer accommodation space of the actuator in liquid-tight and preferably also in gas-tight manner.

It is furthermore advantageous for at least the outer surface of the armature to consist of a material not susceptible to attack by the washing or cleaning agent to be dispensed, in particular of a plastics material.

The armature preferably comprises a core of a magnetizable, in particular a ferromagnetic material, and a permanent magnet positioned in the outer accommodation space, a coil being arranged at each of the two axial ends of said permanent magnet.

It is moreover preferred for the permanent magnets at the axial ends of the armature to be arranged with opposing polarities in the axial direction and for yoke rings of a ferromagnetic material, in particular of iron, to be arranged in the outer accommodation space at both axial ends, with a coil winding arranged between said yoke rings.

It is here advantageous for the axial distance between the yoke rings to be greater than the axial distance between the permanent magnets.

Furthermore, yoke rings may be arranged at the axial ends of the armature, wherein in the outer accommodation space permanent magnets are arranged with opposing polarities in the axial direction and between said permanent magnets a coil winding is arranged. The axial distance between the permanent magnets is here preferably greater than the axial distance between the yoke rings.

In particular, an actuator/closing element combination is provided in a dispenser of a dispensing system with a cartridge for flowable washing or cleaning agents with a plurality of chambers for spatially separate accommodation of in each case different preparations of a washing or cleaning agent and with a dispenser couplable with the cartridge, wherein the dispenser comprises: an energy source, a control unit, a sensor unit, an actuator which is connected with the energy source and the control unit in such a manner that a control signal from the control unit brings about actuation of the actuator, a closing element which is coupled with the actuator such that it is displaceable by the actuator into a closure position and into a passage position (release position), at least one dispensing chamber which, in the case of a dispenser assembled with a cartridge, is connected in communicating manner with at least one of the cartridge chambers of the cartridge, wherein the dispensing chamber comprises an inlet for inflow of washing or cleaning agent from a cartridge chamber and a outlet for outflow of washing or cleaning agent from the dispensing chamber into the surrounding environment and wherein at least the outlet of the dispensing chamber is closable or openable by the closing element.

In particular, the actuator is arranged in a component carrier such that, in the service position of the dispenser, a receptacle for the actuator is arranged on the component carrier above the dispensing chamber in the direction of gravity. In the service position of the dispenser, it is here very particularly advantageous for the inlet of the dispensing chamber on the component carrier to be arranged above the receptacle of the actuator.

It is also conceivable for the dispenser to comprise a component carrier in which, in the service position of the dispenser, a receptacle for the actuator is arranged on the component carrier laterally beside the dispensing chamber.

The receptacle for the actuator preferably comprises an orifice which is in line with the outlet of the dispensing chamber, wherein the closing element may be moved by the actuator to and fro through the outlet orifice.

### Closing Element

A closing element for the purposes of the present application is a component on which the actuator acts and which, as a consequence of said action, brings about opening or closing of an outlet orifice.

The closing element may, for example, comprise valves which may be adjusted by the actuator into a product release position or a closure position.

It is particularly preferred for the closing element and the actuator to assume the form of a solenoid valve, in which the dispenser is embodied by the valve and the actuator by the electromagnetic or piezoelectric drive of the solenoid valve. In particular when a plurality of containers and thus of preparations to be dispensed are used, the use of solenoid valves permits very precise control of the quantity and timing of dispensing.

It is therefore advantageous to control the release of preparations from each outlet orifice of a chamber with a solenoid valve such that the solenoid valve indirectly or directly determines the release of preparation from the product release orifice.

### Sensor

For the purposes of the present application, a sensor is a measured variable pickup or detecting element, which may qualitatively or quantitatively detect specific physical or chemical properties and/or the material nature of its surrounding environment as a measured variable.

The dispensing unit preferably comprises at least one sensor, which is suitable for detecting a temperature. The temperature sensor is designed in particular to detect a water temperature.

It is additionally preferred for the dispensing unit to comprise a sensor for detecting conductivity, whereby in particular the presence of water or the spraying of water, in particular in a dishwashing machine, is detected.

In a further development of the invention the dispensing unit comprises a sensor, which may determine physical, chemical and/or mechanical parameters from the surrounding environment of the dispensing unit. The sensor unit may comprise one or more active and/or passive sensors for the qualitative and/or quantitative detection of mechanical, electrical, physical and/or chemical variables which are forwarded to the control unit as control signals.

In particular, the sensors of the sensor unit may be selected from the group of timers, temperature sensors, infrared sensors, brightness sensors, temperature sensors, motion sensors, strain sensors, rotational speed sensors, proximity sensors, flow sensors, color sensors, gas sensors, vibration sensors, pressure sensors, conductivity sensors, turbidity sensors, instantaneous acoustic pressure sensors, “lab-on-a-chip” sensors, force sensors, acceleration sensors, inclination sensors, pH sensors, moisture sensors, magnetic field sensors, RFID sensors, magnetic field sensors, Hall sensors, biochips, odor sensors, hydrogen sulfide sensors and/or MEMS sensors.

In particular in the case of preparations whose viscosity is subject to severe temperature-dependent fluctuation, it is advantageous to provide flow sensors in the dispensing device for monitoring the volume or mass of the dispensed preparations. Suitable flow sensors may be selected from the group of diaphragm flow sensors, magnetic-inductive flow meters, mass flow metering using the Coriolis method, eddy flow metering, ultrasound flow metering, rotameter metering, annular piston flow metering, thermal mass flow metering or differential pressure flow metering.

It is particularly preferable for at least two sensor units to be provided for measuring different parameters, one sensor unit very particularly preferably being a conductivity sensor and a further sensor unit very particularly preferably being a temperature sensor. It is additionally preferable for at least one sensor unit to be a brightness sensor.

The sensors are in particular adjusted for detecting the start, progress and end of a washing program. By way of non-exhaustive examples, the sensor combinations listed in the following table may be used for this purpose:

| Sensor 1 | Sensor 2 | Sensor 3 | Sensor 4 |
|---|---|---|---|
| Conductivity | Temperature sensor | | |
| sensor | | | |
| Conductivity | Temperature sensor | Brightness sensor | |
| sensor | | | |
| Conductivity | Temperature sensor | Brightness sensor | Turbidity sensor |
| sensor | | | |
| Acoustic | Temperature sensor | | |
| sensor | | | |

Using the conductivity sensor, it is possible, for example, to detect whether the conductivity sensor has been wetted with water, such that it may for example thereby be established whether there is water in the dishwashing machine.

Washing programs as a rule exhibit a characteristic temperature profile, which is determined inter alia by the heating of the washing water and drying of the items being washed, and which may be detected using a temperature sensor.

A brightness sensor may be used, for example, to detect the incidence of light into the interior of a dishwasher when the dishwashing machine door is opened, from which it may for example be concluded that the washing program has come to an end.

A turbidity sensor may also be provided to determine the degree of soiling of the items to be washed in the dishwasher. This for example also allows selection of a dispenser dispensing program which is appropriate for the identified soiling situation.

It is also feasible to detect the progress of a washing program with the assistance of at least one acoustic sensor, specific sound and/or vibration emissions being detected, for example when water is pumped in or out.

It goes without saying that it is possible for a person skilled in the art to use any desired, suitable combinations of a number of sensors to achieve washing program monitoring.

According to a further development of the invention, it is conceivable for a temperature-dependent viscosity curve of at least one preparation to be saved in the control unit, with dispensing being adjusted by the control unit in accordance with the temperature and thus the viscosity of the preparation.

In a further development of the invention, a device is provided for directly determining the viscosity of the preparation.

The previously listed alternatives for determining the dispensing amount or viscosity of a preparation serve to generate a control signal which is processed by the control unit in such a manner for controlling a dispenser that substantially constant dispensing of a preparation is brought about.

The data line between sensor and control unit may take the form of an electrically conductive cable or may assume a cable-less form. In principle it is also conceivable for at least one sensor to be positioned or positionable outside the dispenser in the interior of a dishwashing machine and for a data line, in particular a cable-less data line, to be provided for transmitting measured data from the sensor to the dispenser.

A cable-less data line is achieved in particular by the transmission of electromagnetic waves or light. It is preferable for a cable-less data line to be configured to standards such as for example Bluetooth, IrDA, IEEE 802, GSM, UMTS etc.

To allow efficient production and assembly of the dispenser, it is also possible, however, for at least one sensor unit to be arranged on or in the control unit. For example, it is possible to provide a temperature sensor in the dispenser or directly on the board bearing the control unit, such that the temperature sensor does not have any direct contact with the surrounding environment.

In a particularly preferred development of the invention the sensor unit is arranged at the bottom of the dispenser, the bottom of the dispenser in the service position being directed downwards in the direction of gravity. It is particularly preferable here for the sensor unit to comprise a temperature and/or a conductivity sensor. Such a configuration ensures that, through the spray arms of the dishwasher, water reaches the underside of the dispenser and thus comes into contact with the sensor. Because the arrangement of the sensor on the bottom ensures that the distance between the spray arms and the sensor is as small as possible, between discharge at the spray arms and contact with the sensor the water undergoes only slight cooling, such that the temperature may be measured as accurately as possible.

To extend the dispenser's energy consumption or the service life of the energy source, the dispenser's energy consumers, in particular the control unit, may be connected to the energy source with the inclusion of an on-off switch and the energy source is subjected to load only once the on state of the on-off switch is reached, a sensor unit forming the on-off switch or being connected therewith and switching the latter.

It is particularly preferred for the sensor unit underneath on the bottom of the dispenser to comprise two contacts in contact with the surrounding environment, these in particular taking the form of contact pins projecting downwards from the bottom, for one contact to be connected relative to the energy source as an anode contact and for the other contact to be connected as a cathode contact and for the on-off switch in the off state to remain in the off state if there is no electrically conductive connection between the contacts and for the on-off switch in the off state to be switched to the on state when an electrically conductive connection arises between the contacts.

It is furthermore preferred for the on-off switch to be provided or combined with a seal-in circuit, which ensures or brings about sealing in of the energy supply of the energy consumers once the on state of the on-off switch is reached until the control unit outputs an off signal.

The on-off switch may take the form in particular of a transistor circuit. In this case it is preferable for the transistor of the on-off switch to take the form of a PNP transistor and to be connected with the emitter, optionally via a drive circuit, to the supply voltage, with the collector, optionally via a drive circuit, to ground and to the cathode contact and with the base on the one hand, optionally via a drive circuit, to the supply voltage and on the other hand, optionally via a drive circuit, to the anode contact.

The drive circuit preferably comprises at least one drive resistor, which takes the form in particular of a resistance voltage divider.

It is very particularly advantageous for a sensor unit in the form of a conductivity sensor to be provided in addition to the on-off sensor unit, the sensor unit in the form of a conductivity sensor comprising two contacts underneath on the bottom of the dispenser in contact with the surrounding environment, and for the anode contact of the on-off sensor unit simultaneously to be the anode contact of the sensor unit forming the conductivity sensor. This makes it possible to embody an on-off switch and a conductivity sensor as a single component, a transistor.

It is also possible for the sensor unit forming the temperature sensor to be integrated into a contact, in particular the cathode contact, of the sensor unit forming the conductivity sensor.

The contact, accommodating the temperature sensor, of the sensor unit forming the conductivity sensor may here preferably take the form of a hollow contact pin, in which the temperature sensor of the sensor unit forming the temperature sensor is arranged.

To achieve a compact structural size it is additionally advantageous for the energy source, the control unit and the sensor unit to be combined into an assembly on or in the component carrier.

It is particularly preferable for the contacts of a conductivity sensor arranged on the bottom to be surrounded by an electrically conductive silicone. The conductivity sensor may here take the form in particular of a resistance measurement between two mutually spaced contacts in contact with the surrounding environment of the dispenser. It is in this case very particularly preferable for the silicone to be set flush into the bottom of the dispenser. Advantageously, the silicone comprises an approximately circular base area. The silicone displays good wettability with water and thus supplies good measurement results with regard to the detection of water in the dishwasher.

In order to avoid polarization at the contacts of the conductivity sensor when a direct current source is used, which impairs sensor accuracy, it is advantageous to carry out two successive resistance measurements at the conductivity sensor with in each case different polarities, i.e. with reversal of the plus and minus poles, such that no charge excesses can form at the contacts.

### Control Unit

A control unit for the purposes of the present application is a device which is suitable for influencing the transport of material, energy and/or information. To this end, the control unit acts on actuators with the assistance of information, in particular sensor unit measurement signals, which it processes for the purposes of the control objective.

The control unit may in particular comprise a programmable microprocessor. In a particularly preferred embodiment of the invention, a plurality of dispensing programs are stored in the microprocessor which in a particularly preferred configuration may be selected and executed depending on the container coupled to the dispenser.

In a preferred embodiment, the control unit is not connected to any controller which may be present in the domestic appliance. Accordingly, no information, in particular electrical, optical or electromagnetic signals, is exchanged directly between the control unit and the controller of the domestic appliance.

In an alternative development of the invention the control unit is coupled to the existing controller of the domestic appliance. This coupling is preferably cable-less. It is possible, for example, to position a transmitter on or in a dishwashing machine, preferably on or at the dispensing chamber set into the door of the dishwashing machine, which transmits a signal wirelessly to the dispensing unit if the controller of the domestic appliance brings about dispensing for example of a cleaning agent from the dispensing chamber or of rinse aid.

A plurality of programs for the release of different preparations or for the release of products in different instances of use may be stored in the control unit.

In a preferred development of the invention, the appropriate program is called by corresponding RFID labels or geometric information media formed on the container. It is thus for example possible to use the same control unit for a plurality of applications, for example for dispensing cleaning agents in dishwashing machines, for releasing perfumes for room fragrancing, for applying cleaning substances to a toilet bowl etc.

In order to dispense preparations which in particular have a tendency towards gelation, the control unit may be configured in such a way that on the one hand dispensing takes place in a sufficiently short time to ensure a good cleaning result and on the other hand the preparation is not dispensed so quickly that the spurt of preparation gels. This may be effected for example by release at intervals, the individual dispensing intervals being adjusted in such a way that the correspondingly dispensed quantities dissolve completely during a cleaning cycle.

It is particularly preferable for the dispensing intervals for releasing a preparation to be between 30-90 sec, particularly preferably 45-75 sec.

Release of preparations from the dispenser may proceed in sequence or at the same time.

It is particularly preferable to dispense a plurality of preparations in sequence in a washing program. The following dispensing sequences are particularly preferable

| 1st dispensing | 2nd dispensing | 3rd dispensing | 4th dispensing |
|---|---|---|---|
| Enzymatic | Alkaline cleaning | | |
| cleaning | preparation | | |
| preparation | | | |
| Alkaline cleaning | Rinse aid | | |
| preparation | | | |
| Enzymatic | Alkaline cleaning | Rinse aid | |
| cleaning | preparation | | |
| preparation | | | |
| Enzymatic | Alkaline cleaning | Rinse aid | Disinfectant |
| cleaning | preparation | | preparation |
| preparation | | | |
| Enzymatic | Alkaline cleaning | Rinse aid | Scent |
| cleaning | preparation | | |
| preparation | | | |
| Pretreatment | Enzymatic | Alkaline cleaning | Rinse aid |
| preparation | cleaning | preparation | |
| | preparation | | |

According to a particularly preferred embodiment of the invention, the dishwashing machine and the dispenser interact in such a way that 1 mg to 1 g of surfactant are released in the rinse program of the dishwashing machine per m² of washing compartment wall area. In this way it is ensured that the walls of the washing compartment retain their degree of gloss even after a large number of washing cycles and the dispensing system retains its optical transmission capacity.

It is additionally advantageous for the dishwashing machine and the dispenser to interact in such a way that in the prewash and/or main wash program of the dishwashing machine at least one enzyme-containing preparation and/or alkaline preparation is released, the enzyme-containing preparation preferably being released before the alkaline preparation.

In a further, advantageous development of the invention, the dishwashing machine and dispenser interact in such a way that 0.1 mg-250 mg of enzyme protein are released in the prewash and/or main wash program of the dishwashing machine per m² of washing compartment wall area, whereby the degree of gloss of the washing compartment walls is further improved or is maintained even after a plurality of washing cycles.

In an advantageous further development of the invention, data such as for example control and/or dispensing programs of the control unit or operating parameters or protocols stored by the control unit may be read out of the control unit or loaded into the control unit. This may be performed for example by means of an optical interface, wherein the optical interface is connected appropriately to the control unit. The data to be transmitted are then encoded as light signals, in particular in the visible range, the wavelength range between 600-800 nm being preferred, and emitted or received. It is also possible, however, to use a sensor present in the dispenser for transmitting data from and/or to the control unit. For example, the contacts of a conductivity sensor, which are connected to the control unit and which provides conductivity determination by means of resistance measurement at the contacts of the conductivity sensor, are used for data transmission.

### Method in the Control Unit

By means of the control unit, a method may in particular be developed for operating a dispenser not firmly connected to a domestic appliance for release of at least one washing and/or cleaning agent preparation into the interior of the domestic appliance, wherein at least one dispensing program is stored in the control unit, and the control unit cooperates with at least one actuator located in the dispenser in such a way that washing and/or cleaning agent preparation may be released by the dispenser into the interior of the domestic appliance, the dispenser comprises at least one receive unit for signals, which are emitted by at least one transmit unit arranged in the domestic appliance and at least some of the signals are converted in the dispenser-side control unit into control commands for the actuators of the dispenser, wherein reception of the signals on the dispenser side is monitored by means of the control unit and a dispensing program from the control unit of the dispenser is activated if the signals are not received at the dispenser.

This makes it possible for preparation dispensing to be ensured in the event of an interruption to the signals between the transmit unit on the domestic appliance and the dispenser, the dispenser handing over overall control from the domestic appliance to the controller inside the dispenser.

In particular, it is advantageous for the domestic appliance-side signal to be emitted at predefined periodic intervals by the transmit unit on the domestic appliance into the interior of the domestic appliance. This makes it possible for the defined, periodic intervals at which a signal is output by the transmit unit on the domestic appliance to be saved in the control unit of the dispenser as well as in the domestic appliance. If contact between the transmit unit of the domestic appliance is interrupted after reception of a signal at the dispenser, this interruption may be identified at the dispenser by comparing the time that has elapsed since the last received signal and the time at which reception of a subsequent signal is expected according to the defined, periodic time interval.

It is preferable for the periodic signal intervals to be selected as between 1 sec and 10 min, preferably between 5 sec and 7 min, particularly preferably between 10 sec and 5 min. It is very particularly preferable for the periodic signal intervals to be selected as between 3 min and 5 min.

It is therefore particularly advantageous for reception of a signal output by the domestic appliance to be logged in the control unit of the dispenser with time information t₁.

It is very particularly preferred for the control unit of the dispenser to activate a dispensing program from the control unit of the dispenser after elapse of a predefined time interval t₁₋₂ starting at t₁ during which no further domestic appliance-side signal has been received by the dispenser.

According to an advantageous further development of the invention, the control unit evaluates the number and/or sequence of the signals received by the dispenser in such a way that a dispensing program is activated in the control unit in accordance with the evaluation result. This makes it possible for example to determine the duration of a washing program in a dishwashing machine from the start thereof by comparing the time at which the first signal is received with the time at which interruption of the signal is identified, such that, in accordance with the progress of the washing program, a suitable dispensing program is activated in the control unit of the dispenser which corresponds to the progress of the washing program.

It is also conceivable, on the basis of the above-described evaluation of the number and/or sequence of the signals received by the dispenser, for a dispensing program stored in the control unit of the dispenser to be activated in the control unit beginning from a defined program step corresponding to the progress of the washing program. It is thus possible for example, in the event of signal interruption in the main washing cycle of a washing program, to activate a dispensing program in the dispenser which is provided for a main washing cycle and subsequent washing program sections.

In particular, the signals emitted by the transmit unit on the domestic appliance comprise at least one control signal.

In an advantageous further development of the invention, the signals emitted by the transmit unit on the domestic appliance comprise at least one monitoring signal.

Furthermore, it is advantageous for at least one dispensing program stored in the control unit to comprise a domestic appliance dispensing program. This makes it possible for the dispenser to continue a dispensing program begun by the domestic appliance in the event of signal interruption between the domestic appliance and the dispenser.

It is therefore particularly preferable for the dispensing programs stored in the control unit of the dispenser to comprise the dispensing programs of the domestic appliance.

If a signal does not appear at the dispenser, an acoustic and/or optical signal perceptible to a user may advantageously be generated, which indicates the signal interruption.

It may additionally be advantageous for it to be possible for emission of a monitoring signal and/or control signal at the domestic appliance to be effected manually by a user. In this way, a user may for example verify whether signal reception exists between the transmit unit of the domestic appliance and the dispenser when the dispenser is in a position selected by said user inside the domestic appliance. This may be effected for example by operating elements provided on the domestic appliance, such as for example a pushbutton or switch, which emits a monitoring and/or control signal on actuation.

### Energy Source

For the purposes of the present application, an energy source is taken to mean a component of the dispensing device which is capable of providing energy which is suitable for operation of the dispensing system or of the dispenser. The energy source is preferably configured such that the dispensing system is autonomous.

The energy source preferably provides electrical energy. The energy source may for example comprise a battery, a storage battery, a mains energy supply, solar cells or the like.

It is particularly advantageous to make the energy source interchangeable, for example in the form of a replaceable battery.

A battery may for example be selected from the group of alkali-manganese batteries, zinc-carbon batteries, nickel-oxyhydroxide batteries, lithium batteries, lithium-iron sulfide batteries, zinc-air batteries, zinc chloride batteries, mercury oxide-zinc batteries and/or silver oxide-zinc batteries.

Examples of suitable storage batteries are lead storage batteries (lead dioxide/lead), nickel-cadmium storage batteries, nickel-metal hydride storage batteries, lithium-ion storage batteries, lithium-polymer storage batteries, alkali-manganese storage batteries, silver-zinc storage batteries, nickel-hydrogen storage batteries, zinc-bromine storage batteries, sodium-nickel chloride storage batteries and/or nickel-iron storage batteries.

The storage battery may in particular be designed in such a way that it may be rechargeable by induction.

It is however also conceivable to provide mechanical energy sources consisting of one or more helical springs, torsion springs or torsion bars, bending springs, air/gas springs and/or elastomer springs.

The energy source is dimensioned in such a manner that the dispenser may run through approximately 300 dispensing cycles before the energy source is exhausted. It is particularly preferable for the energy source to run through between 1 and 300 dispensing cycles, very particularly preferably between 10 and 300, more preferably between 100 and 300, before the energy source is exhausted.

In addition, means may be provided on the dispensing unit for energy conversion, which generate a voltage by means of which the storage battery is charged. These means may for example take the form of a dynamo, which is driven by the water currents during a washing cycle in a dishwashing machine and outputs the voltage generated in this way to the storage battery.

### Light Guide, Dispenser

An optical transmit and/or receive unit is preferably arranged inside the dispenser, in particular in or on the component carrier, in order to protect the electrical and/or optical components of the transmit and/or receive unit from being affected by water splashes and washing water.

To conduct light out of the surrounding environment of the dispenser to the optical transmit and/or receive unit, a light guide is arranged between the optical transmit and/or receive unit and the surrounding environment of the dispenser, which exhibits light transmittance of at least 75%. The light guide preferably consists of a transparent plastics material with a transmittance of at least 75%. The transmittance of the light guide is defined as transmittance between the surface of the light guide at which light is incoupled from the surrounding environment of the dispenser into the light guide and the surface at which light is outcoupled from the light guide to the optical transmit and/or receive unit. Transmittance may be determined to DIN 5036.

The light guide comprises at least one incoupling and/or outcoupling point at which light from an optical transmit and/or receive unit and/or from the surrounding environment of the dispenser is respectively incoupled and outcoupled.

It is particularly preferable for the light guide to be of single-part construction with the component carrier. Advantageously, the component carrier is therefore made from a transparent material.

To accommodate the incoupling and/or outcoupling point of the light guide and produce an optical connection between light guide and surrounding environment, an orifice is provided in the dispenser. The incoupling and/or outcoupling point may be arranged in the outer circumferential surface in the bottom or top of the dispenser. In order to provide a good transmit and/or receive characteristic for optical signals, it may be advantageous for the incoupling and/or outcoupling point of the light guide to be of lenticular and/or prismatic construction.

The light guide may also be of multi-layer and/or multi-part construction of identical or different materials. It is also possible to provide an air gap between a light guide of multi-layer and/or multi-part form. The transmittance of the light guide is understood in the case of multi-layer and/or multi-part structure as being between the surface of the light guide at which light is incoupled from the surrounding environment of the dispenser into the light guide and the surface at which light is outcoupled from the light guide to the optical transmit and/or receive unit.

In addition, it is preferable for at least two incoupling or outcoupling points of the light guide to be provided relative to the surrounding environment. It is particularly advantageous for the incoupling or outcoupling points on the dispenser to be substantially opposite one another.

### Vibratory Atomizer

In a further preferred embodiment of the invention the dispensing system comprises at least one vibratory atomizer, by means of which it is possible to convert a preparation into the gas phase or keep it in the gas phase. It is thus conceivable, for example, to use the vibratory atomizer to vaporize, nebulize and/or atomize preparations, whereby the preparation is converted into the gas phase or forms an aerosol in the gas phase, the gas phase conventionally being air.

This embodiment is particularly advantageous when using a dishwashing or washing machine in which corresponding release of preparation into the gas phase takes place in a closable washing compartment. The preparation introduced into the gas phase may be distributed uniformly about the washing compartment and be deposited on the items to be washed located in the dishwashing machine.

The preparation released by the vibratory atomizer may be selected from the group of surfactant-containing preparations, enzyme-containing preparations, odor-neutralizing preparations, biocidal preparations and antibacterial preparations.

By applying the cleaning preparations onto the items being washed from the gas phase, a uniform layer of the corresponding cleaning preparation is applied onto the surface of the items being washed. It is particularly preferable for the entire surface of the items being washed to be wetted by the cleaning preparation.

In this way, a plurality of advantageous effects may be achieved before the start of a water-releasing cleaning program in the dishwashing machine. On the one hand, a suitable cleaning preparation may prevent malodors from arising as a result of biological decomposition processes taking place in food residues sticking to the items being washed. On the other hand, an appropriate cleaning preparation may “soften” any food residues which may be stuck to the items being washed, such that these may be easily and completely detached during the dishwasher cleaning program, in particular in the case of low temperature programs.

It is additionally possible to apply a preparation onto the items being washed by means of the vibratory atomizer after completion of a dishwashing machine cleaning program. In this case the preparation may for example be a preparation with antibacterial action or a preparation for modifying surfaces.

### Preparation

The dispensing system according to the invention comprises at least one first aqueous surfactant-containing preparation, which in particular has a pH value of less than 5.5, preferably less than 4, particularly preferably less than 3.5 (10% solution, 20° C.). By adjusting the acidity of the surfactant phase, it is possible in particular to prevent lime deposits on the walls of the washing compartment, which may reduce the degree of gloss and the reflectivity of the walls. It has also surprisingly emerged that, by means of such a surfactant preparation, the transmittance of the light guide between the optical transmit and/or receive unit of the dispenser and the surrounding environment of the dispenser may be kept constant even over a large number of washing cycles.

As stated above, wireless signal transmission for controlling the dispensing systems positioned in the washing compartment is ensured and improved according to the invention by means of a specific surfactant-containing preparation to be released in the rinse cycle. In addition to its surfactant content, this preparation is additionally distinguished by its pH value of below 5.5 (10% solution, 20° C.).

The preparations according to the invention contain acidifying agents to adjust the pH value. The proportion by weight of acid(s) in the total weight of the preparation according to the invention amounts, relative to the total weight of the preparation, preferably to between 0.05 and 10 wt. %, preferably between 0.1 and 8 wt. % and in particular between 0.2 and 5 wt. %.

The acidifying agent may take the form of both inorganic acids and organic acids, organic acids being particularly preferred for the purposes of the present application for reasons of consumer protection and handling safety. Particularly preferred organic acids are mono-, oligo- and polycarboxylic acids, in particular citric acid, acetic acid, tartaric acid, succinic acid, glutaric acid, malonic acid, adipic acid, maleic acid, fumaric acid, oxalic acid and homo- or copolymeric polycarboxylic acids. Organic sulfonic acids such as amidosulfonic acids may likewise be used.

Particularly preferred preparations according to the invention contain, relative to their total weight, between 0.05 and 10 wt. %, preferably between 0.1 and 8 wt. % and in particular between 0.2 and 5 wt. % of acetic acid and/or citric acid.

It goes without saying that the preparations according to the invention may also contain salts of the above-stated acids as buffer substances. Preference is here given to alkali metal salts and amongst these in turn to sodium or potassium salts.

In addition to the acidifying agent, a second essential component of preparations according to the invention is surfactants. In addition to anionic and amphoteric surfactants, the group of surfactants in particular also comprises nonionic surfactants, which are particularly preferentially used.

Any nonionic surfactants known to a person skilled in the art may in principle be used as the nonionic surfactants. Examples of suitable nonionic surfactants are alkyl glycosides of the general formula RO(G)ₓ, in which R corresponds to a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose. The degree of oligomerization x, which indicates the distribution of monoglycosides and oligoglycosides, is any desired number between 1 and 10; x is preferably 1.2 to 1.4.

Nonionic surfactants of the amine oxide type, for example N-coconut alkyl-N,N-dimethylamine oxide and N-tallow alkyl-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants are used as preferred surfactants. Washing or cleaning agents, in particular cleaning agents for machine dishwashing, particularly preferentially contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. Preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Ethoxylated nonionic surfactants which were obtained from C₆₋₂₀ monohydroxyalkanols or C₆₋₂₀ alkylphenols or C₁₆₋₂₀ fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₈ alcohol, and at least 12 mol, preferably at least 15 mol and in particular at least 20 mol of ethylene oxide. Among these, “narrow range ethoxylates” are particularly preferred.

In particular, nonionic surfactants having a melting point of above room temperature are preferred. Nonionic surfactant(s) with a melting point of above 20° C., preferably of above 25° C., particularly preferably of between 25 and 60° C. and in particular of between 26.6 and 43.3° C., is/are particularly preferred.

Nonionic surfactants from the group of alkoxylated alcohols, particularly preferably from the group of mixed alkoxylated alcohols and in particular from the group of EO-AO-EO nonionic surfactants, are likewise particularly preferentially used.

The nonionic surfactant which is solid at room temperature preferably comprises propylene oxide units in its molecule. Such PO units preferably constitute up to 25 wt. %, particularly preferably up to 20 wt. % and in particular up to 15 wt. % of the total molar mass of the nonionic surfactant. Particularly preferred nonionic surfactants are ethoxylated monohydroxyalkanols or alkylphenols which additionally comprise polyoxyethylene/polyoxypropylene block copolymer units. The alcohol or alkylphenol moiety of such nonionic surfactant molecules here preferably constitutes more than 30 wt. %, particularly preferably more than 50 wt. % and in particular more than 70 wt. % of the total molar mass of such nonionic surfactants. Preferred agents are characterized in that they contain ethoxylated and propoxylated nonionic surfactants, in which the propylene oxide units constitute in each molecule up to 25 wt. %, preferably up to 20 wt. % and in particular up to 15 wt. % of the entire molar mass of the nonionic surfactant.

Preferably used surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably to be used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants which have proved to be particularly preferred for the purposes of the present invention are low-foaming nonionic surfactants which comprise alternating ethylene oxide and alkylene oxide units. Among these, surfactants with EO-AO-EO-AO blocks are in turn preferred, with in each case one to ten EO or AO groups being attached to one another before being followed by a block of the respective other groups. Preferred nonionic surfactants are those of the general formula

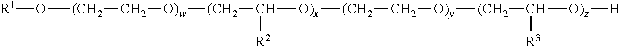

in which R¹ denotes a straight-chain or branched, saturated or mono- or polyunsaturated C₆₋₂₄ alkyl or alkenyl residue; each group R² or R³ is mutually independently selected from —CH₃, —CH₂CH₃, —CH₂CH₂—CH₃, CH(CH₃)₂ and the indices w, x, y, z mutually independently denote integers from 1 to 6.

The preferred nonionic surfactants of the above formula may be produced by known methods from the corresponding alcohols R¹—OH and ethylene or alkylene oxide. Residue R¹ in the above formula may vary depending on the origin of the alcohol. If natural sources are used, the residue R¹ comprises an even number of carbon atoms and is generally unbranched, preference being given to linear residues from alcohols of natural origin with 12 to 18 C atoms, for example from coconut, palm, tallow fat or oleyl alcohol. Alcohols obtainable from synthetic sources are for example Guerbet alcohols or residues methyl-branched in position 2 or linear and methyl-branched residues in a mixture as are conventionally present in oxo alcohol residues. Irrespective of the nature of the alcohol used for producing nonionic surfactants contained in the preparations, preferred nonionic surfactants are those in which R¹ in the above formula denotes an alkyl residue with 6 to 24, preferably 8 to 20, particularly preferably 9 to 15 and in particular 9 to 11 carbon atoms.

Apart from propylene oxide, butylene oxide may in particular be considered as the alkylene oxide unit which alternates with the ethylene oxide unit in preferred nonionic surfactants. However, further alkylene oxides, in which R² or R³ are mutually independently selected from —CH₂CH₂—CH₃ or —CH(CH₃)₂ are also suitable. Nonionic surfactants of the above formula which are preferably used are those in which R² or R³ denotes a residue —CH₃, w and x mutually independently denote values of 3 or 4 and y and z mutually independently denote values of 1 or 2.

In summary, preferred nonionic surfactants are in particular those which comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)_{w}-(A′O)ₓ-(A″O)_{y}-(A′″O)_{z}—R², in which R¹ and R² mutually independently denote a straight-chain or branched, saturated or mono- or polyunsaturated C₂₋₄₀ alkyl or alkenyl residue; A, A′, A″ and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z denote values between 0.5 and 90, with x, y and/or z possibly also being 0, are preferred according to the invention.

In particular, preferred end group-terminated poly(oxyalkylated)nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants are those of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15.

Particularly preferred end group-terminated poly(oxyalkylated)nonionic surfactants are furthermore those of the formula R¹O[CH₂CH₂O]ₓ[CH₂CH(R³)O]_{y}CH₂CH(OH)R², in which R^{1 and R}² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, with nonionic surfactants with R³=—CH₃ and values of x from 15 to 32 and y of 0.5 and 1.5 being very particularly preferred.

Thanks to the use of the above-described nonionic surfactants with a free hydroxyl group on one of the two terminal alkyl residues, it is possible to achieve a distinct improvement in the formation of film deposits in machine dishwashing in comparison with conventional polyalkoxylated fatty alcohols without a free hydroxyl group.

Further preferably usable nonionic surfactants are the end group-terminated poly(oxyalkylated)nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues with 1 to 30 carbon atoms, R³ denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value of x is ≧2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH³ or —CH₂CH₃ are particularly preferred for the residue R₃. Particularly preferred values for x are in the range from 1 to 20, in particular from 6 to 15.

As described above, each R³ in the above formula may be different if x is ≧2. In this manner, it is possible to vary the alkylene oxide unit in the square brackets. For example, if x denotes 3, the residue R³ may be selected in order to form ethylene oxide (R³═H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, the range of variation increasing as the value of x rises and for example comprising a large number of (EO) groups combined with a small number of (PO) groups, or vice versa.

Particularly preferred end group-terminated poly(oxyalkylated) alcohols of the above-stated formula have values of k=1 and j=1, so simplifying the above formula to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those in which the residues R¹ and R² comprise 9 to 14 C atoms, R³ denotes H and x assumes values from 6 to 15.

The stated C chain lengths and degrees of ethoxylation or degrees of alkoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only the C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various of the above-stated general formulae.

The proportion by weight of nonionic surfactants in the total weight of the preparation according to the invention amounts in a preferred embodiment to between 1.0 and 25 wt. %, preferably between 2.0 and 20 wt. %, preferably between 3.0 and 17 wt. % and in particular between 5.0 and 15 wt. %.

The preparations according to the invention for release in the rinse cycle contain water, the proportion by weight of the water in the total weight of the composition preferably amounting to between 1.0 and 90 wt. %, preferably between 2.0 and 80 wt. % and in particular between 5.0 and 70 wt. %. Very particularly preferred preparations have a water content of between 30 and 90 wt. %, preferably between 40 and 80 wt. % and in particular between 50 and 70 wt. %.

In addition to the above-stated ingredients, the preparations according to the invention may contain nonaqueous solvents. It has been demonstrated that, by adding organic solvents, the surface properties of the walls of the washing compartment may be influenced in a manner favorable to the desired signal transmission. The proportion by weight of the organic solvents in the total weight of the preparation according to the invention preferably amounts to between 1.0 and 30 wt. %, preferably between 2.0 and 25 wt. % and in particular between 4.0 and 20 wt. %.

Nonaqueous solvents which may be used in the preparations according to the invention originate for example from the group of mono- or polyhydric alcohols, alkanolamines or glycol ethers. The solvents are preferably selected from ethanol, n- or i-propanol, butanols, glycol, propanediol or butanediol, glycerol, diglycol, diethylene glycol monopropyl or monobutyl ether, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol methyl or ethyl ether, methoxy-, ethoxy- or butoxytriglycol, 1-butoxyethoxy-2-propanol, 3-methyl-3-methoxybutanol, propylene glycol t-butyl ether, 1,2-propylene glycol and mixtures of these solvents.

The organic solvents from the group of organic amines and/or alkanolamines have proven particularly effective with regard to advantageously influencing signal transmission in the washing compartment.

Primary and secondary alkylamines, alkyleneamines and mixtures of these organic amines are particularly preferred as organic amines. The group of preferred primary alkylamines include monomethylamine, monoethylamine, monopropylamine, monobutylamine, monopentylamine and cyclohexylamine. The group of preferred secondary alkylamines includes in particular dimethylamine.

Preferred alkanolamines are in particular primary, secondary and tertiary alkanolamines and mixtures thereof. Particularly preferred primary alkanolamines are monoethanolamine(2-aminoethanol, MEA), monoisopropanolamine, diethylethanolamine(2-(diethylamino)-ethanol). Particularly preferred secondary alkanolamines are diethanolamine(2,2′-iminodiethanol, DEA, bis(2-hydroxyethyl)amine), N-methyl-diethanolamine, N-ethyldiethanolamine, diisopropanolamine and morpholine. Particularly preferred tertiary alkanolamines are triethanolamine and triisopropanolamine.

The preparations according to the invention may additionally contain hydrotropes. Preferred hydrotropes are xylene- and cumenesulfonate as well as urea and N-methylacetamide.

Preparations preferred for the purposes of the present invention contain toluene-, cumene- or xylenesulfonate in quantities of 0.5 to 15 wt. %, preferably of 1.0 to 12 wt. %, particularly preferably of 2.0 to 10 wt. % and in particular of 2.5 to 8 wt. %, in each case relative to the total weight of the preparation.

To prevent the formation of cloudiness, streaks and scratches on dishwasher-cleaned glass surfaces, the preparations according to the invention may contain glass corrosion inhibitors. Preferred glass corrosion inhibitors originate from the group of zinc salts and zinc complexes.

The spectrum of zinc salts preferred according to the invention, preferably the zinc salts of organic acids, particularly preferably the zinc salts of organic carboxylic acids, extends from salts which are sparingly soluble or insoluble in water, i.e. exhibit a solubility of below 100 mg/l, preferably of below 10 mg/l, in particular of below 0.01 mg/l, up to those salts which exhibit a solubility in water of above 100 mg/l, preferably of above 500 mg/l, particularly preferably of above 1 g/l and in particular of above 5 g/l (all solubilities at 20° C. water temperature). The first group of zinc salts includes for example zinc citrate, zinc oleate and zinc stearate, while the group of soluble zinc salts includes for example zinc formate, zinc acetate, zinc lactate and zinc gluconate.

At least one zinc salt of an organic carboxylic acid, particularly preferably a zinc salt from the group of zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

A number of exemplary formulations for preferred preparations according to the invention may be found in the following tables:

| | No. 1 | No. 2 | No. 3 | No. 4 | No. 5 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 6 | No. 7 | No. 8 | No. 9 | No. 10 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 11 | No. 12 | No. 13 | No. 14 | No. 15 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Citric acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Misc. | Ad 100 | Ad 100 | Ad 100 | Ad 100 | Ad 100 |

| | No. 16 | No. 17 | No. 18 | No. 19 | No. 20 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 21 | No. 22 | No. 23 | No. 24 | No. 25 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 26 | No. 27 | No. 28 | No. 29 | No. 30 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Citric acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Org. solvent | 0-30 | 0 to 25 | 0 to 25 | 0-20 | 0-20 |
| Hydrotrope | 0-15 | 0-12 | 0-10 | 0-8 | 0-8 |
| Misc. | Ad 100 | Ad 100 | Ad 100 | Ad 100 | Ad 100 |

| | No. 31 | No. 32 | No. 33 | No. 34 | No. 35 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic | 1.0-25 | 2.0-20 | 3.0-17 | 5.0-15 | 5.0-15 |
| surfactant | | | | | |
| 1,2-Propylene | 1.0-30 | 2.0 to 25 | 2.0 to 25 | 4.0-20 | 4.0-20 |
| glycol | | | | | |
| Misc. | Ad 100 | Ad 100 | Ad 100 | Ad 100 | Ad 100 |

| | No. 36 | No. 37 | No. 38 | No. 39 | No. 40 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic | 1.0-25 | 2.0-20 | 3.0-17 | 5.0-15 | 5.0-15 |
| surfactant | | | | | |
| 1,2-Propylene | 1.0-30 | 2.0 to 25 | 2.0 to 25 | 4.0-20 | 4.0-20 |
| glycol | | | | | |
| Misc. | Ad 100 | Ad 100 | Ad 100 | Ad 100 | Ad 100 |

| | No. 41 | No. 42 | No. 43 | No. 44 | No. 45 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Na cumenesulfonate | 0.5-15 | 1.0-12 | 2.0-10 | 2.5-8 | 2.5-8 |
| Misc. | Ad 100 | Ad 100 | Ad 100 | Ad 100 | Ad 100 |

| | No. 46 | No. 47 | No. 48 | No. 49 | No. 50 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| Na cumenesulfonate | 0.5-15 | 1.0-12 | 2.0-10 | 2.5-8 | 2.5-8 |
| Misc. | Ad 100 | Ad 100 | Ad 100 | Ad 100 | Ad 100 |

| | No. 51 | No. 52 | No. 53 | No. 54 | No. 55 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acid | 0.05-10 | 0.1-8 | 0.1-8 | 0.2-5 | 0.2-5 |
| Nonionic | 1.0-25 | 2.0-20 | 3.0-17 | 5.0-15 | 5.0-15 |
| surfactant | | | | | |
| Org. solvent | 1.0-30 | 2.0 to 25 | 2.0 to 25 | 4.0-20 | 4.0-20 |
| Hydrotrope | 0.5-15 | 1.0-12 | 2.0-10 | 2.5-8 | 2.5-8 |
| Misc. | Ad 100 | Ad 100 | Ad 100 | Ad 100 | Ad 100 |

| | No. 56 | No. 57 | No. 58 | No. 59 | No. 60 |
|---|---|---|---|---|---|
| Ingredient | [wt. %] | [wt. %] | [wt. %] | [wt. %] | [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic | 1.0-25 | 2.0-20 | 3.0-17 | 5.0-15 | 5.0-15 |
| surfactant | | | | | |
| 1,2-Propylenel | 1.0-30 | 2.0 to 25 | 2.0 to 25 | 4.0-20 | 4.0-20 |
| glyco | | | | | |
| Na | 0.5-15 | 1.0-12 | 2.0-10 | 2.5-8 | 2.5-8 |
| cumenesulfonate | | | | | |
| Misc. | Ad 100 | Ad 100 | Ad 100 | Ad 100 | Ad 100 |

| | No. 61 | No. 62 | No. 63 | No. 64 | |
|---|---|---|---|---|---|
| Ingredient | [wt. %] | [wt. %] | [wt. %] | [wt. %] | No. 65 [wt. %] |
| Water | 1.0-90 | 1.0-90 | 2.0-80 | 5.0-70 | 40-80 |
| Acetic acid | 0.05-10 | 0.1-8 | 0.1-8 | 0.2-5 | 0.2-5 |
| Nonionic surfactant | 1.0-25 | 2.0-20 | 3.0-17 | 5.0-15 | 5.0-15 |
| 1,2-Propylene glycol | 1.0-30 | 2.0 to 25 | 2.0 to 25 | 4.0-20 | 4.0-20 |
| Na cumenesulfonate | 0.5-15 | 1.0-12 | 2.0-10 | 2.5-8 | 2.5-8 |
| Zinc salt | 0.1 to 4.0 | 0.2 to 3.0 | 0.2 to 3.0 | 0.5 to 2.0 | 0.5 to 2.0 |
| Misc. | Ad 100 | Ad 100 | Ad 100 | Ad 100 | Ad 100 |

It is moreover advantageous for obtaining and/or improving the degree of gloss of the washing compartment walls for at least one surfactant, at least one polymer and at least one phosphonate to be released from one or more preparations into the washing liquor, these components being selected such that at least the surfactant and the polymer adhere to the surface of the light guide directed into the washing compartment. This improves run-off of washing liquid from and drying of the walls, so reducing deposits on the walls, for example in the form of water spots. In addition, the surfactants and/or polymers adhering to the walls provide a kind of sealing finish on the wall surfaces, such that fresh adhesion of foreign matter may be prevented.

### Dishwashing Machine

A dishwashing machine suitable for the dispensing system according to the invention in particular comprises a closable washing compartment. Conventionally, the washing compartment of a dishwashing machine is opened and closed by a door or drawer. Conventionally, the washing compartment is protected in this way from the ingress of ambient light.

The walls of the washing compartment have in particular a degree of gloss of at least 10 gloss units, preferably at least 20 gloss units, particularly preferably at least 45 gloss units measured to DIN 67530 with 60° geometry. This enables multiple reflections of the radiated optical signals from the walls of the washing compartment, so reducing the risk of possible signal shadows, in particular for optical signals in the visible and/or IR range in the interior of the washing compartment of the dishwashing machine.

An average degree of gloss means the degree of gloss averaged over the entire surface of a wall. In a particularly preferred development of the invention, the average degree of washing compartment gloss amounts to at least 10 gloss units, preferably at least 20 gloss units, particularly preferably at least 45 gloss units measured to DIN 67530 with 60° geometry.

An average degree of washing compartment gloss means the degree of gloss averaged over the entire surface of all the washing compartment walls. In a particularly preferred development of the invention, the average degree of gloss of the washing compartment walls amounts to at least 10 gloss units, preferably at least 20 gloss units, particularly preferably at least 45 gloss units measured to DIN 67530 with 60° geometry.

To reduce further the risk of signal shadows in the washing compartment, in particular for optical signals in the visible or IR range, it is particularly advantageous for the walls of the washing compartment to exhibit a reflectance of at least 50%.

An average reflectance means the reflectance averaged over the entire surface of a wall. In a particularly preferred development of the invention the average reflectance of the washing compartment walls amounts to at least 50%.

An average washing compartment reflectance means the reflectance averaged over the entire surface of all the washing compartment walls. In a further preferred development of the invention the average washing compartment reflectance amounts to at least 50%.

In a preferred development of the invention the walls of the washing compartment comprise optical reflection elements. The reflection elements serve in distributing the optical signals as homogeneously as possible in particular in the visible and/or IR range within the washing compartment, such that zones of optical signal shadows within the washing compartment may be reduced or completely avoided by the corresponding reflections. It is particularly preferable for the reflection elements to be formed integrally with the washing compartment walls. According to an advantageous development the optical reflection elements project out of the plane of the washing compartment walls and into the washing compartment. It is also conceivable, however, for the optical reflection elements to take the form of recesses in the washing compartment walls. The optical reflection elements may assume any suitable three-dimensional shape, in particular the optical reflection elements are for example dome-shaped, bowl-shaped, truncated cone-shaped, cuboidal or cubic, with rounded or sharp edges and/or consist of combinations of the above.

The reflection elements may in particular be arranged approximately centrally on a washing compartment wall. However, it is also conceivable additionally or alternatively to provide reflection elements at the edges or corners of a washing compartment wall, in order to reduce the risk of signal shadows in particular in the rear, lower and upper corners of the washing compartment (when viewed from the dishwashing machine door).

### Release Device for the Dishwasher

In a preferred embodiment of the invention the dispenser may receive signals from a release device fixed in a dishwashing machine.

The release device for releasing at least one preparation into the interior of a dishwasher may in particular be a cleaning agent dispenser, a release device for rinse aid or salt or a combi dispenser.

The release device advantageously comprises at least one transmit unit and/or at least one receive unit for wireless transmission of signals into the interior of the dishwasher or for wireless reception of signals from the interior of the dishwasher.

It is particularly preferable for the transmit unit and/or receive unit to be configured to emit or receive optical signals. It is very particularly preferable for the transmit unit and/or receive unit to be configured to emit or receive light in the visible range. Since conventionally when a dishwashing machine is in operation it is dark inside the washing compartment, signals may be emitted and detected in the visible optical range, for example in the form of signal pulses or photoflashes.

Alternatively or in addition, it is advantageous for the transmit unit and/or receive unit to be configured to emit or receive infrared signals. It is particularly advantageous for the transmit unit and/or receive unit to be configured to emit or receive infrared signals in the near infrared range (780 nm-3000 nm).

In particular, the transmit unit comprises at least one LED. Particularly preferably, the transmit unit comprises at least two LEDs. It is very particularly advantageous in this case for at least two LEDs to be arranged at a transmission angle offset by 90° relative to one another. In this way, the risk of signal shadows, in which a freely positionable signal receiver, in particular a dispenser, could be situated may be reduced by the multiple reflections produced inside the dishwasher.

It is also possible according to a further development of the invention which is to be preferred to provide at least two LEDs, which emit light at different wavelengths. This makes it possible, for example, to define different signal bands on which information may respectively be transmitted or received.

In addition, it is advantageous, in a further development of the invention, for at least one LED to be an RGB LED, the wavelength of which is adjustable. Thus, for example, different signal bands which emit signals on different wavelengths may be defined with one LED. It is thus for example also conceivable for light to be emitted on a different wavelength during the drying process, during which high atmospheric humidity (fog) prevails in the washing compartment, than for example during a washing stage.

The transmit unit of the release device may be configured in such a way that the LED is provided both for emitting signals inside the dishwasher, in particular when the dishwashing machine door is closed, and for optical indication of an operating state, for example the filling level of the salt or rinse aid storage container of a dishwashing machine, in particular when the dishwashing machine door is open.

It is particularly preferable for an optical signal to be configured as a signal pulse or a sequence of signal pulses with a pulse duration of between 1 ms and 10 seconds, preferably between 5 ms and 100 ms.

In addition, it is advantageous for the transmit unit to be configured in such a way that it emits an optical signal with the dishwashing machine closed which brings about an average illuminance E of between 0.01 and 100 lux, preferably between 0.1 and 50 lux, measured at the walls bounding the washing compartment. This illuminance is then sufficient to bring about multiple reflections with or from the other washing compartment walls and thus to reduce or prevent possible signal shadows in the washing compartment, in particular when the dishwashing machine is loaded.

The receive unit of the release device may in particular comprise a photodiode.

In a further development of the invention, the release device may additionally or alternatively also be configured to emit or receive radio signals.

The signal emitted by the transmit unit and/or received by the receive unit in particular bears information, in particular a control signal.

It is particularly preferable for the release device to be arranged in the door of a dishwashing machine.

In addition, a receptacle for detachably fixing a dispenser to the release device may be provided on the release device. In this way it is possible, for example, to position the dispenser not only in the crockery drawer of a dishwasher, but also directly on a release device for the dishwasher, in particular a combi dispenser. In this way, on the one hand no loading space in the crockery drawer is occupied by the dispenser, while on the other hand defined positioning of the dispenser relative to the release device is achieved.

Frequently, release devices such as a combi dispenser comprise a swivelable flap, which is opened during a washing program in order to release cleaning preparations located in the dispensing chamber of the combi dispenser into the interior of the dishwashing machine. The receptacle for the dispenser may then be configured on the release device in such a way that opening of the flap is prevented when the dispenser is fixed in the receptacle. This prevents the risk of double dispensing from the dispenser and the release device.

Moreover, it is advantageous to configure fixing of the release device and the transmit and/or receive unit in such a way that at least the transmit unit directly irradiates the receiver of the dispenser arranged in the fixing.

Advantageously, the dispenser not connected firmly to the dishwasher, for use in a dispensing system comprising the release device, comprises at least one receive unit and/or at least one transmit unit for wirelessly transmitting signals from the interior of the dishwasher to the release device or for wirelessly receiving signals from the release device.

### Adapter

An adapter allows simple coupling of the dispensing system to a water-conveying domestic appliance. The adapter serves to connect the dispensing system mechanically and/or electrically to the water-conveying domestic appliance.

The adapter is connected, preferably firmly, to a water-conveying line of the domestic appliance. However it is also conceivable to provide the adapter for positioning in or on the domestic appliance in a position in which the adapter falls within the path of the water flow and/or spray jet of the domestic appliance.

According to a preferred embodiment of the invention, the adapter is configured in such a way that the release of preparation from the dispenser, when coupled to the adapter, does not proceed directly into the washing liquor, but rather into the water conveyed into the adapter by the water-conveying line, wherein the water consequently bearing preparation is then conveyed out of the adapter into the interior of the dishwashing machine.

Preferably, the adapter is configured in such a way that, when not coupled to the dispenser, outlet of water from the adapter is prevented. This may for example be prevented in that the water-conveying line, with which the adapter is in fluid connection, does not convey any water into or to the adapter or indeed water from the water-conveying line passes through the adapter, but the adapter comprises sealing means which prevent the outlet of water from the adapter, for example slit silicone elements, which close the adapter in a substantially liquid-tight manner when the dispenser is removed from the adapter.

The adapter makes it possible to construct a dispensing system both for an autonomous and a “built-in” version, the per se autonomous dispenser being coupled to the adapter. It is also possible to configure the adapter as a type of charging station for the dispensing system, in which for example the energy source of the dispenser is charged or data are exchanged between the dispenser and the adapter or the dishwasher.

The adapter may be arranged in a dishwashing machine on one of the interior walls of the washing chamber, in particular on the inside of the dishwashing machine door. However, it is also conceivable for the adapter as such to be positioned in the water-conveying domestic appliance where it is not accessible to the user, such that the dispenser is inserted into the adapter for example during assembly of the domestic appliance, wherein the adapter, the dispenser and the domestic appliance are configured in such a way that a cartridge may be coupled to the dispenser by the user.

### Examples of Application

In principle the dispensing system of the above-described type is suitable for use in or in conjunction with water-conveying devices of any type.

The dispensing system according to the invention is in particular suitable for use in water-conveying domestic appliances such as dishwashing and/or washing machines, but is not limited to such use.

In general, it is possible to use the dispensing system according to the invention anywhere where dispensing of at least one, preferably a plurality of preparations into a liquid medium is required in accordance with an external physical or chemical parameter triggering or controlling a dispensing program.

It is thus for example also conceivable to use the dispensing system in domestic robots, such as for example floor cleaning robots, for dispensing cleaning substances into a toilet bowl or WC cistern, in water-conveying cleaning devices such as for example high pressure cleaners, in screenwashing systems for vehicles, in plant watering systems, steam ironing devices, valves and the like.

We claim:

1. A dispensing system for use in the interior of a dishwashing machine, comprising:
at least one cartridge for flowable washing or cleaning agents with a plurality of chambers for spatially separate accommodation of in each case different preparations of a washing or cleaning agent; and
a dispenser couplable with the cartridge and comprising:
at least one energy source;
a control unit;
a sensor unit;
at least one actuator, which is connected with the energy source and the control unit in such a manner that a control signal from the control unit brings about movement of the actuator;
a closing element, which is coupled with the actuator such that movement of the actuator displaces the closing element into a closure or a release position;
at least one dispensing chamber which, when cartridge and dispenser are assembled, is connected in communicating manner with at least one of the cartridge chambers:
wherein the dispensing chamber comprises an inlet for inflow of washing or cleaning agent from a cartridge chamber and an outlet for outflow of washing or cleaning agent from the dispensing chamber into the surrounding environment,
wherein at least the outlet of the dispensing chamber is closable or openable by the closing element.

2. The dispensing system according to claim 1, wherein the dispenser comprises at least one first interface, which interacts with a corresponding interface in or on a dishwashing machine such that signals and/or electrical energy is/are transmitted from the dishwashing machine to the dispenser.

3. The dispensing system according to claim 2, wherein at least one interface is provided in each case on the dispenser and dishwashing machine for transmitting electromagnetic signals, in particular light in the visible range, which in particular represent operating state, measurement and/or control information of the dispenser and/or the dishwashing machine.

4. The dispensing system according to claim 3, wherein the interfaces are configured for emitting and/or receiving optical signals, in particular in the visible range, preferably in a wavelength range of between 600-800 nm.

5. The dispensing system according to claim 3, wherein an optical signal is configured as a signal pulse or a sequence of signal pulses with a pulse duration of between 1 ms and 10 seconds, preferably between 5 ms and 100 ms.

6. The dispensing system according to claim 1, wherein the closing element takes the form of an open-close valve element, the actuator is configured in such a way that, driven by a suitable pulse, it adopts as desired one of two end positions and without further drive, stably maintains the end position it has reached thereby forming a pulse-controlled, bistable open-close valve.

7. The dispensing system according to claim 1, wherein at least one sensor unit is arranged on the bottom of the dispenser.

8. A cartridge for flowable washing or cleaning agents for use in a dispensing system, comprising:
a plurality of chambers for spatially separate accommodation in each case of different preparations of a flowable washing or cleaning agent;
a cartridge bottom which in the service position is directed downwards in the direction of gravity; and
at least two chambers, which in each case comprise at least one outlet orifice arranged on the cartridge bottom.

9. The cartridge according to claim 8, further comprising at least one light guide arranged in or on the cartridge, into which light guide a light signal may be incoupled from outside the cartridge.

10. The cartridge according to claim 8, wherein the cartridge comprises at least one ventilation orifice at the bottom in the direction of gravity for the ventilation of at least one chamber, wherein the ventilation orifice is separate from the release orifice and the ventilation orifice is connected in communicating manner with at least one cartridge chamber via a ventilation channel in such a way that the end of the ventilation channel remote from the ventilation orifice opens, in the release position of the cartridge coupled with the dispenser, above the maximum filling level of the cartridge.

11. A combi dispenser for use in conjunction with a dispensing system according to claim 1, the combi dispenser being connected nondetachably with the dishwasher, wherein the combi dispenser comprises at least one transmit unit and/or at least one receive unit for wirelessly transmitting signals into the interior of the dishwasher or for wirelessly receiving signals from the interior of the dishwasher, wherein the transmit unit and/or receive unit is configured in particular for emitting or receiving optical signals in the visible range.

12. A dishwasher comprising a combi dispenser according to claim 11.
